(19) United States
(12) Patent Application Publication
(10) Pub. No.: US 2026/0150178 A1
(43) Pub. Date: May 28, 2026

(54) APPARATUS, SYSTEM AND METHOD FOR PRODUCING AN IONIZED GAS DISCHARGE FOR TREATMENT OF A MEDIUM

(71) Applicant: Green Lightning Solutions, LLC, Winchester, KY (US)

(72) Inventor: Joseph E. Lewis, III, Holly Hill, FL (US)

(21) Appl. No.: 19/448,006

(22) Filed: Jan. 13, 2026

Related U.S. Application Data
(63) Continuation of application No. PCT/US2024/037957, filed on Jul. 14, 2024.
(63) Continuation of application No. 18/222,027, filed on Jul. 14, 2023, now Pat. No. 12,193,373.
(63) Continuation of application No. 18/222,053, filed on Jul. 14, 2023, now Pat. No. 12,108,516.
(63) Continuation of application No. 18/222,080, filed on Jul. 14, 2023, now abandoned.
(63) Continuation of application No. 18/222,103, filed on Jul. 14, 2023, now Pat. No. 12,381,066.
(63) Continuation of application No. 18/222,134, filed on Jul. 14, 2023, now Pat. No. 12,385,712.
(63) Continuation of application No. 18/222,176, filed on Jul. 14, 2023, now Pat. No. 12,338,803.
(63) Continuation of application No. 18/222,220, filed on Jul. 14, 2023, now Pat. No. 12,201,135.
(63) Continuation of application No. 18/222,252, filed on Jul. 14, 2023, now abandoned.
(60) Provisional application No. 63/744,452, filed on Jan. 13, 2025.

(51) Int. Cl. A01G 7/04; A01C 23/00; A01G 27/02

(52) U.S. Cl. CPC H05H 1/482; H05H 1/2406; H05H 1/3447; H05H 1/466; H05H 1/48; H05H 2245/40

(57) ABSTRACT

An apparatus includes a treatment chamber configured to contain a growth medium, at least one reservoir configured to contain at least one fluid, and a plasma reactor. The plasma reactor includes a plurality of electrodes including a first electrode and a second electrode and a reaction region is disposed between the first electrode and the second electrode. The apparatus also includes an ignition unit electrically connected to at least one electrode of the plurality of electrodes, an injector in fluidic communication with the at least one reservoir, and a pressure regulator configured to transfer the fluid to the injector. Various other apparatuses, systems, and methods are also disclosed.

### CROSS REFERENCE TO RELATED APPLICATIONS

This U.S. Patent application claims priority to and the benefit of U.S. Provisional Patent Application No. 63/744,452, filed Jan. 13, 2025, and is a continuation of and claims priority to and the benefit of International Patent Application No. PCT/US2024/037957, filed Jul. 14, 2024, U.S. patent application Ser. No. 18/222,027, filed Jul. 14, 2023, U.S. patent application Ser. No. 18/222,053, filed Jul. 14, 2023, U.S. patent application Ser. No. 18/222,080, filed Jul. 14, 2023, U.S. patent application Ser. No. 18/222,103, filed Jul. 14, 2023, U.S. patent application Ser. No. 18/222,135, filed Jul. 14, 2023, U.S. patent application Ser. No. 18/222,176, filed Jul. 14, 2023, U.S. patent application Ser. No. 18/222,220, filed Jul. 14, 2023, and U.S. patent application Ser. No. 18/222,252, filed Jul. 14, 2023, the disclosures of each of which are incorporated, in their entirety, by this reference.

### TECHNICAL FIELD

The present invention generally relates to the field of Non-thermal Plasma (NTP) technology. In particular, the present invention is directed to apparatuses, systems, and methods for treating a targeted medium via an electrical discharge. A range of media are appropriate targets for the apparatus, system, and method of use for the invention, and may include, but are not limited to growth media for plants, treatments for seeds, nutritional components for animal feed, liquids for use in beverage formulations, personal wellness formulation components and surface treatments for equipment and industrial use.

### BACKGROUND

The present invention can be used in different environments for specific product and performance outcomes and improvements. In agriculture, plants regularly undergo a multitude of stresses such as, without limitation, scarcity of water, waterlogging, toxicity, high salinity, extreme temperatures, and the like. These stresses result in impacts to plant health, and can reduce crop yields. To enhance seed germination and growth under the changing environment, techniques such as chemical, physical, and biological treatment are developing. However, existing treatments may result in changes to the plant, such as but not limited to the change of seed morphology, gene expression, or protein levels. Crops grown with such treatment may potentially be toxic to humans and/or the environment. What is needed is a way to generate stable, consistent, growth media, including fertilizer solutions that can be used with fertigation, irrigation, and broadcast treatments that supply readily available nutrients important for use in enhancing plant growth, including nitrogen and oxygen.

This invention is also applicable outside of agriculture, and can be harnessed for use in other fields of endeavor. By way of example and not limitation, nitrogen in various chemical states is critical in beverage production, including certain systems that manufacture soft drinks, fermented, and distilled beverages and mixes. In another example, human healthcare, nitric oxides have been shown to enhance performance of a spectrum of skincare products, and the number of products containing nitric oxides for human digestive health is growing rapidly. What is needed is a cost-effective way to provide producers and manufacturers involved in a spectrum of applications with a device and methodology capable of treating media used in those applications.

### SUMMARY OF INVENTION

The invention disclosed provides an apparatus, a system and method of using the apparatus within the system for the ionization of gas to treat medium used as described herein. It is distinguished from existing technology and systems in that it can be configured as modular such that by connecting multiple units in parallel it can expand output and therefore efficiency over existing disclosures. The specific system provides for flexibility with respect to how fluid inputs are incorporated; it can use multiple input configurations, in contrast to existing systems which are fixed with respect to fluid inputs including gas and water. Also, attributes of the existing disclosure solve challenges associated with power input, including the ability to accept multiple voltage types such as alternating current or direct current.

In an aspect, an apparatus for treating a medium via an electrical discharge is described. The apparatus includes a treatment chamber configured to contain a medium; at least a reservoir configured to contain at least a fluid; a plasma reactor, wherein the plasma reactor includes at least a pair of electrodes containing a first electrode and a second electrode, wherein the at least a pair of electrodes is configured to produce an electrical discharge as a function of the at least a fluid; and a reaction region disposed between the first electrode and the second electrode, wherein the reaction region is configured to enable an interaction between the electrical discharge and a-medium, an ignition unit electrically connected to at least an electrode of the at least a pair of electrodes, wherein the ignition unit is configured to supply an electrical voltage to the at least an electrode, an injector in fluidic connection with the at least a reservoir, wherein the injector is configured to feed at least a fluid through the reaction region, and a pressure regulator configured to transfer at least a fluid to the injector.

In another aspect, a method for treating a growth medium for use in agriculture via an electrical discharge is described. The method includes transferring, by an atmospheric pressure system, at least a fluid contained in at least a reservoir to an injector, feeding, by the injector in fluidic connection with the at least a reservoir, the at least a fluid through a reaction region of a plasma reactor, wherein the plasma reactor includes at least a pair of electrodes containing a first electrode and a second electrode, and the reaction region is disposed between the first electrode and the second electrode, supplying, by an ignition unit electrically connected to at least an electrode of the at least a pair of electrodes, an electrical voltage to the at least an electrode, producing, by the at least a pair of electrodes, an electrical discharge as a function of the at least a fluid, and enabling, by the reaction region, an interaction between the electrical discharge and a growth medium contained in a treatment chamber.

In another aspect, an alternate embodiment of an apparatus for treating a medium via an electrical discharge is described. The apparatus includes a treatment chamber, at least a reservoir, a plasma reactor, an injector, an pressure regulation system, and in ignition unit including a voltage source configured to provide an electrical voltage, a converter configured to convert the electrical voltage from a direct current (DC) voltage input to an alternating current (AC) voltage output, and an electrical connection interface configured to electrically connect the converter to at least one electrode of a pair of electrodes disposed in the plasma reactor, wherein the pair of electrodes includes a first electrode and a second electrode, a feedback mechanism comprising a sensor configured to detect reaction data, and a control module communicatively connected to the feedback mechanism, wherein the control module is configured to initiate a generation of an electrical discharge in a reaction region disposed between the first electrode and the second electrode as a function of the AC voltage output, wherein the reaction region is configured to enable an interaction between the electrical discharge and a medium contained in the treatment chamber.

In another aspect, a method for treating a medium via an electrical discharge is described. The method includes providing, by a voltage source, an electrical voltage, converting, by a converter, the electrical voltage from a direct current (DC) voltage input to an alternating current (AC) output, connecting, by an electrical connection interface, the converter to at least one electrode of a pair of electrodes disposed in the plasma reactor electrically, wherein the pair of electrodes includes a first electrode and a second electrode, initiating, by a control module, a generation of an electrical discharge in a reaction region disposed between the first electrode and the second electrode, enabling, by the reaction region, an interaction between the electrical discharge and a growth medium contained in the treatment chamber, and detecting, by a feedback mechanism, reaction data using a sensor.

Also, in an aspect an apparatus for improved injection for a plasma reactor is disclosed. The apparatus includes at least a reservoir, a plasma reactor, an ignition unit, and an injector, wherein the injector is configured to feed at least a fluid from the at least a reservoir through reaction region of the plasma reactor and the injector includes at least a fluid outlet, wherein the at least a fluid outlet is configured to output the at least a fluid in a cone distribution to the plasma reactor, wherein the cone distribution includes a distribution angle and droplets of the at least a fluid.

In another aspect, a vapor injection system that includes a fluid inlet in fluidic communication with a fluid reservoir, wherein the fluid inlet is configured to transport a fluid, a voltage conditioner connected to a power source, where the voltage conditioner is configured to: receive electrical energy from the power source and transform the electrical energy, wherein transforming the electrical energy comprises: regulating voltage of the electrical energy and modifying frequency of the voltage, a crystal compressor connected to the voltage conditioner and the fluid inlet, wherein the crystal compressor is configured to: receive the transformed electrical energy from the iron core coil, receive the fluid from the fluid inlet, generate the vapor as a function of the transformed electrical energy and the fluid and output the vapor using a vapor outlet.

In another aspect, a method for using a vapor injection system, wherein the method includes receiving, by a fluid inlet, a fluid from a fluid reservoir, receiving, by a voltage conditioner connected to a power source, electrical energy. The method also includes transforming, by the voltage conditioner, the electrical energy, wherein transforming the electrical energy comprises, regulating voltage of the electrical energy and modifying frequency of the electrical energy, generating, by a crystal compressor, vapor as function of the transformed electrical energy and the fluid and outputting, using a vapor outlet, the vapor.

In still another aspect, a low-pressure injection system for a plurality of fluids is provided. The system includes at least one first fluid inlet configured to receive a first fluid from a first fluid reservoir comprising the first fluid and at least one second fluid inlet configured to receive a second fluid from a second fluid reservoir comprising the second fluid. The system further includes a low-pressure compressor configured to provide pressure to the second fluid received from the second fluid reservoir and at least one injector configured to disperse a combination of the first fluid and the second fluid.

In another aspect, a method for use of a low-pressure injection system for a plurality of fluids is provided. The method comprises receiving, by at least one first fluid inlet, a first fluid from a first fluid reservoir comprising the first fluid and receiving, at least one second fluid inlet, a second fluid from a second fluid reservoir comprising the second fluid. The method further comprises providing, by a low-pressure compressor, pressure to the second fluid received from the second fluid reservoir and dispersing, by at least one injector, a combination of the first fluid and the second fluid.

In an aspect, an apparatus for a modular plasma reactor is disclosed. The apparatus includes a modular plasma reactor, wherein the modular plasma reactor includes a housing, a modular ignition unit removably connected to the modular plasma reactor, a modular injector removably connected to the modular plasma reactor, at least a modular reservoir removably connected to the modular injector and a controller communicatively connected to one or more of the modular ignition unit and the modular injector.

In another aspect, a method of use for a modular plasma reactor is disclosed. The method includes removably connecting a modular ignition unit to a modular plasma reactor, wherein the modular plasma reactor comprises a housing, removably connecting a modular injector to the modular plasma reactor, removably connecting at least a modular reservoir to the modular injector, communicatively connecting a controller to one or more of the modular ignition unit and the modular injector.

In an aspect, an apparatus for treating a substrate, such as a food substance, is disclosed. The apparatus may include a water supply tank connected to both a reaction chamber and a control module, which may generate a control signal. The water supply tank has a level line and a reservoir filled with water to the level line. The water supply tank may replenish water upon detection of depletion of water beneath the level line. That is, more specifically, the water supply tank may automatically replenish water by extracting additional water from a water source, such as a sink, reservoir, or other water container, which is fluidically connected to the water tank when the amount of water declines beneath the level line. The reaction chamber is connected to the water supply tank and includes a pair of electrodes with a first electrode and a second electrode positioned opposite to the first electrode, and a reaction region defined between the first electrode and the second electrode. The reaction region may at least temporarily retain the substrate. A control module is connected to at least the reaction chamber and may generate at least a control signal. The apparatus may also include an injector connecting the water supply tank to the reaction chamber. The injector may generate a dispersion of microfine water droplets from water extracted from the reservoir in response to receipt of the control signal. In addition, the apparatus may include a platform configured to support at least the reaction chamber and lay on a flat surface.

In another aspect, a method for generating a plasma for treatment of a substrate within a plasma reactor is disclosed. The method may include providing, by a voltage source, an electrical voltage, converting, by a converter, the electrical voltage from a direct current (DC) voltage input to an alternating current (AC) output. The method may also include connecting, by an electrical connection interface, the converter to at least one electrode of a pair of electrodes disposed in the plasma reactor, wherein the pair of electrodes comprises a reaction region defined between a first electrode and a second electrode positioned opposite to the first electrode; dispersing a plurality of water droplets extracted from a reservoir in a water tank fluidically connected to the plasma reactor into the reaction region, wherein the reservoir stores an amount of water. In addition, the method may include flowing a gaseous mixture into the plasma reactor, wherein at least some water droplets from the plurality of water droplets are configured to be suspended within the gaseous mixture and correspondingly produce a mist; igniting the plasma by generating an electrical discharge from the first electrode to the second electrode through the mist in the reaction region. Still further, the method may include treating the substrate by exposing the substrate to the plasma for a defined duration and replenishing the amount of water in the reservoir of the water tank automatically by extracting additional water from a water source fluidically connected to the water tank when the amount of water declines beneath a defined setpoint.

In an aspect, using the invention for generation of a fertilizer blend for use as a growth medium is described. The fertilizer blend includes a reactive mixture comprising a reactive oxygen species and a reactive nitrogen species. The fertilizer blend further includes an ocean brine solution having a filtered ocean blend, wherein the ocean brine solution further includes magnesium, sulfur, potassium, and calcium.

In another aspect, a method of manufacturing a fertilizer blend for use as a growth medium is described. The method includes forming a reactive mixture having a reactive oxygen species and reactive nitrogen species, filtering an ocean blend to create an ocean brine solution, wherein the ocean brine solution includes magnesium, sulfur, potassium and calcium, and combining the reactive mixture and the ocean brine solution to create a fertilizer blend.

In yet another aspect, a method of using the fertilizer blend generated using the system of the invention is disclosed. The method includes pouring a fertilizer blend over a plant, wherein the fertilizer blend includes a reactive mixture having a reactive oxygen species and a reactive nitrogen species, and an ocean brine solution having a filtered ocean blend, wherein the ocean brine solution further includes magnesium, sulfur, potassium, and calcium.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exemplary embodiment of an apparatus for treating a growth medium via an electrical discharge.

FIG. 2 is an exemplary embodiment of a plasma reactor assembly.

FIG. 3 is an exemplary embodiment of an injector with a flow adjustment component.

FIG. 4 is an exemplary embodiment of a piezo water vapor injector.

FIG. 5 is an exemplary embodiment of an apparatus for treating a growth medium via an electrical discharge with an external mounted injector.

FIG. 6 is an exemplary embodiment of a method for treating a growth medium via an electrical discharge.

FIG. 7 is an exemplary embodiment of a segment of conduit.

FIG. 8 is an exemplary embodiment of an ignition unit.

FIG. 9 is a block diagram of exemplary embodiment of a machine learning module in accordance with one or more embodiments of the present disclosure.

FIG. 10 is an exemplary embodiment of a method for treating a growth medium via an electrical discharge.

FIGS. 11A-C are exemplary embodiments of a portion of an injector for improved injection for a plasma reactor.

FIG. 12 is an exemplary embodiment of a vapor injection system for a plasma reactor.

FIG. 13 is an exemplary embodiment of a plasma reactor assembly.

FIG. 14 is an exemplary embodiment of an internally mounted vapor injection system.

FIG. 15 is an exemplary embodiment of an externally mounted vapor injection system.

FIG. 16 is an exemplary depiction of a crystal compressor.

FIG. 17 is an exemplary embodiment of a method for using a vapor injection system.

FIG. 18 is an exemplary embodiment of a low-pressure injection system for a plurality of fluids.

FIG. 19 illustrates an exemplary embodiment of a low-pressure injection system for a plurality of fluids.

FIG. 20 is an exemplary embodiment of an internally mounted low-pressure injection system.

FIG. 21 is an exemplary embodiment of an externally mounted low-pressure injection system.

FIG. 22 is an exemplary embodiment of a method for using a low-pressure injection system for a plurality of fluids.

FIG. 23 is a block diagram of an exemplary embodiment of an apparatus for a modular plasma reactor.

FIG. 24 is a flow diagram of an exemplary method of use for a modular plasma reactor.

FIG. 25 is an exemplary embodiment of an apparatus including a reaction chamber with automatic water replenishment for treating a substrate.

FIG. 26 is an exemplary embodiment of a method for treating a growth medium via an electrical discharge.

FIG. 27 is an exemplary embodiment of a fertilizer blend for use as a growth medium.

FIG. 28 is an exemplary embodiment of a method of manufacturing a fertilizer blend for use as a growth medium.

FIG. 29 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION OF EXEMPLARY EMBODIMENTS

Aspects of the present disclosure are directed to apparatus and methods for treating media via an electrical discharge. In an embodiment, the apparatus includes a plasma reactor, wherein the plasma reactor includes at least a pair of electrodes containing a first electrode and a second electrode, configured to produce an electrical discharge. The plasma reactor further includes a reaction region disposed between the first electrode and the second electrode, wherein the reaction region is configured to enable an interaction between the electrical discharge and a growth medium contained in a treatment chamber.

Aspects of the present disclosure can be used to generate reactive oxygen and nitrogen species (RONS) and change solution properties pH, electrical conductivity, and oxidation-reduction potential. Aspects of the present disclosure can also be used to affect the rate of the growth medium (e.g., seed) germination, enhancement in plant growth, as well as an increase in agricultural yields. This is so, at least in part, because the apparatus is configured to expose growth medium to a non-thermal plasma (NTP) using a high energy ignition system. The apparatus may generate a high voltage NTP using air, water, and an electrical load without any harmful emission.

Aspects of the present disclosure can be used to monitor the electrical discharge and/or growth medium and provide necessary information to the user of the apparatus. This is so, at least in part, because the apparatus includes an ignition unit with a feedback mechanism configured to detect reaction data. In an embodiment, reaction data may include plurality of electrical discharge parameters, fluid parameters, growth medium parameters, and the like.

Aspects of the present disclosure can be used to optimize the treatment process for the growth medium, adapting changes in the electrical voltage, fluid, and/or other factors that may affect the electrical discharge. This is so, at least in part, because the apparatus includes an ignition unit with a control module communicatively connected to the feedback mechanism, wherein the control module is configured to regulate electrical discharge generation in a reaction region. Control module may adjust at least a treatment parameter of the apparatus as a function of the reaction data detected by the feedback mechanism during an interaction between the electrical discharge and the growth medium contained in the treatment chamber.

Aspects of the present disclosure can be used to monitor the electrical discharge and/or growth medium and provide necessary information to the user of the apparatus. This is so, at least in part, because the apparatus includes an ignition unit with a feedback mechanism configured to detect reaction data. In an embodiment, reaction data may include plurality of electrical discharge parameters, fluid parameters, growth medium parameters, and the like.

Aspects of the present disclosure can be used to optimize the treatment process for the growth medium, adapting changes in the electrical voltage, fluid, and/or other factors that may affect the electrical discharge. This is so, at least in part, because the apparatus includes an ignition unit with a control module communicatively connected to the feedback mechanism, wherein the control module is configured to regulate electrical discharge generation in a reaction region. Control module may adjust at least a treatment parameter of the apparatus as a function of the reaction data detected by the feedback mechanism during an interaction between the electrical discharge and the growth medium contained in the treatment chamber.

Aspects of the present disclosure allow for growth medium treatment under low-temperature without damaging growth medium. Exemplary embodiments illustrating aspects of the present disclosure are described below in the context of several specific examples.

Aspects of the present disclosure are also directed to a low-pressure injection system for a plurality of fluids and method of use thereof. In an embodiment, the system includes at least one injector configured to disperse a first fluid and second fluid mixture. Aspects of the present disclosure can be used to generate microfine fluid droplets, which may allow a second fluid to become ionized and be transferred into the generated microfine fluid droplets. Exemplary embodiments illustrating aspects of the present disclosure are described below in the context of several specific examples.

Aspects of the present disclosure are directed to apparatus for a modular plasma reactor and method of use. The apparatus includes a modular plasma reactor, wherein the modular plasma reactor includes a housing, a modular ignition unit removably connected to the modular plasma reactor, a modular injector removably connected to the modular plasma reactor, at least a modular reservoir removably connected to the modular injector and a controller communicatively connected to one or more of the modular ignition unit and the modular injector.

Aspects of the present disclosure may allow for growth medium treatment under low-temperature without damaging growth medium. In some embodiments, aspects of the present disclosure may also allow for a controller to detect a connection between a housing that includes a plasma reactor and the one or more of an ignition unit, an injector and a pressure regulator and control the power provided to the one or more of the ignition unit, the injector and the pressure regulator. Exemplary embodiments illustrating aspects of the present disclosure are described below in the context of several specific examples.

Aspects of the present disclosure can be used to monitor the electrical discharge and/or growth medium and provide necessary information to the user of the apparatus. This is so, at least in part, because the apparatus includes an ignition unit with a feedback mechanism configured to detect reaction data. In an embodiment, reaction data may include plurality of electrical discharge parameters, fluid parameters, growth medium parameters, and the like.

Aspects of the present disclosure can be used to optimize the treatment process for the growth medium, adapting changes in the electrical voltage, fluid, and/or other factors that may affect the electrical discharge. This is so, at least in part, because the apparatus includes an ignition unit with a control module communicatively connected to the feedback mechanism, wherein the control module is configured to regulate electrical discharge generation in a reaction region. Control module may adjust at least a treatment parameter of the apparatus as a function of the reaction data detected by the feedback mechanism during an interaction between the electrical discharge and the growth medium contained in the treatment chamber.

Aspects of this disclosure can be used to treat growth mediums using a combination of modified ocean water and a reactive mixture. Aspects of this disclosure may further allow for the prevention of disease that may be prevalent within various growth mediums.

Aspects of the present disclosure can be used to generate reactive oxygen and nitrogen species (RONS) and change solution properties pH, electrical conductivity, and oxidation-reduction potential. Aspects of the present disclosure can also be used to affect the rate of the growth medium (e.g., seed) germination, enhancement in plant growth, as well as an increase in agricultural yields. This is so, at least in part, because the apparatus is configured to expose growth medium to a non-thermal plasma (NTP) using a high energy ignition system. The apparatus may generate a high voltage NTP using air, water, and an electrical load without any harmful emissions.

Aspects of the present disclosure allow for growth medium treatment under low temperature without damaging growth medium. Exemplary embodiments illustrating aspects of the present disclosure are described below in the context of several specific examples.

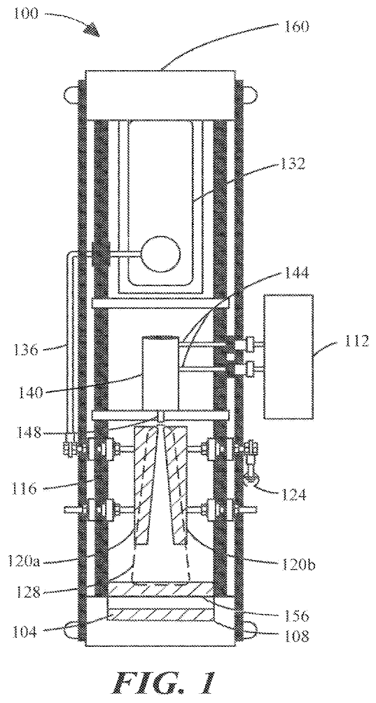

Now referring to FIG. 1, an exemplary embodiment of an apparatus 100 for treating a growth medium 104 via an electrical discharge is illustrated. As used in this disclosure, a “growth medium” is a substance or material that provides essential nutrients and environmental conditions for the growth and proliferation of microorganisms, cells, tissues. In an embodiment, one or more seeds may be placed in growth medium 104. “Seeds,” for the purpose of this disclosure, are a mature, fertilized ovule of a flowering plant (i.e., angiosperms) that contains an embryonic plant within a protective outer covering, serve as the primary means of reproduction for many plant species, enabling them to disperse and establish new plants. In some embodiments, seeds may include, without limitation, cereal seeds (e.g., wheat, rice, corn, barley, oats, millets, and the like), legume seeds (e.g., soybeans, peas, beans, lentils, chickpeas, peanuts, and the like), oilseeds (e.g., sunflower, rapeseed, flaxseed, sesame, safflower, and the like), vegetable seeds (e.g., tomatoes, peppers, cucumbers, eggplants, lettuce, spinach, and the like), and fruit seeds (e.g., watermelon, muskmelon, apple, citrus, and the like). In such an embodiment, growth medium 104 may include a nutrient-rich environment that provides the essential conditions for germination and growth of the seeds. In some cases, growth medium may provide environmental factors such as, without limitation, temperature, pH level, oxygen, and the like required for the seed to germinate and develop into a healthy plant. In a non-limiting example, growth medium 104 may include soil, wherein the soil may include a complex mixture of mineral particles, organic matter, water, air, living organisms, and the like. In another non-limiting example, growth medium 104 may include soilless mix or a specially formulated medium designed for seed germination and plant growth.

With continued reference to FIG. 1, apparatus 100 includes a treatment chamber 108 configured to contain growth medium 104. As used in this disclosure, a “treatment chamber” is a controlled space designed to hold a specific material, substance, object, and subject it to a particular treatment. In an embodiment, treatment chamber 108 may be constructed as an open system; for instance, and without limitation, treatment chamber 108 may include an open-top container. In another embodiments, treatment chamber 108 may be constructed as a closed system; for instance, and without limitation, treatment chamber 108 may be an enclosed container with an airtight seal. In some embodiments, treatment chamber 108 may be designed to provide easy access to the growth medium 104 being treated. In a non-limiting example, treatment chamber 108 may include removable or hinged doors or ports for loading and/or unloading growth medium 104. In another non-limiting example, treatment chamber 108 may include one or more window with/without cover for visual inspection or sampling during the treatment process.

With continued reference to FIG. 1, apparatus 100 includes at least a reservoir 112. As used in this disclosure, a “reservoir” is a container or storage chamber designed to hold at least a fluid used in the treatment process. In a non-limiting example, reservoir 112 is configured to contain at least a fluid. A “fluid” as used in this disclosure is defined as a gas or fluid. Reservoir may provide a consistent and controlled supply of at least a fluid for the treatment of growth medium 104 as described in further detail below. In an embodiment, fluid may include a substance that enables the production of electrical discharge. In some cases, at least a fluid may include liquid; for instance, and without limitation, at least a fluid may include water, organic solvents, electrolyte solutions, and the like. In other cases, at least a fluid may include one or more gases; for instance, and without limitation, at least a fluid may include inert gases (e.g., nitrogen, argon, helium, neon, and the like), oxygen, carbon dioxide, air, reactive gases (e.g., hydrogen, ammonia, sulfur hexafluoride, and the like), and the like. Additionally, or alternatively, apparatus 100 may include a plurality of reservoirs. In an embodiment, at least a reservoir 112 may include a first reservoir configured to contain a first fluid and a second reservoir configured to contain a second fluid, wherein the first fluid may include at least a gas and the second fluid may include at least a liquid.

With continued reference to FIG. 1, at least a reservoir 112 may be constructed from materials that are compatible with at least a fluid being stored. For example, and without limitation, at least a reservoir 112 may be made from material such as corrosion-resistant metals, plastics, and/or glass. In some cases, at least a reservoir 112 may be appropriately sized to provide an adequate supply of fluid throughout the treatment process without frequent refilling or interruptions. In an embodiment, fluid may be supplied by a pressurized hose or tube. At least a reservoir 112 may include at least an inlet, at least an outlet, or both. In a non-limiting example, at least an inlet may be used for filling at least a reservoir 112 with at least a fluid and at least an outlet may be connected to an injector or other fluid delivery component of apparatus 100 such as a pressure regulator and/or pressure regulation system as described in further detail below. At least a fluid may be input through the at least an inlet into at least a reservoir 112 and/or output through the at least an outlet to injector. In the case of apparatus 100 having a plurality of reservoirs, each reservoir of plurality of reservoirs may include at least an inlet and at least an outlet. In a non-limiting example, first reservoir configured to contain first fluid may include a first inlet and a first outlet, second reservoir configured to contain second fluid may include a second inlet and a second outlet, wherein the first inlet/first outlet may never intersect with second inlet/second outlet. In such an embodiment, first fluid and second fluid may not contact each other before output through first outlet/second outlet.

With continued reference to FIG. 1, apparatus 100 includes a plasma reactor 116. As used in this disclosure, a “plasma reactor” is a device configured to generate, sustain, and/or control plasma. “Plasma,” for the purpose of this disclosure, refers to the fourth state of matter, in addition to solid, liquid, and gas. Plasma may include a partially ionized gas consisting of a mixture of ions, electrons, and/or neutral particles (i.e., atoms and molecules). In an embodiment, plasma may be formed when at least a fluid subject to high-energy source, such as, without limitation, heat, radiation, electric filed, and the like, causing the atoms or molecules in at least a fluid to become ionized by losing or gaining electrons. At least a fluid may be inputted into plasma reactor 116 using injector as described below in this disclosure. In some cases, plasma may include non-thermal plasma (NTP), wherein the non-thermal plasma is a type of plasma in which the electron temperature is significantly higher than the temperature of the heavier ions and neutral particles. In this case, while the electrons in plasma have high kinetic energy, the overall temperature of at least a fluid may remain relatively low (e.g., often near room temperature of 20-22° C./68-72° F.). Additionally, or alternatively, the energy distribution among particles within non-thermal plasma may not be in thermal equilibrium due to the electrons, being much lighter than ions and neutral particles, may gain energy more rapidly when subjected to an electric or magnetic field, leading to a higher electron temperature. On the other hand, heavier ions and neutral particles may move more slowly and remain cooler, resulting in low temperature of at least a fluid.

With continued reference to FIG. 1, plasma reactor 116 includes at least a pair of electrodes 120a-b, wherein the at least a pair of electrodes includes a first electrode 120a and a second electrode 120b. As used in this disclosure, an “electrode” is a conductor that is used to make electrical contact with a conductive medium and/or a medium that can become conductive given a sufficient voltage differential, such as at least a fluid as described above. At least a pair of electrodes 120a-b is configured to produce an electrical discharge as a function of at least a fluid. As used in this disclosure, an “electrical discharge” refers to a phenomenon where an electric current flows between two or more conductive surfaces (i.e., at least a pair of electrodes 120a-b) through at least a fluid, causing ionization and the subsequent release of energy in the form of light, heat, or sound. In a non-limiting example, at least a pair of electrodes 120a-b may receive a voltage, supplied by an ignition unit as described in further detail below, wherein the voltage may be applied across the surface of at least a pair of electrodes 120a-b, creating an electric field between first electrode 120a and second electrode 120b. Such electric field may accelerate free electrons and other charged particles in at least a fluid, initiating a cascade of ionization event, thereby resulting in a formation of a conductive channel of charged particles (i.e., plasma) such as ions and electrons that allow electric current to flow between first electrode 120a and second electrode 120b.

With continued reference to FIG. 1, each electrode of at least a pair of electrodes 120a-b may be constructed from a metal or a metal alloy such as copper that has certain electrical conductivity and capability to withstanding high temperatures and chemical reactions. In an embodiment, at least a pair of electrodes 120a-b may include at least a cathode and at least an anode. A “cathode,” for the purpose of this disclosure, is an electrode that is negatively charged in an electrical circuit, while an “anode,” for the purpose of this disclosure, is an electrode that is positively charged in the electrical circuit. In some cases, at least a cathode may be an electrode where reduction occurs (i.e., meaning that it gains electrons) and at least an anode may be an electrode where oxidation occurs (i.e., meaning that it loses electrons). In a non-limiting example, first electrode 120a may include an anode electrically connected to ignition unit as described above and second electrode 120b may include cathode electrically connected to a ground 124. As used in this disclosure, a “ground” is a common reference point or a conductive path that provides a baseline for measuring voltages, a return path for electric currents, and a means for safely dissipating excess electrical energy. Ground 124 may be connected to an earth's conductive surface or otherwise directly or through a grounding electrode conductor. Such connection may establish a reference voltage level (i.e., zero volts), against which other voltages within apparatus 100 may be measured. Additionally, or alternatively, ground 124 may provide a pathway for excess electrical energy to safely dissipate into the earth, reducing the risk of electrical shock, fires, or equipment damage of apparatus 100.

With continued reference to FIG. 1, plasma reactor includes a reaction region 128 disposed between first electrode 120a and second electrode 120b, wherein the reaction region 128 is configured to enable an interaction between electrical discharge (i.e., plasma) and growth medium 104. As used in this disclosure, a “reaction region” is a designated area or space within plasma reactor 116 where specific chemical or physical reactions take place. In some embodiments, generating plasma in reaction region may include generating reactive oxygen species (ROS) and reactive nitrogen species (RNS), wherein both species are highly reactive molecules primarily formed through an interaction of molecular oxygen (O2) and molecular nitrogen (N2) with high-energy species, such as free radicals, ions, and/or electrons generated through electrical discharge as described above. In some cases ROS may include, without limitation, superoxide (02 •-), hydroxyl radical (—OH), hydrogen peroxide (H2O2). Plasma may collide with 02 molecules, causing dissociation, ionization, or excitation, which subsequently leads to the formation of ROS through further reactions. In some cases, RNS may include, without limitation, nitric oxide (—NO), nitrogen dioxide (—NO2), peroxynitrite (ONOO—), and the like. Plasma may collide with N2 molecules or other nitrogen-containing molecules, causing dissociation, ionization, or excitation, which subsequently leads to the formation of RNS through further reactions. In an embodiment, additional acids may be produced such as nitrous acid (HNO2) and nitric acid (HNO3) due to the interaction of plasma, oxygen, nitrogen and water. These acids may further oxidize to form NO2 and NO3.

Still referring to FIG. 1, ROS and RNS may drive various chemical and physical reactions within reaction region 128 of plasma reactor 116 during the treatment process. In an embodiment, ROS and RNS may readily participate in oxidation and reduction reactions; for instance, and without limitation, ROS and RNS may oxidize organic compounds, reducing stability of the organic compounds, and leading to their degradation or modification. In another embodiment, ROS and RNS may effectively inactivate or kill microorganisms such as bacteria, viruses, fungi, and the like; for instance, and without limitation, ROS and RNS may damage microorganisms' cellular structures and disrupting their metabolic functions by attacking cell wall, cell membrane, proteins, nucleic acids, and the like. In a further embodiment, ROS and RNS may modulate cellular processes such as cell signaling, gene expression, immune response and the like in both prokaryotic and eukaryotic cells; for instance, and without limitation, in low concentrations, ROS and RNS may act as signaling molecules that regulate cellular functions, while at higher concentrations, they may induce cellular stress, damage, or apoptosis. In other embodiments, ROS and RNS may also react with other molecules or species to generate secondary reactive species.

In a non-limiting example, and continuing to refer to FIG. 1, reaction region 128 may include a space between first electrode 120a and second electrode 120b where the electrical charge takes place and plasma is generated as a function of at least a fluid. In an embodiment, reaction region 128 may include a gap between at least a pair of electrodes 120a-b, wherein first electrode 120a may be parallel to second electrode 120b (i.e., in a corona discharge). In another embodiment, reaction region 128 may include a cylindrical space within a coaxial electrode arrangement. In a non-limiting example, at least a pair of electrodes 120a-b may be arranged in a diverging configuration (i.e., in a gliding arc discharge). In yet another embodiment, the electrodes may be in a singular tapered designed having a wide portion and a narrow position, in this configuration the electrodes may be mounted in the center of a round metal cylinder and both gas and water maybe introduced in a tangential method in order to elongate the arc or plasma discharge. First electrode 120a may be configured to diverge from second electrode 120b in diverging configuration; for instance, and without limitation, first electrode 120a and second electrode 120b may be slightly tilted. At least a pair of electrodes 120a-b may include an air gap in between first electrode 120a and second electrode 120b, wherein the air gap may be narrow on one end and gradually widen towards another end. For example, and without limitation, first electrode 120a may be closer together at one end and further apart at the other end. In some cases, each electrode of at least a pair of electrodes 120a-b may include various shapes, such as, without limitation, linear, curved, spiral, and the like. In some cases, each electrode of at least a pair of electrodes 120a-b may be placed symmetrically on both sides of plasma reactor 116 along the fluid output axis of fluid outlet of injector as described below. The distance between first electrode 120a and second electrode 120b may be adjusted to control the intensity of electrical discharge.

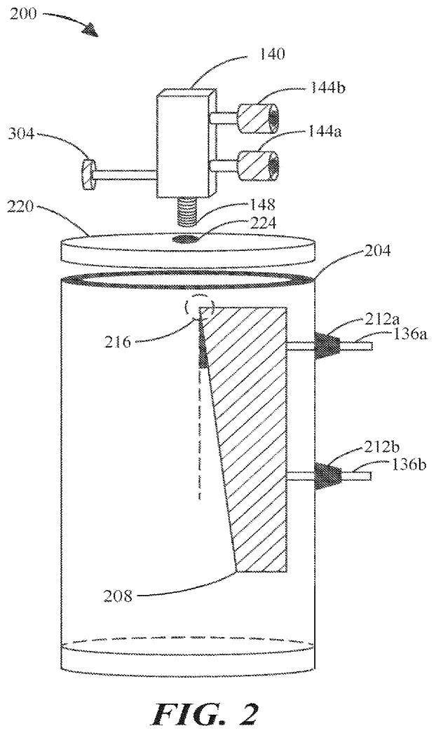

Further referring to FIG. 1, in some embodiments, reaction region 128 may include a plurality of points of arc between first electrode 120a and second electrode 120b. As used in this disclosure, a “point of arc” refers to a flow of electrons between first electrode 120a and second electrode 120b. In some cases, point of arc may mark a starting point of electrical discharge. In some cases, position of point of arc may be influenced by various factors such as geometry and material of at least a pair of electrodes 120a-b, distance between first electrode 120a and second electrode 120b within at least a pair of electrodes 120a-b, received voltage, properties of at least a fluid, and the like. In a non-limiting example, point of arc may include a region where the electrical current “jumps” or “arcs” from first electrode 120a to electrode 120b. A first point of arc may be formed at the narrowest gap between first electrode 120a and second electrode 120b. First point of arc may include a maximally intense electrical field. As plasma is generated, by plasma reactor 116 through electrical discharge, first point of arc may move along the surface of at least a pair of electrodes 120a-b due to the influence of the electric field and the flow of at least a fluid. Such movement may introduce the rest of plurality of points of arcs along the surface of at least a pair of electrodes 120a-b and ensure a continuous, non-equilibrium plasma that enhances the generation of ROS and/or RNS described above. Plasma reactor 116 and elements thereof will be described in further detail below with reference to FIG. 2.

With continued reference to FIG. 1, apparatus 100 includes an ignition unit 132 electrically connected to at least an electrode of at least a pair of electrodes 120a-b. As used in this disclosure, an “ignition unit” is an electrical component responsible for supplying an initial electrical voltage necessary to initiate electrical discharge between electrodes. In a non-limiting example, ignition unit is configured to supply an electrical voltage to at least an electrode. At least an electrode may include first electrode 120a (i.e., anode), Ignition unit 132 may include a power source. As used in this disclosure, a “power source” is any system, device, or means that provides power such as, without limitation, electric power to a device. Power source may provide electrical power to ignition unit 132 and/or other devices/components within apparatus 100 described in this disclosure, such as, without limitation, plasma reactor 116, injector, any computing device and/or the like. In a non-limiting example, apparatus 100 may be electrically connected to a power source. In some embodiments, power source may be externally electrically connected to apparatus 100. In such an embodiment, power source may include an external power source. As a non-limiting example, the external power source may include a wall outlet connection, a battery, direct current supply, renewable energy sources, fuel cells, generators, and the like. In an embodiment, the power source may include direct current (DC) power. In another embodiment, the power source may include alternating current (AC) power. In some embodiments, additionally or alternatively, the power source may include AC or DC renewable power. As a non-limiting example, AC or DC renewable power may include electrical power that is generated from renewable sources of energy such as solar, wind, hydro, geothermal, and biomass. In some embodiments, power source may include one or more battery cells. As non-limiting examples, battery cells may be lithium ion, alkaline, lithium metal, or the like. In some cases, transmitting electric power may include using one continuous conductor 136. A “continuous conductor,” as described herein, is an electrical conductor, without any interruption, made from electrically conducting material that is capable of carrying electrical current over a distance. Electrically conductive material may include any material that is conductive to electrical current and may include, as a nonlimiting example, various metals such as copper, steel, or aluminum, carbon conducting materials, or any other suitable conductive material.

With continued reference to FIG. 1, in some embodiments, ignition unit 132 may be configured to convert a lower input voltage (e.g., 110V/220V for AC voltages or 12V/24V for DC voltages) from power source into a higher output voltage, thereby providing necessary electrical energy to drive plasma reactor 116. In an embodiment, ignition unit may also convert AC to AC. For example, AC to AC converters may be used for converting the AC waveforms with one particular frequency and magnitude to AC waveform with another frequency at another magnitude. For example, an AC voltage controller may be a thyristor-based device which converts fixed alternating voltage directly to variable alternating voltage without a change in frequency. AC voltage controller may be a phase-controlled device and hence no force commutation circuitry may be required and natural or line commutation may be used. In a non-limiting example, ignition unit 132 may include an ignition transformer. As used in this disclosure, an “ignition transformer” is an electrical transformer designed to generate a high voltage output which is used to initiate electrical discharge as described above, wherein the electrical transformer is a passive electrical device that transfers electrical energy from one circuit to another through the process of electromagnetic induction. In some cases, electrical transformer may be used to increase or decrease the voltage levels of alternating current (AC) electrical signal while maintaining the same frequency. In a non-limiting example, ignition transformer may be configured to step up the input voltage from a lower level (from power source) to a higher voltage level required by plasma reactor 116 to create an electrical arc (i.e., point of arc).

In some embodiments, ignition transformer may include two sets of windings, wherein the two sets of windings may include a primary winding and a secondary winding. Two sets of windings may be wound around a magnetic core. In some cases, primary winding may be connected to lower voltage input, while secondary winding may generate high voltage output. In a non-limiting example, ignition unit 132 may include an ignition transformer configured to convert electrical power received from power source into a high-voltage discharge of a voltage range of 6 kV to 30k. In another embodiment, the voltage range may be 3 kV to 18k.

With continued reference to FIG. 1, in some embodiments, ignition unit 132 may be capable of converting AC voltage, which oscillates periodically between positive and negative values, into direct current (DC), which has a constant polarity (positive or negative) and does not change over time, for connected electrodes to produce a controlled and/or stable electrical discharge to generate and/or maintain the plasma. In some cases, apparatus 100 may need to convert AC to DC power supply to perform a pulsed operation. During the pulse plasma operation, plasma reactor 116 may operate in a pulsed mode, where the plasma may be generated and sustained for short periods followed by a period of no electrical discharge. DC power supply may be easily controlled and switched on and off as required, thereby making it suitable for pulsed plasma operation. In some cases, apparatus 100 may convert AC to DC power supply to reduce electrode wear and contamination; for instance, and without limitation, in AC-powered plasma reactor 116, the constantly changing polarity of electrodes may lead to accelerated electrode wear and the release of electrode material into the generated plasma. In an embodiment, apparatus 100 may also convert AC to AC. For example, AC to AC converters may be used for converting the AC waveforms with one particular frequency and magnitude to AC waveform with another frequency at another magnitude. For example, an AC voltage controller may be a thyristor-based device which converts fixed alternating voltage directly to variable alternating voltage without a change in frequency. AC voltage controller may be a phase-controlled device and hence no force commutation circuitry may be required and natural or line commutation may be used. By using a DC power supply, the electrodes may maintain a constant polarity, reducing wear and contamination and increasing lifetime of the electrodes. In a non-limiting example, ignition unit 132 may include a rectifier. As used in this disclosure, a “rectifier” is an electrical device or circuit that converts AC to DC. Rectifier may be built using one or more diodes, wherein the diodes are semiconductor devices that allow electrical current to flow in only one direction and have a low resistance to electrical current flow in the forward direction (when the voltage is positive) and a high resistance to electrical current flow in the reverse direction (when the voltage is negative). In some cases, a rectifier may include, without limitation, half-wave rectifier, full-wave rectifier, and the like.

With continued reference to FIG. 1, in some embodiments, ignition unit 132 may include a power regulator (i.e., filter). As described in this disclosure, a “power regulator” is an electric device in 1 that performs electrical power regulation or redistribution, wherein “power regulation” or “power redistribution,” as described herein, refers to a process that keeps voltage of power source below its maximum value during operation, non-operation, or charging. In a non-limiting example, power regulator may be used to remove or attenuate unwanted frequencies, noise, or voltage fluctuations from the output voltage or current. Power regulator may include, without limitation, passive filter, active filter, EMI/RFI filter, voltage regulator, and the like. Additionally, or alternatively, ignition unit 132 may include a balancer. As described herein, a “balancer” is an electric that performs power balancing, wherein “power balancing,” for the purpose of this disclosure, refers to a process that balances electric energy from one or more first power sources (e.g., strong batteries) to one or more second power sources (e.g., weaker batteries). Persons skilled in the art, upon reviewing the entirety of this disclosure, will be aware of various devices/components that may be used within ignition unit 132 of apparatus 100.

With continued reference to FIG. 1, apparatus 100 includes an injector 140 in fluidic connection with at least a reservoir 112. As used in this disclosure, an “injector” is a component designed to introduce at least a fluid into plasma reactor 116, specifically, reaction region 128 of plasma reactor 116. In a non-limiting example, injector 140 is configured to feed at least a fluid through reaction region. At least a fluid may then be used by the plasma reactor 116 to generate plasma. “Fluidic connection,” for the purpose of this disclosure, refers to a pathway or link that enables the transfer of at least a fluid. In a non-limiting example, fluidic connection between injector 140 and at least a reservoir 112 may be established using various components such as, without limitation, tubes, pipes, hoses, channels, or the like to create a continuous pathway for the flow of at least a fluid.

With continued reference to FIG. 1, injector 140 may include at least a fluid inlet 144. As used in this disclosure, a “fluid inlet” is an entry point through which at least a fluid is introduced into injector 140 before being fed into reaction region 128 of plasma reactor 116 or any other process described in this disclosure. In a non-limiting example, at least a fluid inlet 144 may be connected with outlet of at least a reservoir 112 as described above. In some cases, at least a fluid inlet 144 may be designed to provide a secure, leak-free connection with the at least reservoir; for instance, and without limitation, at least a fluid inlet 144 may be sealed using one or more sealing elements such as O-rings, gaskets, thread sealants, and the like to ensure a tight seal and/or prevent leaks or contamination. Injector 140 may include at least a fluid outlet 148. As used in this disclosure, a “fluid outlet” is an exit point through which at least a fluid is discharged from injector 140 into reaction region 128 of plasma reactor 116. In some cases, at least a fluid outlet 148 may be configured to allow at least a fluid to be released into the intended location within reaction region 128. For example, and without limitation, at least a fluid outlet 148 may be placed at the center and right above at least a pair of electrodes 120a-b. At least a fluid outlet 148 may be in a distance with at least a pair of electrodes 120a-b or reaction region 128. Such distance may impact the time and space available for at least a fluid to mix and interact with the plasma or other process components. In some cases, at least a fluid outlet 148 may be configured to provide an optimal flow pattern and dispersion of the at least a fluid into reaction region 128. In a non-limiting example, at least a fluid outlet 148 may include a nozzle (i.e., a specially-shaped opening) designed to create a directed, high-velocity stream of at least a fluid, which may improve mixing and dispersion in reaction region 128. Such a nozzle may include, without limitation, swirl nozzle, fan spray nozzle, impinging jet nozzle, multi-hole nozzle, atomizing nozzle, and the like.

Additionally, or alternatively, and still referring to FIG. 1, injector 140 may include one or more valves configured to monitor, control, or otherwise regulate the flow of at least a fluid fed through reaction region 128 of plasma reactor 116. As used in this disclosure, a “valve” is a component that controls fluidic communication between two or more components (e.g., between at least a reservoir 112 and injector 140). Exemplary non-limiting valves include directional valves, control valves, selector valves, multi-port valves, check valves, and the like. Valves may include any suitable valve construction including ball valves, butterfly valves, needle valves, globe valves, gate valves, wafer valves, regulator valves, and the like. Valves may be included in a manifold of hydraulic or pneumatic circuit, for example allowing for multiple ports and flow paths. Valves may be actuated by any known method, such as without limitation by way of hydraulic, pneumatic, mechanical, or electrical energy. For instance, in some cases, a valve may be actuated by an energized solenoid or electric motor. Valve actuators and thereby valves themselves, may be controlled by computing device as described in further detail below. Computing device may be in communication with valve, for example by way of one or more of electrical communication, hydraulic communication, pneumatic communication, mechanical communication, and the like. Further, injector 140 and elements thereof will be explained in greater detail below in this disclosure.

With continued reference to FIG. 1, apparatus 100 include a pressure regulator configured to transfer at least a fluid to injector. As used in this disclosure, a “pressure regulator” or “pressure regulation system” is a component and/or mechanism designed to control and maintain the pressure of at least a fluid, wherein such pressure drives the flow of the at least a fluid into plasma reactor 116. In an embodiment, the flow of fluid may be regulated by the pressure of gas, as higher gas pressure produces more fluid flow. In some cases, higher gas pressure also regulates fluid droplet size, for example, high gas pressure equals smaller water droplet size. In an embodiment, pressure regulation system may include an atmospheric pressure system. As used in this disclosure, an “atmospheric pressure system” is a mechanism that controls the pressure of at least a fluid being introduced into the plasma reactor 116 around atmospheric pressure. “Atmospheric pressure,” for the purpose of this disclosure, is the pressure exerted by the weight of air in the Earth's atmosphere at sea level, which is approximately 101.3 kilopascals (kPa) or 14.7 pounds per square inch (psi). In some embodiments, pressure regulator and/or pressure regulation system may ensure that at least a fluid being injected into reaction region 128 of plasma reactor 116 is maintained at or near atmospheric pressure. In some embodiments, pressure regulator and/or pressure regulation system may be responsible for transferring the fluid from at least a reservoir 112 to injector 140, providing a consistent and controlled flow of at least a fluid into reaction region 128 of plasma reactor 116.

With continued reference to FIG. 1, in some cases, pressure regulator and/or pressure regulation system may include a flow component connected with at least a reservoir 112 configured to flow at least a fluid from at least a fluid inlet 144 of injector 140 or outlet of at least a reservoir 112 to at least a fluid outlet 148 of injector 140. ressure regulator may include the valves described above. In some embodiments, flow component may include a passive flow component configured to initiate a passive flow process. As used in this disclosure, a “passive flow component” is a component that imparts a passive flow on at least a fluid, wherein the “passive flow,” for the purpose of this disclosure, is flow of fluid, which is induced absent any external actuators, fields, or power sources. A “passive flow process,” as described herein, is a plurality of actions or steps taken on passive flow component in order to impart a passive flow on at least a fluid. In a non-limiting example, with pressure regulator and/or pressure regulation system including passive flow component, injector 140 may be able to feed at least a fluid through reaction region 128 as a function of passive flow process. Passive flow component may employ one or more passive flow techniques in order to initiate passive flow process; for instance, and without limitation, passive flow techniques may include osmosis, capillary action, surface tension, pressure, gravity-driven flow, hydrostatic flow, vacuums, and the like. Passive flow component may be in fluidic communication with at least a reservoir 112.

Still referring to FIG. 1, in other embodiments, a flow component may include an active flow component configured to initiate an active flow process. As used in this disclosure, an “active flow component” is a component that imparts an active flow on a fluid, wherein the “active flow,” for the purpose of this disclosure, is flow of fluid which is induced by external actuators, fields, or power sources. An “active flow process,” as described in this disclosure, is a plurality of actions or steps taken on active flow component in order to impart active flow on at least a fluid. In some embodiments, active flow component may be electrically connected to power source as described above. In a non-limiting example, with pressure regulator and/or pressure regulation system including active flow component, injector 140 may be able to feed at least a fluid through reaction region 128 as a function of active flow process. pressure and/or pressure regulation system may be configured to pressurize at least a fluid entering reaction region 128 of plasma reactor 116; for instance, and without limitation, active flow component of pressure regulator and/or pressure regulation system may include one or more pumps. Pump may include a substantially constant pressure pump (e.g., centrifugal pump) or a substantially constant flow pump (e.g., positive displacement pump, gear pump, and the like). Pump can be hydrostatic or hydrodynamic. As used in this disclosure, a “pump” is a mechanical source of power that converts mechanical power into fluidic energy. A pump may generate flow with enough power to overcome pressure induced by a load at a pump outlet. A pump may generate a vacuum at a pump inlet, thereby forcing fluid from a reservoir into the pump inlet to the pump and by mechanical action delivering this fluid to a pump outlet. Hydrostatic pumps are positive displacement pumps.

Hydrodynamic pumps can be fixed displacement pumps, in which displacement may not be adjusted, or variable displacement pumps, in which the displacement may be adjusted. Exemplary non-limiting pumps include gear pumps, rotary vane pumps, screw pumps, bent axis pumps, inline axial piston pumps, radial piston pumps, and the like. Pump may be powered by any rotational mechanical work source, for example without limitation, an electric motor or a power take off from power source. Pump may be in fluidic communication with at least a reservoir 112. With continued reference to FIG. 1, apparatus 100 may further include a condenser 156 disposed within reaction region above or below treatment chamber. As used in this disclosure, a “condenser” is a component configured to collect reactive products generated from electric discharge within reaction region 128 of plasma reactor 116. Condenser 156 may be made of steel wool, metal wool, copper, carbon steel and the like. Condenser 156 may be located at or near the outlet and/or may be mounted at the bottom of the reaction region 128 in order to allow for vaporized water to condense to water droplets. In an embodiment, condenser 156 may be a piece of steel wool that is placed in the bottom of apparatus 100 or into a conduit or pipe connected to it. In some cases, condenser 156 may be disposed inside a conduit. In an embodiment, condenser 156 may not be an external component but may be integrated within a conduit itself wherein the conduit may include a pipe that allows for the flow of fluids such as gases or liquids, from one part of the condenser 156 to another or from the condenser 156 to another component of apparatus 100. In some embodiments, condenser 156 may be strategically placed between reaction region 128 configured to collect reactive products before they come into contact with growth medium 104 contained in treatment chamber 108. In some cases, reactive products may include ions, free radicals, electrons, excited molecules, and the like as described above; for instance, and without limitation, ROS and/or RNS. In other cases, reactive products may include byproducts or waste products produced during the treatment process. In a non-limiting example, reactive products may include carbon monoxide (CO) and/or carbon dioxide (CO2), wherein these gases may be produced as a result of the decomposition of growth medium 104 or the reaction of electrical discharge with impurities in growth medium 104. Other exemplary byproducts or waste products may include, without limitation, ozone, volatile organic compounds (VOCs), and the like.

With continued reference to FIG. 1, condenser 156 may include a cooling chamber. As used in this disclosure, a “cooling chamber” is a component configured to rapidly cool reactive products coming (i.e., falling) from reaction region 128 of plasma reactor. In some embodiments, cooling chamber may be configured to ensure efficient heat transfer and maintain optimal temperature conditions for the condensation process. Cooling chamber may be constructed from materials with thermal conductivity, such as, without limitation, copper, aluminum, stainless steel, and the like. In some cases, materials may also be chemically resistant to reactive products and at least a fluid used in the system. Cooling chamber may be non-conductive and constructed from materials such as, without limitation, plastics, glass, fiberglass and the like. In some embodiments, cooling chamber of condenser 156 may be designed in a shape consistent with the shape of plasma reactor 116 or treatment chamber 108; for instance, and without limitation, cooling chamber may be designed in a cylindrical shape, consistent with the shape of plasma reactor 116 and treatment chamber 108 to optimize the flow of reactive products and maximize a contact surface area between a cooling medium and reactive products, wherein the cooling medium may include water, air, refrigerant, and/or the like configured to remove heat from reactive products efficiently. In some cases, interior of cooling chamber may be equipped with fins, coils, plates, and/or the like to further enhance the heat transfer process (i.e., by increasing the surface area of the cooling chamber). In a non-limiting example, cooling chamber may include a heat exchanger, wherein the heat exchanger may be configured to facilitate the transfer of heat from reactive products to the cooling medium.

With continued reference to FIG. 1, condenser 156 may include a collection surface. As used in this disclosure, a “collection surface” is a designated area within condenser 156 where reactive products come into contact with the cooling chamber and undergo a phase change, transitioning from a first state to a second state. In a non-limiting example, collection surface may be configured to enable reactive products in gaseous state to transit to liquid state. Such transition may allow apparatus 100 to efficiently collect and subsequently handle or transport condensed substances. In some embodiments, collection surface may include various surface features such as, without limitation, ridges, channels, and the like to facilitate the flow of condensed/collected substances. In a non-limiting example, collection surface may include a flat surface, wherein the flat surface may include a plurality of channels or grooves designed to facilitate the flow of condensed reactive products away from collection surface. Additionally, or alternatively, collection surface may include a surface finish; for instance, and without limitation, collection surface may be finished or treated (e.g., using hydrophobic coating, hydrophilic coating, and/or the like) to enhance the wetting properties and reduce surface tension, thereby improving condensation efficiency and fluid flow further.

With continued reference to FIG. 1, condenser 156 may include at least a conduit. As used in this disclosure, a “conduit” is a passageway for substances (i.e., condensed reactive products) to move from one location to another location within apparatus 100. In a non-limiting example, condenser 156 may use one or more conduits to transfer condensed reactive products from collection surface to growth medium 104 contained in treatment chamber 108. In some cases, conduit may be designed with a circular cross-sectional shape. In some cases, conduit may be thermally insulated to maintain a desired temperature of the condensed reactive products and/or prevent any unwanted chemical reactions during transport using material such as fiberglass. In some embodiments, one or more conduits may be connected to collection surface in a manner that ensures a leak-proof connection; for instance, and without limitation, such connection between collection surface and one or more conduits may be established using threaded fittings, compression fittings, flange, and the like. In some embodiments, one or more conduits may be routed from collection surface to treatment chamber 108 with minimized interference with other components of apparatus 100 to ensure a smooth flow of the condensed reactive products; for instance, and without limitation, proper support and/or anchoring of conduits may be installed to prevent conduits from sagging, vibrating, experiencing any other mechanical stress that could cause leaks or damages. Additionally, or alternatively, conduits may incorporate one or more valves to regulate the flow of condensed reactive products into treatment chamber 108. Valves may include any valves described in this disclosure. Persons skilled in the art, upon reviewing the entirety of this disclosure, will be aware of various devices/components that may be used within condenser 156 of apparatus 100.

With continued reference to FIG. 1, apparatus 100 may include a computing device configured to control various internal components as described above, such as, without limitation, plasma reactor 116, ignition unit 132, injector 140, condenser 156, and the like. Computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented using a “shared nothing” architecture in which data is cached at the worker, in an embodiment, this may enable scalability of apparatus 100 and/or computing device.

With continued reference to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, in some embodiments, internal components of apparatus 100 may be in communication with the computing device using one or more signals. As used in this disclosure, a “signal” is a human-intelligible and/or machine-readable representation of data, for example and without limitation an electrical and/or digital signal from one device to another; signals may be passed using any suitable communicative connection. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. A signal may include an optical signal, a hydraulic signal, a pneumatic signal, a mechanical signal, an electric signal, a digital signal, an analog signal and the like. In some cases, a signal may be used to communicate with a computing device, for example by way of one or more ports. In some cases, a signal may be transmitted and/or received by computing device, for example by way of an input/output port. An analog signal may be digitized, for example by way of an analog to digital converter. In some cases, an analog signal may be processed, for example by way of any analog signal processing steps described in this disclosure, prior to digitization. In some cases, a digital signal may be used to communicate between two or more devices, including without limitation computing devices. In some cases, a digital signal may be communicated by way of one or more communication protocols, including without limitation (e.g., universal asynchronous receiver-transmitter [UART]), parallel communication protocols (e.g., IEEE 128 [printer port]), and the like.

Further referring to FIG. 1, in some cases, apparatus 100 and/or computing device may perform one or more signal processing steps on a signal. For instance, apparatus 100 and/or computing device may analyze, modify, and/or synthesize a signal representative of data in order to improve the signal, for instance by improving transmission, storage efficiency, or signal to noise ratio. Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, phase-locked loops, and/or any other process using operational amplifiers or other analog circuit elements. Continuous-time signal processing may be used, in some cases, to process signals which vary continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

With continued reference to FIG. 1, apparatus 100 may include a housing 160 configured to house various internal components such as, without limitation, treatment chamber 108, plasma reactor 116, ignition unit 132, injector 140, pressure regulator, condenser 156, computing device, and the like thereof. As used in this disclosure, a “housing” is an outer structure or enclosure that contains and supports various internal components of apparatus 100. In some cases, housing 160 may provide protection, stability, and/or organization to apparatus 100. In an embodiment, housing 160 may be designed to accommodate and securely hold internal components of apparatus 100. In some cases, housing 160 may include a plurality of layers, wherein one or more internal components of apparatus 100 may be strategically placed into each layer of plurality of layers, thereby minimizing physical or functional interference between internal components of apparatus 100. In a non-limiting example, housing 160 may include a first layer incorporating ignition unit 132, a second layer incorporating injector 140, a third layer incorporating plasma reactor 116, and a fourth layer incorporating treatment chamber 108 containing growth medium 104. Each layer may be physically isolated but functionally connected in various means (e.g., fluidic connection, electrical connection, and the like thereof); for instance and without limitation, continuous conductor 136 may be used to connect ignition unit 132 and at least an electrode of at least a pair of electrode 120a-b of plasma reactor 116 configured to transmit electrical power from first layer of housing 160 to third layer of housing 160, wherein continuous conductor may travel from first layer of housing 160 to third layer of housing 160 through second layer of housing 160 externally. For another instance, and without limitation, at least a fluid outlet 148 of injector 140 may be mechanically fixed to the bottom of second layer or top of third layer of housing 160, wherein the at least a fluid outlet 148 may include a first end connected to injector 140 and a second end extended into third layer of housing 160 that incorporates plasma reactor 116. In such embodiment, at least a fluid contained within at least a reservoir 112 may be introduced into plasma reactor 116 and further through reaction region 128 from second layer of housing 160 to third layer of housing 160. Additionally, or alternatively, housing 160 may include a proper insulation of the electrode wire (continuous conductor 136) configured to prevent electrical shorts or interference with other components in housing 160. In a non-limiting example, an insulator may be used at a point where continuous conductor 136 passes through housing 160, as described in further detail with reference to FIG. 2.

Now referring to FIG. 2, an exemplary FIG. 2 is an exemplary embodiment of a plasma reactor assembly 200. Plasma reactor assembly 200 may include a housing 204. In an embodiment, housing 204 may be a portion of housing 160 as described above. In another embodiment, housing 204 may be a separate housing configured to only house plasma reactor 116. In a non-limiting example, plasma reactor 116 may be double-housed, wherein housing 204 may be disposed within third layer of housing 160 as illustrated in FIG. 1. At least a pair of electrodes 120a-b and reaction region 128 in between electrodes of at least a pair of electrodes 120a-b may be disposed within housing 204. In some cases, housing 204 may be injection molded via an injectable mold. As used in this disclosure, an “injectable mold” is a manufacturing tool for producing plastic parts. Manufacturing housing 204 may include using an injection molding process, wherein the injection molding process may involve a use of injectable mold configured to create specific shape and features of housing 204. In some embodiments, injectable mold may include two halves that are clamped together, with one or more cavities in between, wherein the cavities may define the shape of housing 204. In some cases, material such as, without limitation, molten plastic may be injected into the injectable mold under high pressure, filling the space and taking on the shape of injectable mold. Injection molding process may include a cooling process which is configured to cool and/or solidify injected material. Injectable mold may be then opened and finished housing 204 may be removed. In some embodiments, injectable mold may be precisely machined to desired shape and size of housing 204. In a non-limiting example, housing 204 may include a hollow cylinder.

With continued reference to FIG., one or more continuous conductor 136a-b may pass through housing 204, with one end electrically connected to at least an electrode 208 of at least a pair of electrodes 120a-b. In some cases, at least an electrode 208 may include a first electrode 120a. In other cases, at least an electrode 208 may include second electrode 120b. Another end of continuous conductor 136a-b may be connected to ignition unit 132 or ground 124 as described above with reference to FIG. 1. In some embodiments, one or more insulators 212a-b may be used at the point where continuous conductor 136a-b passes through housing 204. An “insulator,” for the purpose of this disclosure, is a material that does not readily conduct heat, electricity, or sound. In a non-limiting example, insulators 212a-b may include electrical insulators, wherein the electrical insulators are material that have high electrical resistivity. Electrical insulators may not readily conduct electric current, thereby preventing the flow of electricity between plasma reactor 116 with other components except ignition unit 132, reducing the risk of short circuits, electrical shocks, interference, and the like. Exemplary electrical insulator may include plastics, ceramics, glass, rubber, and the like.

With continued reference to FIG. 2, each electrode of at least a pair of electrodes 120a-b may include a pitch angle 216. In a non-limiting example, at least an electrode 208 may include a pitch angle 216 of from 6 degrees to 8 degrees such that an angle between faces of the at least a pair of electrodes is from 12 degrees to 16 degrees. As used in this disclosure, a “pitch angle” of an electrode refers to an angle between the electrode's longitudinal axis and a reference plane or axis within plasma reactor 116. In an embodiment, the cone shape of the injector discharge may be from 12 degrees to 15 degrees and the pitch angle of the electrode 208 may be from 6 degrees to 8 degrees. In an embodiment, the injector pitch may match the electrode 208 or vice versa. In some cases, pitch angle 216 may impact on characteristics of plasma generated between electrodes in reaction region 128 such as, without limitation, electric field distribution, efficiency of electrical discharge process, interaction with reactive species (e.g., ROS, RNS, and the like) within the plasma.

With continued reference to FIG. 2, injector 140 may be connected to plasma reactor 116 via an injector mount flange 220. As used in this disclosure, an “injector mount flange” is a mechanical component used to securely attach injector 140 to housing 204 in a reliable and leak-proof manner. In a non-limiting example, injector mount flange 220 may include an interface 224 between injector 140 and plasma reactor 116. In some cases, at least a fluid outlet 148 of injector 140 may include a threaded adaptor. Both at least a fluid outlet 148 and interface 224 may include a threaded section; for instance, and without limitation, at least a fluid outlet 148/interface 224 may include a male/female threaded section, wherein the male and the female threaded section are compatible (i.e., matched). Injector 140 may be threaded, via at least a fluid outlet 148 with threaded adaptor onto injector mount flange 220 at interface 224. In an embodiment, the bottom of the injector 140 may be a fluid outlet 148 having an opening at the bottom which allows the gas and water to exit in a controlled spray cone. The outside of the fluid outlet 148 may be threaded. The mount flange 220 may feature an interface 224 with matching threads in the center of it allowing for the injector 140 to securely connect to it. In an embodiment, the position of the fluid outlet 148 in the mount flange 220 may allow for the release of the gas and water to exit directly into the center of the reaction region 128.

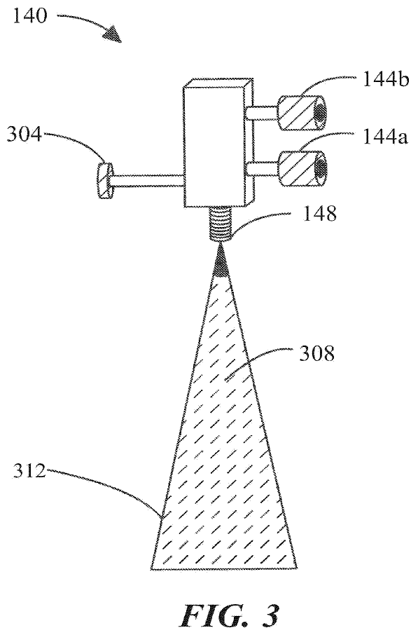

Now referring to FIG. 3, an exemplary embodiment of an injector 140 with a flow adjustment component 304 is illustrated. In some embodiments, injector 140 may include a plurality of fluid inlets 144a-b. In a non-limiting example, injector 140 may include a first fluid inlet 144a in fluidic connection with first reservoir, wherein the first fluid inlet may be configured to accept first fluid from first reservoir. First fluid may include one or more gases as described above. Injector 140 may include a second fluid inlet 144b in fluidic connection with second reservoir, wherein second fluid inlet 144b may be configured to accept second fluid from second reservoir. Second fluid may include liquid such as, without limitation, water. In some cases, at least a fluid outlet 148 may be configured to output a mixture of first fluid and second fluid in the form of droplets to plasma reactor. As used in this disclosure, “droplets” refer to small, spherical-shaped liquid particles. In a non-limiting example, injector 140 may produce droplets through different mechanisms, such as, without limitation, pressure-driven atomization, ultrasonic atomization, electrostatic atomization, and the like. Injector 140 may break second fluid down into small droplets which may then be dispersed and mixed with first fluid. In some cases, droplets may carry reactants into reaction region 128 of plasma reactor 116. In some cases, droplets may enhance the mixing and interaction between different fluids or reactive species within plasma reactor, thereby improving the efficiency and/or uniformity of the treatment process.

With continued reference to FIG. 3, as used in this disclosure, a “flow adjustment component” is a device that allows for the precise control and regulation of the fluid flow rate through the injector. In some cases, flow adjustment component 304 may include a manual flow control valve which can be adjusted by hand to regulate the fluid flow rate through injector 140. In a non-limiting example, by turning a knob, valve opening or the opening of at least a fluid outlet 148 may be changed, allowing for more or less fluid to pass through injector 140 or introduce into plasma reactor 116. Additionally, or alternatively, flow adjustment component 304 may include an 8X turn-down ratio. As used in this disclosure, a “turn-down ratio” is a measure of the versatility and flexibility of flow adjustment component 304 which indicates how well flow adjustment component 304 may accommodate different flow rate requirements within a system. Such flow adjustment component 304 may control fluid flow rate over a range of eight times the minimum flow rate. For example, if the minimum flow rate of flow adjustment component 304 is 1 gallon per minute (GPM), an 8X turn-down ratio may indicate that flow adjustment component 304 may be able to effectively regulate flow rates from 1 GPM up to 8 GPM. In a non-limiting example, at least a fluid outlet 148 of injector 140 may output gas and 5-8μ water drops 308 in a 12-15 degree spray cone 312. In an embodiment, the adjustment component 304 may terminate the fluid flow.

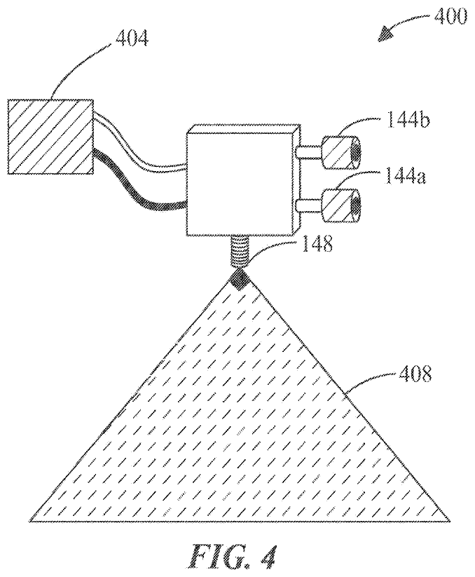

Now referring to FIG. 4, an exemplary embodiment of a piezo vapor injector, such as a piezo water vapor injector 400, is illustrated. As used in this disclosure, a “piezo water vapor injector” is a type of injector 140 that utilizes piezoelectric technology to generate water vapor by atomizing at least a liquid (i.e., second fluid) into fine droplets as described above. “Water vapor,” as described herein, is the gaseous phase of water (i.e., second fluid), which occurs when water molecules gain enough energy to break free from liquid state and become dispersed in surrounding air (i.e., first fluid). “Piezoelectric technology,” as described herein, is a technology based on a piezoelectric effect: a phenomenon where certain materials generated an electric charge when subjected to mechanical stress or other way around (i.e., undergo mechanical deformation when exposed to electric field). In some cases, materials such as ceramics (e.g., lead zirconate titanate), quartz crystals, polymers, and the like may exhibit such an effect. Piezo water vapor injector 400 may include a piezoelectric element; for instance, and without limitation, a ceramic disk or plate may be used to create mechanical vibrations at certain frequencies when an electrical voltage is applied by power source 404. Power source 404 may include any power source as described above in this disclosure such as a DC power supply. Mechanical vibrations may be transmitted to at least a fluid input from at least a fluid inlet (i.e., first fluid inlet 144a and/or second fluid inlet 144b), thereby causing at least a fluid to break up into fine droplets of mist, which then evaporate to form water vapor. In a non-limiting example, at least a fluid outlet 148 of piezo water vapor injector 400 may output at least 90 degrees water vapor and air discharge cone. In an embodiment, piezo water vapor injector 400 may have a single inlet which is only for water. In an embodiment, the piezo water vapor injector 400 may discharge into a chamber that features a port where water enters and a second port where air and water vapor exit into reaction region 128. In another embodiment, piezo water vapor injector 400 may dispense water vapor directly into a plasma reactor 116 and a second gas only injector may discharge directly into the reaction region 128.

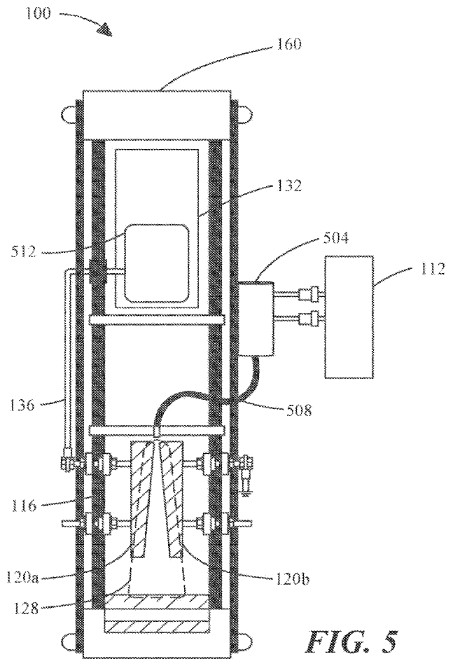

Now referring to FIG. 5, an exemplary embodiment of apparatus 100 for treating a growth medium via an electrical discharge with an external mounted injector 504 is illustrated. As used in this disclosure, an “external mounted injector” is an injector that is installed on the exterior of apparatus 100, rather than being integrated within apparatus 100 as described above with reference to FIGS. 1-4. External mounted injector 504 may include any injector as described above such as, without limitation, injector 140 (air & water injector), Piezo water vapor injector 400, and the like. In some embodiments, external mounted injector 504 may be designed to deliver at least a fluid from at least a reservoir 112 into plasma reactor 116 from an external location via a tube 508. In a non-limiting example, external mounted injector 504 may be mechanically fixed to the exterior of housing 160. In some cases, external mounted injector 504 may be attached to exterior of housing 160 via screw or bolt fastening, clamp or clip fastening, sliding or snap-fit connections, and/or the like.

Additionally, or alternatively, and still referring to FIG. 5, ignition unit 132 may include a coil 512. As used in this disclosure, a “coil” is a wound spiral or helix of conductive wire that creates an electromagnetic field when an electric current flows through it. In a non-limiting example, coil 512 may be electrically connected to at least an electrode (i.e., first electrode 120a) of at least a pair of electrodes 120a-b, configured to initiate electrical discharge in plasma reactor 116. Coil may include an induction coil or a high-voltage transformer coil, wherein the induction coil or the high-voltage transformer coil may generate high-voltage electrical pulses necessary to create electrical discharge between first electrode 120a and second electrode 120b.

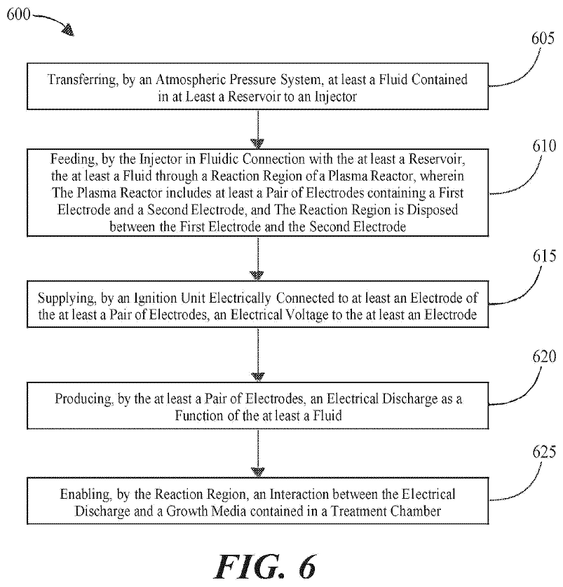

Now referring to FIG. 6, a flow diagram of an exemplary embodiment of a method 600 for treating a growth medium via an electrical discharge is illustrated. Method 600 includes step 605 of transferring, by an atmospheric pressure system, at least a fluid contained in at least a reservoir to an injector. In some embodiments, the at least a reservoir may include a first reservoir configured to contain a first fluid, and a second reservoir configured to contain a second fluid, wherein the first fluid may include at least a gas, and the second fluid may include at least a liquid. In some embodiments, the pressure regulator may be configured to pressurize the at least a fluid entering the reaction region. This may be implemented, without limitation, as described herein.

With continued reference to FIG. 6, method 600 includes a step 610 of feeding, by the injector in fluidic connection with the at least a reservoir, the at least a fluid through a reaction region of a plasma reactor, wherein the plasma reactor may include at least a pair of electrodes containing a first electrode and a second electrode, and the reaction region is disposed between the first electrode and the second electrode. In some embodiments, the injector may include a first fluid inlet in fluidic connection with the first reservoir, wherein the first fluid inlet is configured to accept the first fluid from the first reservoir, a second fluid inlet in fluidic connection with the second reservoir, wherein the second fluid inlet is configured to accept the second fluid from the second reservoir, and at least a fluid outlet configured to output a mixture of the first fluid and the second fluid in a form of droplets to the plasma reactor. The method of claim 11, wherein the injector comprises a flow adjustment component configured to regulate the flow of the at least a fluid entering the reaction region. This may be implemented, without limitation, as described herein.

With continued reference to FIG. 6, method 600 includes step 615 of supplying, by an ignition unit electrically connected to at least an electrode of the at least a pair of electrodes, an electrical voltage to the at least an electrode. In some embodiments, the ignition unit may include an ignition circuit configured to converts electrical power received from a power source into a high-voltage discharge of 6 kV to 30 kV. This may be implemented, without limitation, as described herein.

With continued reference to FIG. 6, method 600 includes step 620 of producing, by the at least a pair of electrodes, an electrical discharge as a function of the at least a fluid. In some embodiments, the first electrode of the at least a pair of electrodes may be configured to diverge from the second electrode of the at least a pair of electrodes. In some embodiments, an angle between faces of the at least a pair of electrodes may be from 12 degrees to 16 degrees. In another embodiment, the pitch angle of the electrodes may be from 6 degrees to 8 degrees and the spray cone of the injector may be from 12 degrees to 15 degrees. In some embodiments, the reaction region may include a plurality of points of arc between the first electrode of the at least a pair of electrodes and the second electrode of the at least a pair of electrodes. This may be implemented, without limitation, as described herein.

With continued reference to FIG. 6, method 600 includes step 625 of enabling, by the reaction region, an interaction between the electrical discharge and a growth medium contained in a treatment chamber. This may be implemented, without limitation, as described herein.

With continued reference to FIG. 6, method 600 may include a step of collecting, using a condenser disposed within the reaction region above the treatment chamber, reactive species generated during the production of the electrical discharge in the reaction region. Method 600 may further include a step of transferring, using the condenser, the reactive species to the treatment chamber. This may be implemented, without limitation, as described herein.

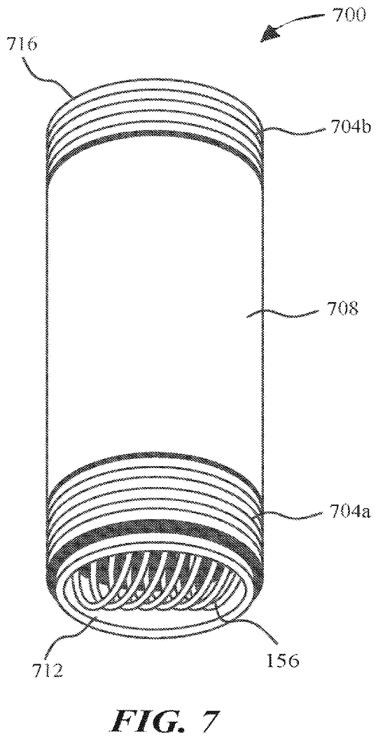

Now referring to FIG. 7, an exemplary embodiment of a segment of conduit 700 is illustrated. Conduit 700 may include any conduit as described above with reference to FIG. 1. In some embodiments, conduit 700 may include a pipe that allows for the flow of fluids such as gases or liquids, from one part of the condenser 156 to another or from the condenser 156 to another component of apparatus 100. In some cases, conduit of condenser 156 may include a plurality of segments of conduit, wherein the plurality of segments of conduit are connected with each other. In a non-limiting example, a plurality of short conduit segments may be connected to form a long conduit within condenser 156 to provide a longer passageway for fluids. In some cases, connection between two segments of conduit may be established through a mechanical interface. In a non-limiting example, segment of conduit 700 may include a body 708, a first mechanical interface 704a, and a second mechanical interface 704b, wherein the first mechanical interface 704a may be connected with a first segment of conduit at a proximal end 712 of the body 708 and the second mechanical interface 704b may be connected with a second segment of conduit at a distal end 716 of body 708. In some cases, mechanical interface may include a swivel joint, wherein the “swivel joint,” as used herein, is a mechanical device used to join two or more components, such as segments of conduit, in a manner that allows for rotational movement along a connection axis. Swivel joint may be designed to withstand the pressure exerted by the flowing fluid and the mechanical stresses caused by the rotation. Connected segment of conduit such as first segment of conduit and second segment of conduit may include matching profiles that allow for assembly and secure connection at their corresponding end. In some cases, proximal end 712 may include an outlet for flow fluids while distal end 716 may include an inlet for flow fluids or vice versa. Other exemplary mechanical interface may include, without limitation, elbow joint, tree joint, cross joint, union joint, coupling joint, reducer joint, flange joint, and/or the like.

Still referring to FIG. 7, in some cases, condenser 156 may be disposed inside conduit. In an embodiment, condenser 156 may not be an external component but is integrated within conduit itself In some cases, condenser 156 may be constructed from thermally conductive materials such as, without limitation, copper, or aluminum. In a non-limiting example, condenser 156 may include stainless steel wool and may be configured to allow fluid such as, without limitation, water vapor, to condense back into droplets of water as described herein. In such embodiments, conduit may serve not only as a pathway for fluid flow but also as a containment vessel for condenser 156 and as a secondary pathway for heat dissipation.

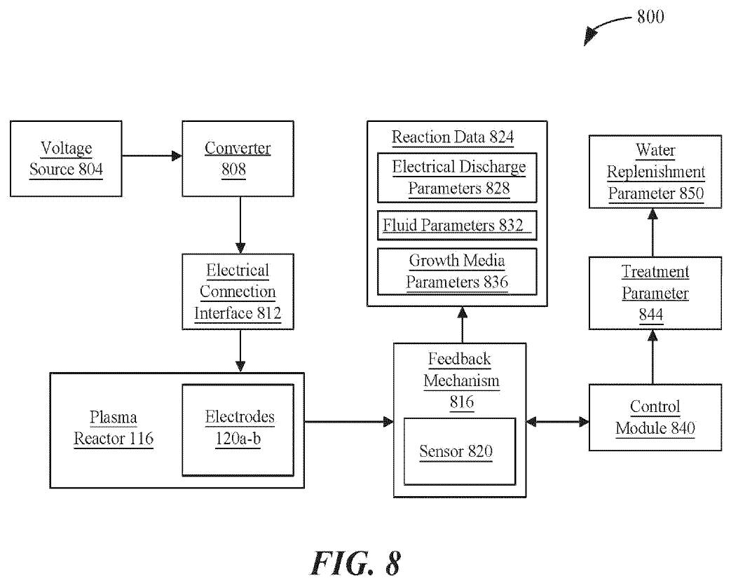

Now referring to FIG. 8, an exemplary embodiment of an ignition unit 132 is illustrated. Ignition unit includes a voltage source 804. As used in this disclosure, a “voltage source” is an electrical device that provides a stable and continuous electrical potential difference (i.e., voltage) between two points in an electrical circuit. In some embodiments, voltage source 804 may supply the energy required for the operation of various circuit, devices, and/or components in apparatus 100. In a non-limiting example, ignition unit 132 may include an ignition circuit, wherein the ignition circuit is an electrical system/circuit that is used to initiate the formation of plasma in plasma reactor 116 as described above with reference to FIGS. 1-2. Voltage source 804 connected within ignition may provide the electrical energy required for generating and/or maintaining electrical discharge between at least a pair of electrodes 120a-b within reaction region 128. In an embodiment, voltage source 804 may include an AC power supply, wherein the alternating current (AC) power supply may provide a sinusoidal or non-sinusoidal waveform with a specific frequency, amplitude, and/or phase angle. In another embodiment, voltage source 804 may include a direct current (DC) power supply, wherein the DC power supply may provide a constant voltage level. In a further non-limiting example, voltage source 804 may include one or more batteries; for instance, and without limitation, ignition unit 132 may include a portable or standalone ignition unit, wherein the batteries may store electrical energy in the form of chemical energy and convert it to electrical energy when required. In some cases, batteries may include, without limitation, lead-acid batteries, lithium-ion batteries, nickel-metal hydride batteries, and the like.

With continued reference to FIG. 8, ignition unit 132 includes a converter 808. As used in this disclosure, a “converter” is an electrical component that transforms electrical energy from one waveform to another. In some cases, converter 808 may modify properties of electrical energy such as, without limitation, voltage, current, waveform, and/or the like. In an embodiment, converter 808 is configured to convert electrical voltage from a DC voltage input to an AC voltage output. In some cases, electrical discharges may be generated and sustained more effectively using AC rather than DC; for instance, and without limitation, AC voltage oscillates between first electrode 120a and second electrode 120b may help plasma reactor 116 in ionizing at least a fluid injected, maintaining the plasma, and/or preventing the build-up of charges on at least a pair of electrodes 120a-b. In a non-limiting example, converter 808 may include an DC to AC converter, wherein the DC to AC converter may convert DC voltage input to AC voltage output with specific waveform, frequency, and/or amplitude. In an embodiment, convertr 808 may also convert AC to AC. For example, AC to AC converters may be used for converting the AC waveforms with one particular frequency and magnitude to AC waveform with another frequency at another magnitude. For example, an AC voltage controller may be a thyristor-based device which converts fixed alternating voltage directly to variable alternating voltage without a change in frequency. AC voltage controller may be a phase-controlled device and hence no force commutation circuitry may be required and natural or line commutation may be used. In such an embodiment, converter may include an inverter. In a non-limiting example, converter 808 may include a switching circuit, wherein the switching circuit is an electrical circuit that is designed to rapidly turn a device on and off in order to control the flow of current or voltage through the circuit. Switching circuit may generate a series of square-wave pulses that approximate the shape of AC waveform; for instance, and without limitation, converter 808 may convert DC and/or AC voltage input to a pulsed output such as a symmetrical or asymmetrical square wave, a pulse train, and/or any other wave form including a triangular sawtooth, or other waveform. In some cases, frequency of square-wave pulses may be determined by an oscillator circuit, wherein the oscillator circuit is an electrical circuit that generates a periodic signal or waveform (e.g., sine wave, square wave, and the like). In some cases, converter 808 may use an electronic circuit to modify frequency of periodic signal; for instance, and without limitation, converter 808 may include a frequency multiplier, a frequency divider, a frequency mixer, a phase-locked loops (PLLs), and/or the like to increase or decrease the frequency of periodic signal.

Still referring to FIG. 8, converter 808 may include a transformer. A “transformer,” for the purpose of this disclosure, is an electrical device that is used to transfer electrical energy from a first circuit to a second circuit via electromagnetic induction. In an embodiment, transformer may be used to increase or decrease voltage of AC power supply, to isolate circuits from each other, and/or to match impedance of a load to a source. In a non-limiting example, transformer may include ignition transformer as described above with reference to FIG. 1. Additionally, or alternatively, switching circuit may include one or more solid-state devices such as, without limitation, power MOSFETs, IGBTs, thyristors, and/or the like to control the flow of current through the circuit. In a non-limiting example, switching circuit may be controlled; for instance, solid-state devices within switching circuit may be turned on and off, by control module that monitors or controls the output voltage and current of converter 808 as described in further detail below. In some embodiments, converter 808 may be configured to convert the DC voltage input to a high-voltage discharge at frequency up to 10,000 kHz (10 MHz). Converter 808 configured to convert DC voltage input to AC voltage output may be implemented using various circuit topologies, such as, without limitation, H-bridge, full-bridge, or half-bridge configurations, and may incorporate pulse-width modulation (PWM) techniques for voltage and frequency control.

With continued reference to FIG. 8, ignition unit 132 may include a dielectric barrier discharge (DBD) operation. As used in this disclosure, a “dielectric barrier discharge (DBD)” is a type of plasma discharge that occurs between two electrodes separated by a dielectric material. In some cases, dielectric material may act as an insulator 212a-b as described above, preventing the direct flow of current between at least a pair of electrodes. In a non-limiting example, DBD operation may include applying high voltage, provided by voltage source 804 and converted through converter 808, to at least a pair of electrodes 120a-b, wherein first electrode 120a and/or second electrode 120b of least a pair of electrodes 120a-b may be insulated by a dielectric. Dielectric material may include, without limitation, quartz, ceramic, glass, and the like. Instead of plurality of points of arc, a plurality of fine plasma filaments may be formed between at least a pair of electrodes 120a-b, wherein plurality of fine plasma filaments may only have a very short lifetime in the range of a few nanoseconds. In some embodiments, DBD may be a non-thermal (cold) plasma due to such low lifetime of DBD, wherein the heavy particles may absorb far less energy from the alternating field than lighter and faster electrons. In some embodiments, DBD operation may be operated at atmospheric pressure via pressure regulation system as described above with reference to FIG. 1.

With continued reference to FIG. 8, in some embodiments, converter 808 may be capable of converting AC voltage input into DC voltage output. In some cases, ignition unit 132 may need to convert AC to DC power supply in order for apparatus 100 to perform a pulsed operation. During the pulse plasma operation, plasma reactor 116 may operate in a pulsed mode, where the plasma may be generated and sustained for short periods followed by a period of no electrical discharge. DC power supply may be easily controlled and switched on and off as required, thereby making it suitable for pulsed plasma operation. In some cases, apparatus 100 may convert AC to DC power supply to reduce electrode wear and contamination; for instance, and without limitation, in AC-powered plasma reactor 116, the constantly changing polarity of electrodes may lead to accelerated electrode wear and the release of electrode material into the generated plasma. By using a DC power supply, the electrodes may maintain a constant polarity, reducing wear and contamination and increasing lifetime of the electrodes. In a non-limiting example, ignition unit 132 may include a rectifier. As used in this disclosure, a “rectifier” is an electrical device or circuit that converts AC to DC. Rectifier may be built using one or more diodes, wherein the diodes are semiconductor devices that allow electrical current to flow in only one direction and have a low resistance to electrical current flow in the forward direction (when electrical voltage is positive) and a high resistance to electrical current flow in the reverse direction (when electrical voltage is negative). In some cases, rectifier may include, without limitation, half-wave rectifier, full-wave rectifier, and the like.

With continued reference to FIG. 8, ignition unit 132 includes an electrical connection interface 812 configured to electrically connect converter 808 to at least one electrode of at least a pair of electrodes 120a-b disposed in plasma reactor 116. As used in this disclosure, an “electrical connection interface” is a physical and electrical arrangement that enables the transfer of electrical energy or signals between two or more devices and/or components. In a non-limiting example, electrical connection interface 812 may establish an electrical connection between voltage source 804/converter 808 and at least one electrode of at least a pair of electrodes 120a-b. Such an electrical connection may allow current to flow (i.e., AC voltage output) between voltage source 804/converter 808 and at least one electrode of at least a pair of electrodes 120a-b. In a non-limiting example, electrical connection interface 812 may include an electrical connector, wherein the electrical connector is an electromechanical device used to create electrical connection. In some embodiments, electrical connection interface 812 may include a gender; for instance, and without limitation, electrical connection interface 812 may include a male component connects to a female component. In a non-limiting example, at least one electrode may include a screw terminal, wherein screw terminal may allow one end of continuous conductor 136 to be attached by tightening a screw. Another end of continuous conductor 136 may include a male component such as a plug, may be connected to a female component located on ignition unit 132 such as a socket. Other exemplary embodiment of electrical connection interface 812 may include, without limitation, a cable, a terminal, connectors, wire-to-board/board-to-board connections, and the like.

With continued reference to FIG. 8, ignition circuit includes a feedback mechanism 816. Feedback mechanism 816 includes a sensor 820 configured to detect reaction data 824. As used in this disclosure, “reaction data” are information related to reactions that occurred in reaction region 128 of plasma reactor 116 and processes or operations of apparatus 100 that initiated, caused, or otherwise maintained the reactions. In some cases, reactions may include, without limitation, electrical discharge generation, plasma generation, and/or any chemical reactions as described above in this disclosure. In an embodiment, reaction data 824 may include a plurality of electrical discharge parameters 828. “Electrical discharge parameters,” for the purpose of this disclosure, are measurable properties or characteristics of electrical discharge process (i.e., plasma generation, electrical arcing, and the like). In a non-limiting example, electrical discharge parameters 828 may include, without limitation, electrical voltage, electrical current, discharge frequency, waveform, phase angle, and the like thereof. In another embodiment, reaction data 824 may include a plurality of fluid parameters 832. “Fluid parameters,” for the purpose of this disclosure, are measurable properties or characteristics of a fluid (i.e., first fluid and/or second fluid) involved in the treatment process. In a non-limiting example, fluid parameters 832 may include, without limitation, flow rate, pressure, fluid temperature, fluid viscosity, fluid density, fluid turbidity or clarity, and the like. In a further embodiment, reaction data 824 may include a plurality of growth medium parameters 836. “Growth medium parameters,” for the purpose of this disclosure, are measurable properties or characteristics of growth medium contained in treatment chamber 108 during the treatment process. In a non-limiting example, growth medium parameters 836 may include, without limitation, light properties, temperature of growth medium, humidity level within treatment chamber 108, optical properties of the growth medium (e.g., growth, absorption, reflectance, transmittance, etc.), and the like.

With continued reference to FIG. 8, as used in this disclosure, a “feedback mechanism” is a system that provides information (i.e., reaction data 824 as listed above) about the output, outcome, or otherwise performance of a device, component, or system back to a control element (i.e., control module as described below). In an embodiment, feedback mechanism 816 may include a negative feedback mechanism, wherein reaction data 824 provided by feedback loop may be used to counteract/oppose the change in system's output or apparatus operation. In such an embodiment, feedback mechanism 816 may maintain apparatus performance within a desired range or setpoint, event in the presence of disturbances or changes in operating conditions. In another embodiment, feedback mechanism 816 may include a positive feedback mechanism, wherein reaction data 824 provided by feedback loop may be used to amplify/reinforce the change in system's output or apparatus operation. In such embodiment, feedback mechanism 816 may lead to rapid changes or exponential growth in system's behavior such as, without limitation, amplification of signals electrical circuits within apparatus 100.

With continued reference to FIG. 8, as used in this disclosure, a “sensor” is a device that detects, measure, or otherwise convert a physical, chemical, or environmental property into an electrical signal, which can be processed and/or analyzed by device/system feedback mechanism 816 connected to. In some embodiments, sensor 820 may include at least one sensor selected from plurality of sensors consisting of a voltage sensor, a moisture sensor, a temperature sensor, and an optical sensor. As used in this disclosure, a “voltage sensor” is a device configured to measure the different ranges of voltage (mV-kV) between two points in an electrical circuit. In some cases, voltage sensor may operate at different frequencies, from DC to high-frequency AC; for instance, and without limitation, voltage sensor may be configured to measure either AC and/or DC voltage. In a non-limiting example, voltage sensor may be connected across electrodes of at least a pair of electrodes 120a-b or within reaction region 128 to continuously monitor the voltage levels. Such voltage sensor may include a high-voltage probe with a resistive divider.

With continued reference to FIG. 8. as used in this disclosure, a “moisture sensor” is a device configured to detect the amount of moisture present in a material, or a space, such as, without limitation, treatment chamber 108 connected to plasma reactor 116. Moisture sensor may be employed by feedback mechanism 816 to monitor the moisture content or humidity of growth medium or treatment chamber 108. In a non-limiting embodiment, moisture sensor may include a capacitive moisture sensor, wherein the capacitive moisture sensor is a type of moisture sensor that works by measuring a capacitance of a sensing element, wherein the sensing element is a thin film or a hygroscopic material such as, without limitation, a polymer or metal oxide, which absorbs or releases fluid molecules based on the surrounding humidity. Capacitive moisture sensor may include two electrodes separated by the sensing element, thereby forming a capacitor. When sensing element contains moisture, the capacitance of capacitive moisture sensor may change, as molecules of at least a fluid in the material increases effective area of electrodes. In a non-limiting example, sensor 820 may determine a moisture level of treatment chamber 108 by measuring the change in capacitance of capacitive moisture sensor. Additionally, or alternatively, in another non-limiting embodiment, moisture sensor may include a resistance moisture sensor, wherein the resistance moisture sensor is a type of moisture sensor that works by measuring electrical resistance of sensing element in a similar manner. In a non-limiting example, electrical current may be passed through sensing element, and the voltage drop across electrodes may be measured. Resistance may be calculated based on Ohm's law. Sensor 820 may then determine moisture level as a function of the calculated resistance of sensing element.

With continued reference to FIG. 1, as used in this disclosure, a “temperature sensor” is a device configured to measure temperature of other devices/components within apparatus 100. In a non-limiting example, sensor 820 may include, without limitation, thermocouples, thermistors, thermometers, passive infrared sensors, resistance temperature sensors (RTD's), semiconductor based integrated circuits (IC), a combination thereof or another undisclosed sensor type, alone or in combination. “Temperature,” for the purposes of this disclosure, and as would be appreciated by someone of ordinary skill in the art, is a measure of the heat energy of a system. Temperature, as measured by temperature sensor, may be measured in Fahrenheit (° F.), Celsius (° C.), Kelvin (° K), or another scale alone or in combination. In some embodiments, sensor 820 may be configured to measure the temperature of ignition unit 132, plasma reactor 116, and/or treatment chamber 108 during treatment process using temperature sensor. In other embodiments, temperature sensor may be configured to measure the temperature of surrounding environment of apparatus 100.

With continued reference to FIG. 1, in a further embodiment, sensor 820 may include an optical device. As used in this disclosure, an “optical device” is any device that generates, transmits, detects, or otherwise functions using electromagnetic radiation, including without limitation ultra-violet light, visible light, near infrared light, infrared light, and the like. In some embodiments, optical device may include one or more waveguide. As used in this disclosure, a “waveguide” is a component that is configured to propagate electromagnetic radiation, including without limitation ultra-violet light, visible light, near infrared light, infrared light, and the like. A waveguide may include a lightguide, a fiberoptic, or the like. A waveguide may include a grating within a transmissive material. In some cases, a waveguide may be configured to function as one or more optical devices, for example a resonator (e.g., microring resonator), an interferometer, or the like. In some cases, waveguide may be configured to propagate electromagnetic radiation (EMR). In a non-limiting example, sensor 820 may include a sensor, wherein the sensor may be optical communication with one or more waveguide. Such sensor may be configured to detect a variance in at least an optical property associated with growth medium 104. As used in this disclosure, an “optical property” is any detectable characteristic associated with electromagnetic radiation, for instance UV, visible light, infrared, and the like.

With continued reference to FIG. 1, in some embodiments, sensor 820 may include at least a photodetector. In some cases, sensor 820 may include a plurality of photodetectors, for instance at least a first photodetector and at least a second photodetector. In some cases, at least a first photodetector and/or at least a second photodetector may be configured to measure one or more of first optical output and second optical output, from a first waveguide and a second waveguide, respectively. As used in this disclosure, a “photodetector” is any device that is sensitive to light and thereby able to detect light. In some cases, a photodetector may include a photodiode, a photoresistor, a photosensor, a photovoltaic chip, and the like. In some cases, photodetector may include a Germanium-based photodiode. Light detectors may include, without limitation, Avalanche Photodiodes (APDs), Single Photon Avalanche Diodes (SPADs), Silicon Photomultipliers (SiPMs), Photo-Multiplier Tubes (PMTs), Micro-Channel Plates (MCPs), Micro-Channel Plate Photomultiplier Tubes (MCP-PMTs), Indium gallium arsenide semiconductors (InGaAs), photodiodes, and/or photosensitive or photon-detecting circuit elements, semiconductors and/or transducers. Avalanche Photo Diodes (APDs), as used herein, are diodes (e.g., without limitation p-n, p-i-n, and others) reverse biased such that a single photon generated carrier can trigger a short, temporary “avalanche” of photocurrent on the order of milliamps or more caused by electrons being accelerated through a high field region of the diode and impact ionizing covalent bonds in the bulk material, these in turn triggering greater impact ionization of electron-hole pairs. APDs provide a built-in stage of gain through avalanche multiplication. When the reverse bias is less than the breakdown voltage, the gain of the APD is approximately linear. For silicon APDs this gain is on the order of 10-100. Material of APD may contribute to gains. Germanium APDs may detect infrared out to a wavelength of 1.7 micrometers. InGaAs may detect infrared out to a wavelength of 1.6 micrometers. Mercury Cadmium Telluride (HgCdTe) may detect infrared out to a wavelength of 14 micrometers. An APD reverse biased significantly above the breakdown voltage is referred to as a Single Photon Avalanche Diode, or SPAD. In this case the n-p electric field is sufficiently high to sustain an avalanche of current with a single photon, hence referred to as “Geiger mode.” This avalanche current rises rapidly (sub-nanosecond), such that detection of the avalanche current can be used to approximate the arrival time of the incident photon. The SPAD may be pulled below breakdown voltage once triggered in order to reset or quench the avalanche current before another photon may be detected, as while the avalanche current is active carriers from additional photons may have a negligible effect on the current in the diode. At least a first photodetector may be configured to generate a first signal as a function of variance of an optical property of the first waveguide, where the first signal may include without limitation any voltage and/or current waveform. Additionally, or alternatively, sensor device may include a second photodetector located down beam from a second waveguide. In some embodiments, second photodetector may be configured to measure a variance of an optical property of second waveguide and generate a second signal as a function of the variance of the optical property of the second waveguide.

With continued reference to FIG. 1, in some cases, photodetector may include a photosensor array, for example without limitation a one-dimensional array. Photosensor array may be configured to detect a variance in an optical property of waveguide. In some cases, first photodetector and/or second photodetector may be wavelength dependent. For instance, and without limitation, first photodetector and/or second photodetector may have a narrow range of wavelengths to which each of first photodetector and second photodetector are sensitive. As a further non-limiting example, each of first photodetector and second photodetector may be preceded by wavelength-specific optical filters such as bandpass filters and/or filter sets, or the like; in any case, a splitter may divide output from optical matrix multiplier as described below and provide it to each of first photodetector and second photodetector. Alternatively, or additionally, one or more optical elements may divide output from waveguide prior to provision to each of first photodetector and second photodetector, such that each of first photodetector and second photodetector receives a distinct wavelength and/or set of wavelengths. For example, and without limitation, in some cases a wavelength demultiplexer may be disposed between waveguides and first photodetector and/or second photodetector; and the wavelength demultiplexer may be configured to separate one or more lights or light arrays dependent upon wavelength. As used in this disclosure, a “wavelength demultiplexer” is a device that is configured to separate two or more wavelengths of light from a shared optical path. In some cases, a wavelength demultiplexer may include at least a dichroic beam splitter. In some cases, a wavelength demultiplexer may include any of a hot mirror, a cold mirror, a short-pass filter, a long pass filter, a notch filter, and the like. An exemplary wavelength demultiplexer may include part No. WDM-11P from OZ Optics of Ottawa, Ontario, Canada. Further examples of demultiplexers may include, without limitation, gratings, prisms, and/or any other devices and/or components for separating light by wavelengths that may occur to persons skilled in the art upon reviewing the entirety of this disclosure. In some cases, at least a photodetector may be communicative with computing device (i.e., by means of sensed signal) as described below in this disclosure.

With continued reference to FIG. 8, ignition unit 132 may include a control module 840 communicatively connected to feedback mechanism 816 configured to control various other components of ignition unit 132, such as, without limitation, voltage source 804, converter 808, feedback mechanism 816, and the like. Control module may include an analog or digital control circuit, or any combination thereof, such as an operational amplifier circuit, a transistor-based circuit, or other analog circuit, a combinational logic circuit using one or more gates, a synchronous or asynchronous sequential logic circuit using one or more registers, latches, or other state-preserving elements, a finite state machine, or the like. Control module 840 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Control module 840 may include a single computing device operating independently, or may include two or more computing device operating in concert, in parallel, sequentially or the like; two or more computing devices may be included together in a single computing device or in two or more computing devices. Control module 840 may interface or communicate with one or more additional devices as described below in further detail via a network interface device. Network interface device may be utilized for connecting control module 840 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Control module 840 may include but is not limited to, for example, a computing device or cluster of computing devices in a first location and a second computing device or cluster of computing devices in a second location. Control module 840 may include one or more computing devices dedicated to data storage, security, distribution of traffic for load balancing, and the like. Control module 840 may distribute one or more computing tasks as described below across a plurality of computing devices of computing device, which may operate in parallel, in series, redundantly, or in any other manner used for distribution of tasks or memory between computing devices. Control module 840 may be implemented using a “shared nothing” architecture in which data is cached at the worker, in an embodiment, this may enable scalability of apparatus 100 and/or computing device.

With continued reference to FIG. 8, control module 840 may be designed and/or configured to perform any method, method step, or sequence of method steps in any embodiment described in this disclosure, in any order and with any degree of repetition. For instance, control module 840 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Control module 840 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 8, as used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Still referring to FIG. 8, in some embodiments, internal components of apparatus 100 may be in communication with the control module 840 using one or more signals. As used in this disclosure, a “signal” is a human-intelligible and/or machine-readable representation of data, for example and without limitation an electrical and/or digital signal from one device to another; signals may be passed using any suitable communicative connection. A signal may include an optical signal, a hydraulic signal, a pneumatic signal, a mechanical signal, an electric signal, a digital signal, an analog signal, and the like. In some cases, a signal may be used to communicate with a control module 840, for example by way of one or more ports. In some cases, a signal may be transmitted and/or received by control module 840, for example by way of an input/output port. An analog signal may be digitized, for example by way of an analog to digital converter. In some cases, an analog signal may be processed, for example by way of any analog signal processing steps described in this disclosure, prior to digitization. In some cases, a digital signal may be used to communicate between two or more devices, including without limitation feedback mechanism 816 and control module 840. In some cases, a digital signal may be communicated by way of one or more communication protocols, including without limitation (e.g., universal asynchronous receiver-transmitter [UART]), parallel communication protocols (e.g., IEEE 128 [printer port]), and the like.

With further reference to FIG. 8, in some cases, control module 840 may perform one or more signal processing steps on a signal. For instance, control module 840 may analyze, modify, and/or synthesize a signal representative of data in order to improve the signal, for instance by improving transmission, storage efficiency, or signal to noise ratio. Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, phase-locked loops, and/or any other process using operational amplifiers or other analog circuit elements. Continuous-time signal processing may be used, in some cases, to process signals which vary continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

With continued reference to FIG. 8, control module 840 is configured to initiate a generation of electrical discharge in reaction region 128 disposed between first electrode 120a and the second electrode 120b as a function of AC voltage output. Control module 840 may regulate electrical voltage provided by voltage source 804. In a non-limiting example, control module 840 may apply AC voltage output converted by converter 808 from converter 808 to at least one electrode of at least a pair of electrodes 120a-b. An AC electric field may be established between first electrode 120a and second electrode 120b in reaction region 128. When AC electric field becomes strong enough, electrical discharge may ionize at least a fluid passing through reaction region 128, thereby creating electrical discharge. Reaction region 128 is then configured to enable an interaction between electrical discharge and growth medium 104. Control module 840 may receive reaction data 824 detected by sensor 820 within feedback mechanism 816 during interaction between electrical discharge and growth medium 104. Reaction data 824 may include any reaction data as described in this disclosure, such as, without limitation, plurality of electrical discharge parameters 828, fluid parameters 832, growth medium parameters 836, and the like. Feedback mechanism 816 may provide such reaction data 824 to control module 840. Control module 840 may process reaction data 824 and adjust the operations of ignition unit 12 accordingly as described in further detail below to maintain optimal discharge conditions and achieve the desired treatment effects.

With continued reference to FIG. 8, in an embodiment, control module 840 may adjust at least a treatment parameter 844 of apparatus 100 as a function of reaction data 824. As used in this disclosure, a “treatment parameter” is operating parameters configured to optimize the treatment process based on the information (e.g., reaction data 824) received from feedback mechanism 816 as described above. In an embodiment, treatment parameter 844 may include an AC electrical voltage; for instance, and without limitation, control module 840 may adjust the amplitude of AC electrical voltage supplied to at least an electrode of at least a pair of electrodes 120a-b, wherein the AC electrical voltage may affect the intensity of electrical discharge and the energy transferred to the plasma. In another embodiment, treatment parameter 844 may include an AC frequency; for instance, and without limitation, control module 840 may change the AC frequency of the AC electrical voltage, wherein AC frequency may influence the generation of specific plasma species or the rate of chemical reactions. In a further embodiment, treatment parameter 844 may include a pulse width, wherein the pulse width refers to a duration or time interval during which a pulse signal is in its “on” state. In a non-limiting example, ignition unit 132 may include a pulse-width modulation to modulate the AC voltage provided by voltage source 804 or output by converter 808. Control module 840 may adjust pulse width of the modulated signal to control the AC voltage output to at least one electrode of at least a pair of electrodes 120a-b. In other embodiments, treatment parameter 844 may include a phase angle, wherein the phase angle describes a difference in timing or position between two wave forms with same the same frequency. In a non-limiting example, control module 840 may control phase angle between the electrical voltage and electrical current waveforms to optimize power transfer of ignition unit 132 and maintain a stable electrical discharge within plasma reacto 116. Other exemplary embodiments of treatment parameter 844 may include, without limitation, fluid flow rate of at least a fluid, fluid composition of at least a fluid, and the like.

Continuing to reference FIG. 8, control module 840 may use a machine learning module, to implement one or more algorithms or generate one or more machine-learning models, such as treatment machine learning model, to determine at least one treatment parameter 844. However, the machine learning module is exemplary and may not be necessary to generate one or more machine learning models and perform any machine learning described herein. In one or more embodiments, one or more machine-learning models may be generated using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories of data elements. Exemplary inputs and outputs may come from a database, such as any database described in this disclosure, or be provided by a user of apparatus 100. In other embodiments, a machine-learning module may obtain a training set by querying a communicatively connected database that includes past inputs and outputs. Training data may include inputs from various types of databases, resources, and/or user inputs and outputs correlated to each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories of data elements by, for example, associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements. Machine leaning module may be used to generate treatment machine learning model using training data. Treatment machine learning model may be trained by correlated inputs and outputs of training data. Training data may be data sets that have already been converted from raw data whether manually, by machine, or any other method. Training data may include previous outputs such that treatment machine learning model iteratively produces outputs. Treatment machine learning model using a machine-learning process may output converted data based on input of training data.

With continued reference to FIG. 8, in an embodiment, adjusting at least a treatment parameter 844 may include determining at least a treatment parameter 844 using a machine leaning model, such as treatment machine-learning model. Treatment machine learning model may be trained by training data, such as treatment training data. Determining at least a treatment parameter 844 based on the reaction data 824 using a machine learning model may include receiving user treatment training data. In an embodiment, treatment training data may include a plurality of reaction data 824 that are each correlated to at least a treatment parameter 844. In another embodiment, each element of reaction data 824 may correlated to a plurality of treatment parameters 844. For example, and without limitation, treatment training data may be used to show reaction data may indicate a particular treatment parameter 844. Control module may adjust treatment parameters 844 to ensure precise and effective treatment of growth medium 104 and optimizing the treatment process for desired outcomes. In an embodiment, treatment training data may include a plurality of electrical discharge parameters 828 that are each correlated to at least one treatment parameter 844. In such embodiment, treatment training data may be used to show how one or more electrical discharge parameters 828 may indicate one or more treatment parameters 844. In another embodiment, treatment training data may also include a plurality of fluid parameters 832 that are each correlated to at least one treatment parameter 844. In such an embodiment, treatment training data may be used to show how one or more fluid parameters 832 may indicate one or more treatment parameters 844. In a further embodiment, treatment training data may further include a plurality of growth medium parameters 836 that are each correlated to at least one treatment parameter 844. In such an embodiment, treatment training data may be used to show how one or more growth medium parameters 836 may indicate one or more treatment parameters 844. Determining at least one treatment parameter 844 using a machine learning model may further include training treatment machine learning model as a function of treatment training data and determining at least one treatment parameter 844 using trained treatment machine learning model.

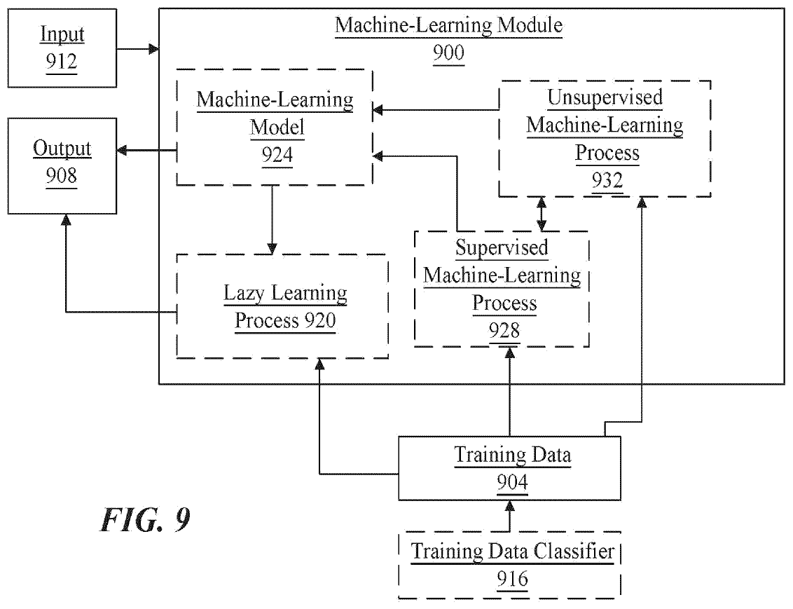

Referring now to FIG. 9, an exemplary embodiment of a machine-learning module 900 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 904 to generate an algorithm that will be performed by a computing device/module to produce outputs 908 given data provided as inputs 912; this is in contrast to a non-machine learning software program where the commands to be executed are determined in advance by a user and written in a programming language.

Still referring to FIG. 9, “training data,” as used herein, is data containing correlations that a machine-learning process may use to model relationships between two or more categories of data elements. For instance, and without limitation, training data 904 may include a plurality of data entries, each entry representing a set of data elements that were recorded, received, and/or generated together; data elements may be correlated by shared existence in a given data entry, by proximity in a given data entry, or the like. Multiple data entries in training data 904 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 904 according to various correlations; correlations may indicate causative and/or predictive links between categories of data elements, which may be modeled as relationships such as mathematical relationships by machine-learning processes as described in further detail below. Training data 904 may be formatted and/or organized by categories of data elements, for instance by associating data elements with one or more descriptors corresponding to categories of data elements. As a non-limiting example, training data 904 may include data entered in standardized forms by persons or processes, such that entry of a given data element in a given field in a form may be mapped to one or more descriptors of categories. Elements in training data 904 may be linked to descriptors of categories by tags, tokens, or other data elements; for instance, and without limitation, training data 904 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively, or additionally, and continuing to refer to FIG. 9, training data 904 may include one or more elements that are not categorized; that is, training data 904 may not be formatted or contain descriptors for some elements of data. Machine-learning algorithms and/or other processes may sort training data 904 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 904 to be made applicable for two or more distinct machine-learning algorithms as described in further detail below. Training data 904 used by machine-learning module 900 may correlate any input data as described in this disclosure to any output data as described in this disclosure.

Further referring to FIG. 9, training data may be filtered, sorted, and/or selected using one or more supervised and/or unsupervised machine-learning processes and/or models as described in further detail below; such models may include without limitation a training data classifier 916. Training data classifier 916 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 900 may generate a classifier using a classification algorithm, defined as a processes whereby a computing device and/or any module and/or component operating thereon derives a classifier from training data 904. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 9, machine-learning module 900 may be configured to perform a lazy-learning process 920 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 904. Heuristic may include selecting some number of highest-ranking associations and/or training data 904 elements. Lazy learning may implement any suitable lazy learning algorithm, including without limitation a K-nearest neighbors algorithm, a lazy naive Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 9, machine-learning processes as described in this disclosure may be used to generate machine-learning models 924. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 924 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 924 may be generated by creating an artificial neural network, such as a convolutional neural network comprising an input layer of nodes, one or more intermediate layers, and an output layer of nodes. Connections between nodes may be created via the process of “training” the network, in which elements from a training data 904 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 9, machine-learning algorithms may include at least a supervised machine-learning process 928. At least a supervised machine-learning process 928, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include reaction data as described above as inputs, at least a treatment parameter as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 904. Persons skilled in the art, upon reviewing the entirety of this disclosure, will be aware of various possible variations of at least a supervised machine-learning process 928 that may be used to determine relation between inputs and outputs. Supervised machine-learning processes may include classification algorithms as defined above.

Further referring to FIG. 9, machine learning processes may include at least an unsupervised machine-learning processes 932. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 9, machine-learning module 900 may be designed and configured to create a machine-learning model 924 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 9, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

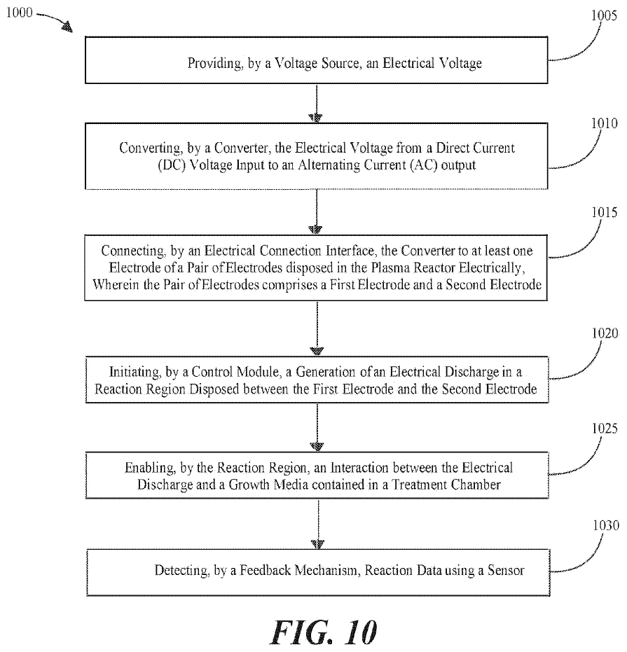

Now referring to FIG. 10, a flow diagram of an exemplary embodiment of a method 1000 for treating a growth medium via an electrical discharge is illustrated. Method 1000 includes step 1005 of providing, by a voltage source, an electrical voltage. This may be implemented, without limitation, as described herein.

With continued reference to FIG. 10, method 1000 includes step 1010 of converting, by a converter, the electrical voltage from a direct current (DC) voltage input to an alternating current (AC) output. In some embodiments, the converter may be configured to the DC voltage input to a high-voltage discharge at 10,000 kHz (10 MHz). This may be implemented, without limitation, as described herein.

With continued reference to FIG. 10, method 1000 includes a step 1015 of connecting, by an electrical connection interface, the converter to at least one electrode of a pair of electrodes disposed in the plasma reactor electrically, wherein the pair of electrodes comprises a first electrode and a second electrode. In some embodiments, the first electrode of the at least a pair of electrodes may be configured to diverge from the second electrode of the at least a pair of electrodes. In some embodiments, each electrode of at least a pair of electrodes may include a pitch angle of from 6 degrees to 8 degrees (for a combined angle between the at least a pair of electrodes of from 12 degrees to 16 degrees). In some embodiments, at least one electrode of the pair of electrodes may include a dielectric insulation. This may be implemented, without limitation, as described herein.

With continued reference to FIG. 10, method 1000 includes step 1020 of initiating, by a control module, a generation of an electrical discharge in a reaction region disposed between the first electrode and the second electrode. In some embodiments, the reaction region may include a plurality of points of arc between the first electrode of the at least a pair of electrodes and the second electrode of the at least a pair of electrodes. This may be implemented, without limitation, as described herein.

With continued reference to FIG. 10, method 1000 includes step 1025 of enabling, by the reaction region, an interaction between the electrical discharge and a growth medium contained in the treatment chamber. This may be implemented, without limitation, as described herein.

With continued reference to FIG. 10, method 1000 includes step 1030 of detecting, by a feedback mechanism, reaction data using a sensor. In some embodiments, the sensor may include at least one sensor selected from a plurality of sensors consisting of a voltage sensor, a current sensor, a temperature sensor, a moisture sensor, and an optical sensor. In some embodiments, the reaction data may include a plurality of electrical discharge parameters, a plurality of fluid parameters, and a plurality of growth medium parameters. This may be implemented, without limitation, as described herein.

With continued reference to FIG. 10, method 1000 may include steps of receiving, by the control module, the reaction data detected by the sensor from the feedback mechanism and adjusting, by the control module, at least a treatment parameter of the apparatus as a function of the reaction data. In some embodiment, adjusting the at least a treatment parameter may include training, by the control module, a treatment machine-learning model using treatment training data, wherein the treatment training data may include a plurality of reaction data as input correlated to a plurality of treatment parameters as output and determining, by the control module, at least a treatment parameter as a function of the trained treatment machine-learning model. This may be implemented, without limitation, as described herein.

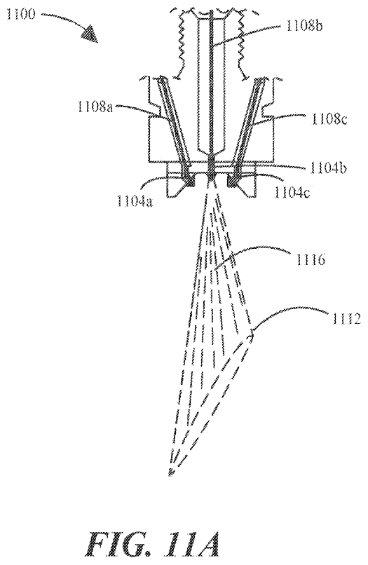

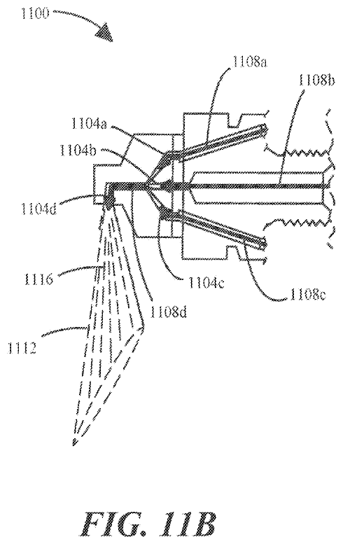

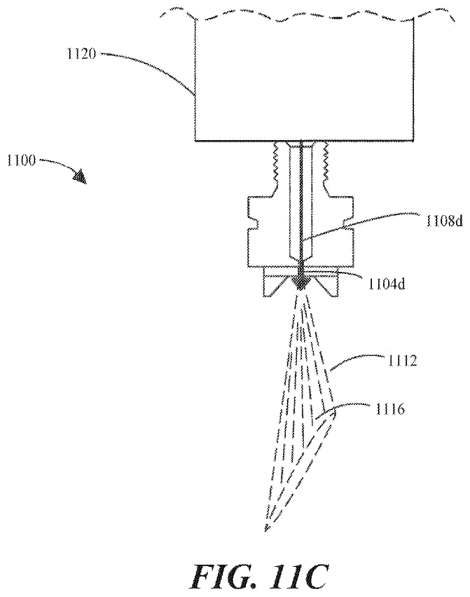

Now referring to FIGS. 11A-C, exemplary embodiments of a portion of an injector 1100 for a plasma reactor are illustrated. As used in this disclosure, a “plasma reactor” is a device configured to generate, sustain, and/or control plasma. “Plasma,” for the purpose of this disclosure, refers to the fourth state of matter, in addition to solid, liquid, and gas. Plasma may include a partially ionized gas consisting of a mixture of ions, electrons, and/or neutral particles (i.e., atoms and molecules). In an embodiment, plasma may be formed when at least a fluid subject to high-energy source, such as, without limitation, heat, radiation, electric filed, and the like, causing the atoms or molecules in at least a fluid to become ionized by losing or gaining electrons. At least a fluid may be input into plasma reactor using injector 1100 as described below in this disclosure. In some cases, plasma may include non-thermal plasma (NTP), wherein the non-thermal plasma is a type of plasma in which the electron temperature is significantly higher than the temperature of the heavier ions and neutral particles. In this case, while the electrons in plasma have high kinetic energy, the overall temperature of at least a fluid may remain relatively low (e.g., often near room temperature of 30-32° C./68-72° F.). Additionally, or alternatively, the energy distribution among particles within non-thermal plasma may not be in thermal equilibrium due to the electrons, being much lighter than ions and neutral particles, may gain energy more rapidly when subjected to an electric or magnetic field, leading to a higher electron temperature. On the other hand, heavier ions and neutral particles may move more slowly and remain cooler, resulting in low temperature of at least a fluid. As used in this disclosure, a “fluid” is a gaseous or liquid material that can flow, including without limitation water, nitrogen, oxygen, and/or other gases and/or liquids.

With continued reference to FIGS. 11A-C, as used in this disclosure, an “injector” is a component designed to introduce at least a fluid into a plasma reactor. Specifically, injection may occur in reaction region of plasma reactor. In a non-limiting example, injector 1100 is configured to feed at least a fluid through reaction region of the plasma reactor. As used in this disclosure, a “reaction region” is a designated area or space within plasma reactor where specific chemical or physical reactions take place. At least a fluid may then be used by the plasma reactor to generate plasma. “Fluidic connection,” for the purpose of this disclosure, refers to a pathway or link that enables the transfer of at least a fluid. In a non-limiting example, fluidic connection between injector 1100 and at least a reservoir may be established using various components such as, without limitation, tubes, pipes, hoses, channels, or the like to create a continuous pathway for the flow of at least a fluid.

With continued reference to FIGS. 11A-C, in some embodiments, an injector 1100 includes at least a fluid outlet 1104a-d. As used in this disclosure, a “fluid outlet” is an exit point through which at least a fluid is discharged from injector 1100 into reaction region of plasma reactor. In some embodiments, at least a fluid outlet 1104a-d is configured to output the at least a fluid in a cone distribution 1112 to the plasma reactor. For the purposes of this disclosure, a “cone distribution” of droplets is the shape of distribution of droplets of at least a fluid that resembles a cone-like shape. As a non-limiting example, the at least a fluid dispersed from the at least a fluid outlet 1104a-d may include the cone distribution 1112 due to the physics of fluid dynamics. For example, and without limitation, when the at least a fluid exits a nozzle of the at least a fluid outlet 1104a-d, it initially travels in a straight line before it encounters the surrounding air. As at least a fluid enters the air, it is subjected to aerodynamic forces, such as drag and turbulence, which cause it to spread out in cone distribution 1112. This phenomenon is known as the Coanda effect, which describes the tendency of a fluid jet to adhere to a nearby surface, such as the surface of the air surrounding the droplets 1116. The cone distribution 1112 may also be influenced by the size and shape of the nozzle of the at least a fluid outlet 1104a-d, the pressure and velocity of the at least a fluid, and the properties of the surrounding air. In some embodiments, the cone distribution 1112 includes a distribution angle. For the purposes of this disclosure, a “distribution angle” of a cone distribution refers to an angle between the cone distribution's longitudinal axis and a reference plane or axis within plasma reactor. As a non-limiting example, the distribution angle of the cone distribution of the at least a fluid may include various angles, such as but not limited to 12°, 13°, 14°, 15°, and the like. In some embodiments, the cone distribution of droplets may coincide with a shape of a pair of electrodes of plasma reactor. As a non-limiting example, when a pitch angle of the pair of electrodes is 6° (i.e., when an angle between the pair of electrodes is) 12°, the distribution angle of the cone distribution of the at least a fluid may include 12°. In some embodiments, the cone distribution 1112 includes droplets 1116 of the at least a fluid. As used in this disclosure, “droplets” refer to small, spherical-shaped liquid particles. In some embodiments, at least a fluid outlet 1104a-d may output various size of the droplets 1116 of at least a fluid. As a non-limiting example, the droplets may include microfine droplets. For the purposes of this disclosure, “microfine droplet” is a droplet that has a diameter of less than 110 micrometers. For example, and without limitation, the diameter of the microfine droplets of the droplets 1116 may include 5μ, 6μ, 7μ, 8μ, and the like. In some cases, at least a fluid outlet 1104a-d may be configured to allow at least a fluid to be released into the intended location within reaction region. For example, and without limitation, at least a fluid outlet 1104a-d may be placed at the center and right above at least a pair of electrodes.

With continued reference to FIGS. 11A-C, in some embodiments, at least a fluid outlet 1104a-d may be configured to produce a nitrogen oxide (NOx) concentration. For example, and without limitation, when plasma reacts with air, it may produce a variety of reactive species, including nitrogen oxides (NOx). The reactive species disclosed herein are further described below. The NOx species, for example and without limitation, may react with droplets 1116 in a plasma reactor to form nitric acid. Since nitric acid is highly soluble in the at least a fluid, it can get absorbed by the droplets 1116, leading to an increase in the concentration of NOx in the microfine droplets. The least a fluid outlet 1104a-d may be at a distance with at least a pair of electrodes or reaction region. Such distance may impact the time and space available for at least a fluid to mix and interact with the plasma or other process components. In some cases, at least a fluid outlet 1104a-d may be configured to provide an optimal flow pattern and dispersion of the at least a fluid into reaction region. In a non-limiting example, at least a fluid outlet 1104a-d may include a nozzle (i.e., a specially-shaped opening). For the purposes of this disclosure, a “nozzle” is a component that is configured to create a directed, high-velocity stream of at least a fluid. In some embodiments, the nozzle may improve mixing and dispersion of at least a fluid in reaction region. Such nozzle may include, without limitation, swirl nozzle, fan spray nozzle, impinging jet nozzle, multi-hole nozzle, atomizing nozzle, and the like. In another non-limiting example, such nozzle may include, without limitation, ultrasonic nozzle, compressed air nozzle, high-pressure nozzle, low-pressure nozzle, aerodynamic nozzle, micro-fog nozzle, mist line nozzle, and the like. In some embodiments, at least a fluid outlet 1104a-d may be configured to output a mixture of a first fluid and a second fluid from a first fluid inlet and a second fluid inlet in the form of droplets to plasma reactor.

With continued reference to FIGS. 11A-C, in an embodiment, at least a fluid outlet 1104a-d may include ultrasonic atomization to create droplets 1116. As a non-limiting example, the at least a fluid outlet 1104a-d may use high-frequency sound waves to create waves on the surface of the at least a fluid, which in turn create droplets 1116 that are released into the air. In another embodiment, the at least a fluid outlet 1104a-d may include air pressure atomization to create the droplets 1116. As a non-limiting example, the at least a fluid outlet 1104a-d may use compressed air to force water through a nozzle, creating microfine droplets. In another embodiment, the at least a fluid outlet 1104a-d may include centrifugal atomization to create the droplets 1116. As a non-limiting example, the at least a fluid outlet 1104a-d may use a spinning disk or wheel to fling droplets 1116 outwards, creating microfine droplets. In another embodiment, the at least a fluid outlet 1104a-d may include electrostatic atomization. As a non-limiting example, the at least a fluid outlet 1104a-d may use an electric field to break up a stream of the at least a fluid into droplets 1116, which are then charged and repelled from each other, creating microfine droplets. In another embodiment, the at least a fluid outlet 1104a-d may include thermal atomization. As a non-limiting example, the at least a fluid outlet 1104a-d may use a method of heating the at least a fluid to create steam, which is then condensed back into droplets 1116 using a cooling system, creating microfine droplets.

With continued reference to FIGS. 11A-C, in some embodiments, at least a fluid outlet 1104a-d may include a plurality of the at least a fluid outlet 1104a-d. In some embodiments, the at least a fluid outlet 1104a-d may be configured to output at least a fluid 1108a-d. As a non-limiting example, at least a fluid outlet 1104a may be configured to output at least a fluid 1108a. As another non-limiting example, at least a fluid outlet 1104b may be configured to output at least a fluid 1108b. As another non-limiting example, at least a fluid outlet 1104b may be configured to output at least a fluid 1108b. As another non-limiting example, at least a fluid outlet 1104c may be configured to output at least a fluid 1108c. As another non-limiting example, at least a fluid outlet 1104c may be configured to output at least a fluid 1108d. In some embodiments, the at least a fluid outlet 1104a-d may be configured to output a mixture of the at least a fluid 1108a-c. As a non-limiting example, the at least a fluid 1108d may include a mixture of the at least a fluid 1108a-c. As a non-limiting example, the at least a fluid outlet 1104d may be configured to output the at least a fluid 1108d, where the at least a fluid 1108d may include a mixture of the at least a fluid 1108a-c. In some embodiments, the at least a fluid outlet 1104a-d may output a cone distribution 11 of droplets of the at least a fluid 1108a-c. The cone distribution 1112 of droplets 1116 of the at least a fluid 1108a-c disclosed herein may be consistent with spray cone 312 (see FIG. 3).

The cone distribution 11 of droplets of the at least a fluid 1104a-c has been further described in detail above with respect to FIG. 1. In some embodiments, the at least a fluid outlet 1104a-d may be fluidically connected to at least a reservoir 112. As another non-limiting example, the at least a fluid outlet 1104a may be fluidically connected to a first reservoir 112 that may include the at least a fluid 1108a. As another non-limiting example, the at least a fluid outlet 1104b may be fluidically connected to a second reservoir 112 that may include the at least a fluid 1108b. As another non-limiting example, the at least a fluid outlet 1104c may be fluidically connected to a third reservoir 112 that may include the at least a fluid 1108a. In some embodiments, as shown in FIG. 11A, the at least a fluid 1108a-c may be mixed externally. In some embodiments, as shown in FIG. 11B, the at least a fluid 1108a-c may be mixed internally. In some embodiments, as shown in FIG. 11C, the at least a fluid 1108a-c may be mixed in an injector reservoir 1120. For the purposes of this disclosure, an “injector reservoir” is a container or storage chamber of an injector designed to hold at least a fluid used in the treatment process. In some embodiments, the injector reservoir 1120 may be fluidically connected to at least a reservoir 112. As a non-limiting example, the injector reservoir 1120 may be fluidically connected to an outlet of the at least a reservoir 112.

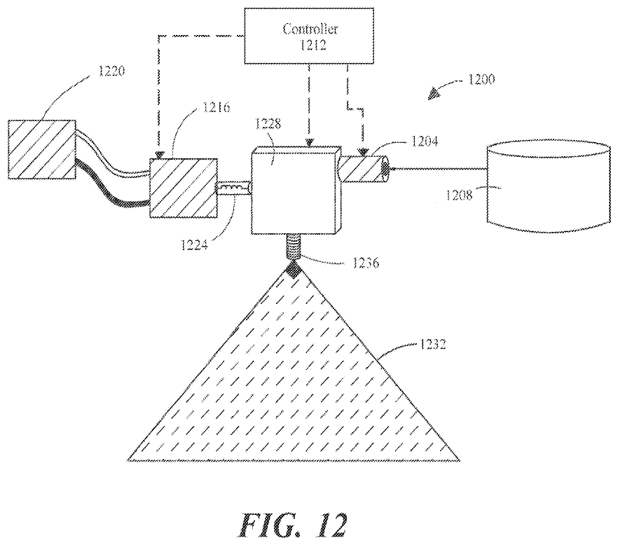

Now referring to FIG. 12, an exemplary embodiment of a vapor injection system 1200 is presented. In an embodiment, system 1200 includes a fluid inlet 1204 in fluidic communication with a fluid reservoir 1208. In an embodiment, fluid inlet 1204 may receive a fluid from a fluid reservoir 1208. A “fluid inlet,” as used herein, is an entry point through which a fluid may be introduced into vapor injection system before for use in such manners described herein. In some nonlimiting examples, fluid inlet 1204 may include components such as, without limitation, tubes, pipes, hoses, channels, or the like to create a continuous pathway for the flow of a fluid. “Fluidic communication,” as used in this disclosure, refers to a pathway or link that enables the transfer of at least a fluid. As used herein, a “reservoir” is a storage system, for example, for a fluid. In embodiments, fluid inlet 1204 may be configured to receive a fluid from fluid reservoir 1208. In embodiments, fluid reservoir 1208 may include a plurality of reservoirs. In an embodiment, fluid reservoir 1208 may be sealed to substantially prevent leaking of the fluid stored in the fluid reservoir 1208. In some embodiments, fluid reservoir 1208 may be vented to allow for free passage of some fluids, such as without limitation air, into and out of the fluid reservoir 1208. In another embodiment, fluid reservoir 1208 may be completely sealed. In embodiments, fluid reservoir 1208 may include a storage reservoir. In an embodiment, fluid reservoir 1208 may include a pressure reservoir, providing for a pressure difference between inside and outside of the reservoir. In some cases, fluid reservoir 1208 may be insulated, for example to prevent electrical and/or thermal communication between inside and outside the reservoir. In an embodiment, fluid inlet 1204 may be hydraulically connected to fluid reservoir 1208. In some embodiments, fluid inlet 1204 may include a pump. In an embodiment, pump may be configured to unidirectionally pump fluid from fluid reservoir 1208 to other components of vapor injection system 1200. In some embodiments, the pump may include more than one pump and/or a number of valves. In an embodiment, the number of valves may comprise at least one check valve. As used in this disclosure, “check valve” is a one-way/nonreturn valve that opens with fluid movement and pressure and closes to prevent backflow of the fluid and/or pressure. In exemplary embodiment, check valve may be any of a ball check valve, swing check, tilting disc check valve, and the like It will be apparent to one of ordinary skill in the art, upon reading this disclosure, of the many ways that can be used to control the flow of fluids from fluid reservoir 1208 to other components of vapor injection system 1200. As used in this disclosure, a “fluid” is a gaseous or liquid material that can flow, including without limitation water, nitrogen, oxygen, and/or other gases and/or liquids.

Still referring to FIG. 12, in some embodiments, fluid inlet 1204 may include a fluidic circuit configured to direct fluid into components of vapor injection system 1200. In an embodiment, fluidic circuit may be connected to a controller 1212 configured to control flow of fluid from fluid reservoir 1208 to other components of vapor injection system 1200. Controller 1212 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Controller 12 may include a single computing device operating independently, or may include two or more computing device operating in concert, in parallel, sequentially or the like; two or more computing devices may be included together in a single computing device or in two or more computing devices. Controller 1212 may interface or communicate with one or more additional devices as described below in further detail via a network interface device. Network interface device may be utilized for connecting controller 1212 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Controller 12 may include but is not limited to, for example, a computing device or cluster of computing devices in a first location and a second computing device or cluster of computing devices in a second location. Controller 12 may include one or more computing devices dedicated to data storage, security, distribution of traffic for load balancing, and the like. Controller 1212 may distribute one or more computing tasks as described below across a plurality of computing devices of computing device, which may operate in parallel, in series, redundantly, or in any other manner used for distribution of tasks or memory between computing devices. Controller 1212 may be implemented using a “shared nothing” architecture in which data is cached at the worker, in an embodiment, this may enable scalability of system 1200 and/or computing device.

With continued reference to FIG. 12, in embodiments, the controller 1212 may be designed and/or configured to perform any method, method step, or sequence of method steps in any embodiment described in this disclosure, in any order and with any degree of repetition. For instance, controller 1212 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Controller 12 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 12, controller 1212 may send pump commands to a pump, for example by way of pump command signals. “Pump command signal,” as used in this disclosure, is a signal representing a pump command. “Pump command,” as used in this disclosure, is a communication intended for any pump described herein. In some cases, pump command may be used to affect performance of the pump. In some embodiments, controller 1212 may receive pump data from a pump connected to fluid inlet 1204, for example by way of pump data signals. As used in this disclosure, a “pump data signal” is a signal representing pump data. As used in this disclosure, “pump data” is information associated with any pump described herein. In some cases, pump data may represent performance and/or operation of a pump.

Continuing to refer to FIG. 12, system 1200 may include a voltage conditioner 1216 connected to a power source 1220. A “voltage conditioner,” as used herein is a device capable of regulating voltage levels and frequency of an electrical current and converting current types. In some embodiments, voltage conditioner 1216 may include a rectifier. A “rectifier,” as used herein, is a device or component configured to covert alternating current (AC) to direct current (DC). In some embodiments, voltage conditioner 1216 may include an inverter. An “inverter,” as used herein, is a device or component configured to convert direct current (DC) to alternating current (AC). In an embodiment, voltage conditioner 1216 may include a boost converter. A “boost converter,” as used herein, is a device or component configured to increase voltage levels of a current. A “transformer,” as used herein, is a device configured to transfer electrical energy from one circuit to another circuit through electromagnetic induction. In an embodiment, voltage conditioner 1216 is configured to receive electrical energy from the power source 1220. A “power source,” as used herein is a is any system, device, or means that provides power such as, without limitation, electric power to a device. In embodiments, power source 1220 may include a power generator. In embodiments, power source 1220 may include a power outlet connected to the power grid. In some embodiments, controller 1212 may be connected to power source. In embodiments, voltage conditioner is further configured to transform the electrical energy. In some embodiments, transforming the electrical energy may include regulating voltage of the electrical energy. In further embodiments, transforming the electrical energy may include regulating voltage of the electrical energy to a range between 1210 volts and 220 volts. In some embodiments, voltage conditioner 1216 may include a transformer. In some embodiments, voltage conditioner 1216 may use transformer to regulate the electrical energy. In embodiments, transforming the electrical energy may include modifying frequency of the voltage. In further embodiments, transforming the electrical energy may include modifying frequency of the voltage to 20 kilohertz (kHz). In some embodiments, transforming the electrical energy may include modifying frequency of the voltage to 30 kilohertz (kHz). In a nonlimiting example, voltage conditioner 1216 may transform electrical energy by receiving AC electrical energy from power source 1220, voltage conditioner 1216 may convert the AC electrical energy to a DC electrical energy using a rectifier component, voltage conditioner 1216 may then increase voltage to 220v using a boost converter component and then increase frequency to 20 kHz using an inverter component. In some embodiments, voltage conditioner 1216 may use rectifier to convert AC electrical energy to Pulsed DC electrical energy. In embodiments, voltage conditioner 1216 may use rectifier in conjunction with a filter, amplifier and/or digital signal processor to convert AC electrical energy to multi-rate waveform. A “multi-rate waveform,” as used herein, is a type of signal that have been sampled at multiple rates, wherein each rate corresponds to a specific frequency range of interest. In embodiments, multi-rate waveform may include a plurality of waveforms such as square waves, sawtooth waves, triangular waves, and the like. As used herein, “square waves” are periodic signals that alternate in a binary manner, such as 0 and 1. As used herein, “sawtooth waves” are periodic signals that have a linear rise and a sudden drop. As used herein, “triangular waves” are periodic signals that have a linear rise and a linear fall. In some embodiments, voltage conditioner 1216 may convert DC electrical energy to AC electrical energy using an inverter. In some embodiments, voltage conditioner 1216 may convert Pulsed DC electrical energy to AC electrical energy using an inverter. In an embodiment, voltage conditioner 1216 may also convert AC to AC. For example, AC to AC converters may be used for converting the AC waveforms with one particular frequency and magnitude to AC waveform with another frequency at another magnitude. For example, an AC voltage controller may be a thyristor-based device which converts fixed alternating voltage directly to variable alternating voltage without a change in frequency. AC voltage controller may be a phase-controlled device and hence no force commutation circuitry may be required and natural or line commutation may be used. It will be apparent to one of ordinary skill in the art, upon reading this disclosure, that component described in this disclosure are described as examples only and that voltage conditioner 1216 may include many other components not described herein and components may be used in other orders not described.

Continuing to refer to FIG. 12, in an embodiment, system 1200 may include an iron core coil 1224 connected to voltage conditioner 1216. In some embodiments, voltage conditioner 1216 may include iron core coil 1224. In an embodiment, iron core coil 1224 may be configured to transmit transformed electrical energy from voltage conditioner 1216. In other embodiments, voltage conditioner 1216 may be configured to transmit transformed electrical energy. An “iron core coil,” as used herein is a type of inductor or magnetic component, consisting of a coil of wire wound around an iron or ferromagnetic core, that resists changes to the current flowing through it. In some embodiments, voltage conditioner 1216 may include two or more coils of insulated wire that are wrapped around a common iron core. In a nonlimiting example, iron core coil 1224 may transmit modified electrical energy from voltage conditioner 1216.

Still referring to FIG. 12, in an embodiment, system 1200 includes a crystal compressor 1228. A “crystal compressor,” as used herein, is a piezoelectric device used to generate pressure variations or ultrasonic waves within a fluid. A “piezoelectric device,” as used herein, is a device that uses piezoelectric materials, such as certain types of crystals that can change their shape and/or dimension when an electric voltage is applied, to generate oscillating pressure waves or ultrasonic vibrations. In some embodiments, crystal compressor 1228 may be connected to iron core coil 1224. In a nonlimiting example, iron core coil 1224 may be used to connect voltage conditioner 1216 and crystal compressor 1228 to maintain the properties of transformed electrical energy, such as set voltage and frequency, during transmission. In embodiments, crystal compressor 1228 may be connected to fluid inlet 1204. In some embodiments, crystal compressor 1228 may be connected to voltage conditioner 1216. In an embodiment, crystal compressor 1228 may be configured to receive the transformed electrical energy from iron core coil 1224. In embodiments, crystal compressor 1228 may receive the transformed electrical energy from voltage conditioner 1216. In embodiments, crystal compressor 1228 may receive the fluid from the fluid inlet 1204. In some embodiments, crystal compressor 1228 may be communicatively connected to controller 1212. In some embodiments, controller 1212 may be a piezo controller. Piezo controller may include the “Open-Loop Piezo Controller” made by Thorlabs Inc., headquartered in Newton, New Jersey USA.

Continuing to refer to FIG. 12, in an embodiment, crystal compressor 1228 generates vapor 1232 as a function of the transformed electrical energy and the fluid. In a nonlimiting example, crystal compressor 1228 may generate vapor 1232, such as water vapor, through applying ultrasonic vibrations to a fluid, such as water. In some embodiments, crystal compressor outputs the vapor using a vapor outlet 1236. A “vapor outlet,” as used herein, is an exit point through which vapor is discharged. In a nonlimiting example, vapor outlet 12 may include a fog nozzle configured to output vapor. In some embodiments, vapor injection system 1200 may be connected to a plasma reactor. In some embodiments, vapor injection system 1200 may be further configured to output vapor to the plasma reactor. As used in this disclosure, a “plasma reactor” is a device configured to generate, sustain, and/or control plasma. “Plasma,” for the purpose of this disclosure, refers to the fourth state of matter, in addition to solid, liquid, and gas. Plasma may include a partially ionized gas consisting of a mixture of ions, electrons, and/or neutral particles (i.e., atoms and molecules). In an embodiment, plasma may be formed when a vapor subject to high-energy source, such as, without limitation, heat, radiation, electric filed, and the like, causing the atoms or molecules in a vapor to become ionized by losing or gaining electrons. In embodiments, vapor may be inputted into plasma reactor using vapor injector system 1200. In some embodiments, plasma may include non-thermal plasma (NTP), wherein the non-thermal plasma is a type of plasma in which the electron temperature is significantly higher than the temperature of the heavier ions and neutral particles. In this case, while the electrons in plasma have high kinetic energy, the overall temperature of the vapor may remain relatively low (e.g., often near room temperature of 20-22° C./68-72° F.). Additionally, or alternatively, the energy distribution among particles within non-thermal plasma may not be in thermal equilibrium due to the electrons, being much lighter than ions and neutral particles, may gain energy more rapidly when subjected to an electric or magnetic field, leading to a higher electron temperature. On the other hand, heavier ions and neutral particles may move more slowly and remain cooler, resulting in low temperature of vapor.

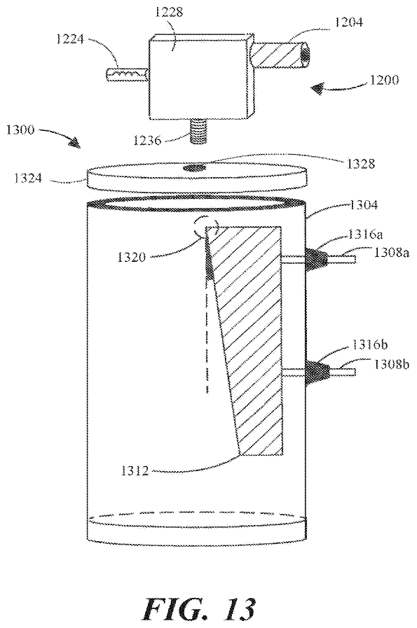

Now referring to FIG. 13, an exemplary FIG. 13 is an exemplary embodiment of a plasma reactor housing assembly 1300. Plasma reactor housing assembly 1300 may include a housing 1304. In another embodiment, housing 1304 may be a separate housing configured to only house a plasma reactor. In a non-limiting example, plasma reactor housing assembly 1300 may be double-housed, wherein housing 1304 may be disposed within another layer of housing 1304. In some cases, housing 1304 may be injection molded via an injectable mold. As used in this disclosure, an “injectable mold” is a manufacturing tool for producing plastic parts. Manufacturing housing 1304 may include using an injection molding process, wherein the injection molding process may involve a use of injectable mold configured to create specific shape and features of housing 1304. In some embodiments, injectable mold may include two halves that are clamped together, with one or more cavities in between, wherein the cavities may define the shape of housing 1304. In some cases, material such as, without limitation, molten plastic may be injected into the injectable mold under high pressure, filling the space and taking on the shape of injectable mold. Injection molding process may include a cooling process which is configured to cool and/or solidify injected material. Injectable mold may be then opened and finished housing 1304 may be removed. In some embodiments, injectable mold may be precisely machined to desired shape and size of housing 1304. In a non-limiting example, housing 1304 may include a hollow cylinder.

With continued reference to FIG. 13, in some embodiments, one or more continuous conductors 1308a-b may pass through housing 1304, with one end electrically connected to at least an electrode 1312. An “electrode,” as used herein, is a conductor that is used to make electrical contact with a conductive medium and/or a medium that can become conductive given a sufficient voltage differential, such as vapor as described above. In embodiments, at least an electrode 1312 may include one or more electrodes 1312. In embodiments, one or more electrodes 1312 may be configured to produce an electrical discharge as a function of vapor 1232. As used in this disclosure, an “electrical discharge” refers to a phenomenon where an electric current flows between two or more conductive surfaces (i.e., at least a pair of electrodes 1312) through vapor 1232, causing ionization and the subsequent release of energy in the form of light, heat, or sound. In an embodiment, another end of continuous conductor 1308a-b may be connected to an ignition unit or ground connection. In some embodiments, one or more insulators 1316a-b may be used at the point where continuous conductor 1308a-b passes through housing 1304. An “insulator,” for the purpose of this disclosure, is a material that does not readily conduct heat, electricity, or sound. In a non-limiting example, insulators 1316a-b may include electrical insulators, wherein the electrical insulators are material that have high electrical resistivity. Electrical insulators may not readily conduct electric current, thereby preventing the flow of electricity between a plasma reactor with other components, reducing the risk of short circuits, electrical shocks, interference, and the like. Exemplary electrical insulator may include plastics, ceramics, glass, rubber, and the like.

With continued reference to FIG. 13, each electrode of at least a pair of electrodes 1312 may include a pitch angle 1320. In a non-limiting example, at least an electrode 1312 may include a pitch angle 1320 of 6 degrees (i.e., an angle between a pair of electrodes 1312 is 12 degrees). As used in this disclosure, a “pitch angle” of an electrode refers to an angle between the electrode's longitudinal axis and a reference plane or axis within a plasma reactor. In some cases, pitch angle 1320 may impact on characteristics of plasma generated between electrodes 1312 in a reaction region of a plasma reactor such as, without limitation, electric field distribution, efficiency of electrical discharge process, interaction with reactive species (e.g., ROS, RNS, and the like) within the plasma.

With continued reference to FIG. 13, vapor injection system 1200 may be connected to a plasma reactor within a plasma reactor housing assembly 1300 via an injector mount flange 1324. As used in this disclosure, an “injector mount flange” is a mechanical component used to securely attach vapor injection system 1200 to housing 1304 in a reliable and leak-proof manner. In a non-limiting example, injector mount flange 1324 may include an interface 1328 between vapor injection 1200 and a plasma reactor. In some cases, vapor outlet 123 of vapor injection system 1200 may include a threaded adaptor. Both vapor outlet 123 and interface 1328 may include a threaded section; for instance, and without limitation, vapor outlet 123/interface 1328 may include a male/female threaded section, wherein the male and the female threaded section are compatible (i.e., matched). Vapor injection system 1200 may be threaded, via vapor outlet 1236 with threaded adaptor onto injector mount flange 1324 at interface 1328.

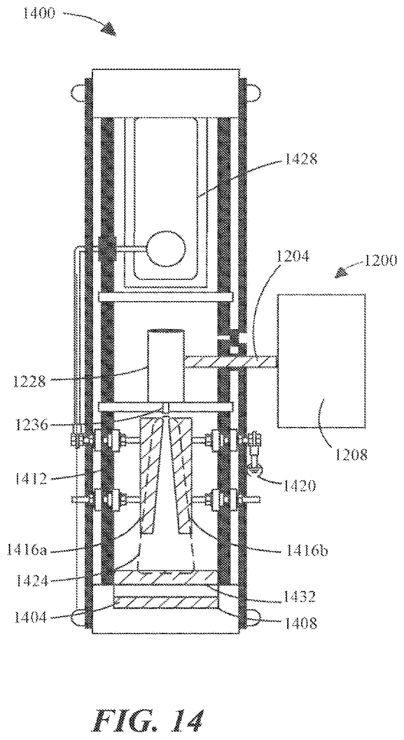

Referring now to FIG. 14, an exemplary embodiment of an apparatus 1400 with an internally mounted vapor injection system 1200 is illustrated. Apparatus 1400 may include an internal injection system, such as vapor injection system 1200, disposed within the apparatus 1400. As used in this disclosure, an “internal injection system” is an injection system that is installed on an interior of apparatus 1400. Injection system may be any injection system described in this disclosure. In some embodiments, internal injection system may be designed to deliver vapor 1232 from fluid reservoir 1208 into plasma reactor 1512.

With continued reference to FIG. 14, apparatus 1400 for treating a growth media 104 via an electrical discharge. Apparatus 1400 may include a growth media 1404 within treatment chamber 1408. Apparatus 1400 may include a plasma reactor 1412. Plasma reactor 1412 may include at least a pair of electrodes 1416a-b. First electrode 1416a may include anode electrically connected to an ignition unit and second electrode 1416b may include cathode electrically connected to a ground 1420. Plasma reactor 1412 may include a reaction region 1424 disposed between first electrode 1416a and second electrode 1416b. Apparatus 1400 may include an ignition unit 1428 electrically connected to at least an electrode of at least a pair of electrodes 1416a-b. Apparatus 1400 may further include a condenser 1432 disposed within reaction region 1424 above treatment chamber 1408.

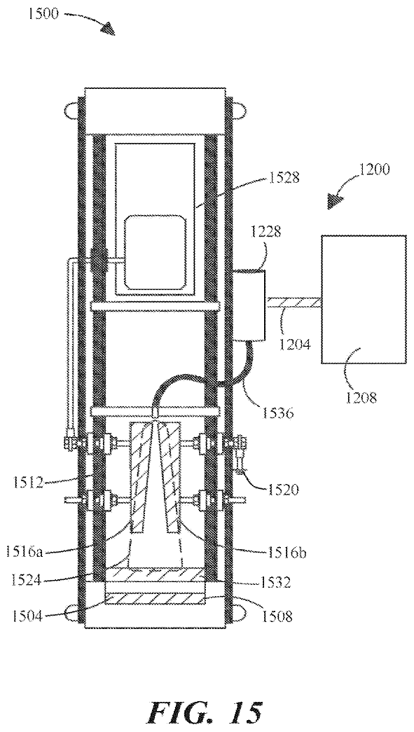

Referring now to FIG. 15, an exemplary embodiment of an apparatus 1500 with an internally mounted vapor injection system 1200 is presented. Apparatus 1500 may include an externally mounted injection system, such as vapor injection system 1200, disposed externally to the apparatus 1500. As used in this disclosure, an “externally mounted injection system” is an injection system that is installed on an exterior of apparatus 1500, rather than being integrated within apparatus 1500 as described above with reference to FIG. 14. Injection system may be any injection system described in this disclosure. Apparatus 1500 may include a growth media 1504 within treatment chamber 1508. Apparatus 1500 may include a plasma reactor 1512. Plasma reactor 1512 may include at least a pair of electrodes 1516a-b. First electrode 1516a may include anode electrically connected to an ignition unit and second electrode 1516b may include cathode electrically connected to a ground 1520. Plasma reactor 1512 may include a reaction region 1524 disposed between first electrode 1516a and second electrode 1516b. Apparatus 1500 may include an ignition unit 1528 electrically connected to at least an electrode of at least a pair of electrodes 1516a-b. Apparatus 1500 may further include a condenser 1532 disposed within reaction region 1524 above treatment chamber 1508.

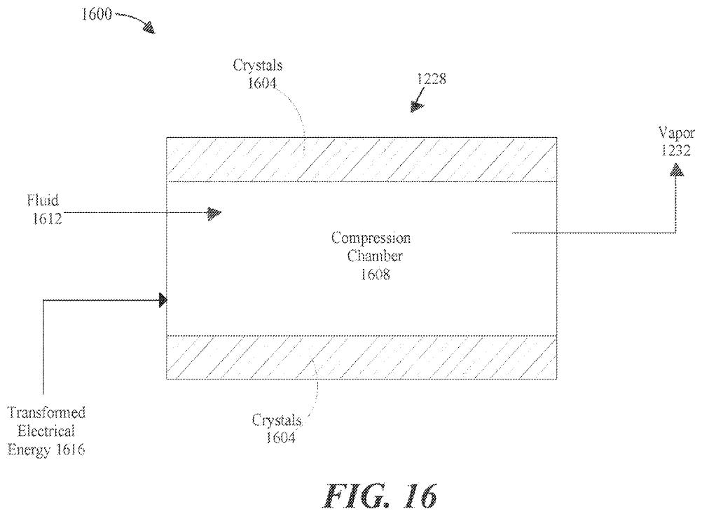

Now referring to FIG. 16, an exemplary block diagram 1600 of a crystal compressor 1228 is presented. In this exemplary embodiment, crystal compressor 1228 includes crystals 1604. In this exemplary embodiment, crystal compressor 1228 includes a compression chamber 1608. A “compression chamber,” as used herein, is an enclosed component capable of withstanding high levels of pressure. In embodiments, compression chamber may receive a fluid 1612. In an embodiment, compression chamber 1608 may be in fluidic communication with fluid inlet 1204. In an embodiment, crystals 1604 may be activated by transformed electrical energy 1616. In an embodiment, crystal compressor 1228 may receive transformed electrical energy 1616 from an iron core coil 1224. In embodiments, crystal compressor 1228 may receive transformed electrical energy 1616 directly from voltage conditioner 1216. In a nonlimiting example, crystals 1604 may be activated by transformed electrical energy 1616, where the activation causes the crystals 1604 to generate ultrasonic pressure, fluid 1612 may then change its state from liquid to vapor 1232 as a function of the pressure generated by the crystals. In some embodiments, pressure levels generated by crystals 1604 may be regulated through controller 1212. In some embodiments, vapor 1232 may exit compression chamber 1608 through vapor outlet 1236. It will be apparent to one of ordinary skill, upon reading this disclosure, that crystal compressor 1228 is described as an example, and that crystal compressor 1228 may include many embodiments of crystal compressors 1228 not described in this disclosure.

Continuing to refer to FIG. 16, in some embodiments, system 1200 may be a piezo water vapor injector. As used in this disclosure, a “piezo water vapor injector” is a type of injector, such as vapor injection system 1200, that utilizes piezoelectric technology to generate water vapor by atomizing at least a liquid (i.e., second fluid) into fine droplets as described above. “Water vapor,” as described herein, is the gaseous phase of water (i.e., second fluid), which occurs when water molecules gain enough energy to break free from liquid state and become dispersed in surrounding air (i.e., first fluid). “Piezoelectric technology,” as described herein, is a technology based on a piezoelectric effect: a phenomenon where certain materials generated an electric charge when subjected to mechanical stress or other way around (i.e., undergo mechanical deformation when exposed to electric field). In some cases, materials such as ceramics (e.g., lead zirconate titanate), quartz crystals, polymers, and the like may exhibit such effect. Crystal compressor 1228 may include a piezoelectric element; for instance, and without limitation, a ceramic disk or plate may be used to create mechanical vibrations at certain frequencies when an electrical voltage is applied by power source 1220. Power source 1220 may include any power source as described above in this disclosure such as a DC power supply. Mechanical vibrations may be transmitted to a fluid input from fluid inlet 1204, thereby causing at least a fluid to break up into fine droplets of mist, which then evaporate to form water vapor.

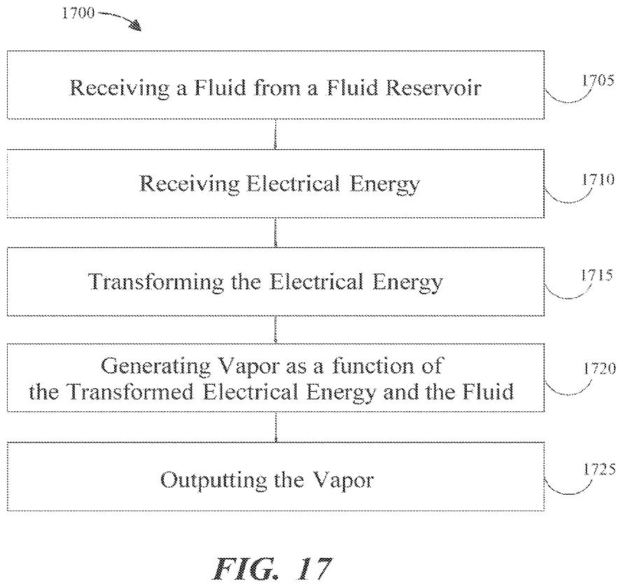

Now referring to FIG. 17, a flow diagram of an exemplary embodiment of a method 1700 for using vapor injection system 1200 is presented. Method 1700, at step 1705, includes receiving, by fluid inlet 1204 a fluid from fluid reservoir 1208. In some embodiments, receiving the fluid includes using at least a pump. In some embodiments, at least a pump connected to fluid inlet 1204 may be communicatively connected to controller 1212. This may be implemented, without limitation, as described herein.

With continued reference to FIG. 17, method 1700 includes, at step 1710, receiving, by voltage conditioner 1216, electrical energy from power source 1220. In some embodiments, voltage conditioner 1216 may be communicatively connected to controller 1212. In a nonlimiting example, controller 1212 may be used to regulate the quantity of electrical energy to be received from power source 1220. This may be implemented, without limitation, as described herein.

With continued reference to FIG. 17, at step 1715, method 1700 includes transforming the electrical energy. In embodiments, transforming the electrical energy may include regulating voltage of the electrical energy. In further embodiments, regulating voltage of the electrical energy may include regulating voltage to a range between 1210 volts and 220 volts. In some embodiments, transforming the electrical energy may include modifying frequency of the voltage. In further embodiments, modifying frequency may include modifying frequency to 20 kHz. In some embodiments, modifying frequency may include modifying frequency to 30 KHz. In some embodiments, voltage and/or frequency to be regulated, or modified, may be set by controller 1212. This may be implemented, without limitation, as described herein.

With continued reference to FIG. 17, method 1700 may include transmitting the transformed electrical energy by iron core coil 1224. In some embodiments, method 1700 may further include transmitting transformed electrical energy by iron core coil 1224 to crystal compressor 1228. In some embodiments, method 1700 may include transmitting the transformed electrical energy directly from voltage conditioner 1216 to crystal compressor 1228. In an embodiment, voltage conditioner 1216 includes iron core coil 1224. In some embodiments, method 1700 may include transmitting the transformed electrical energy by voltage conditioner 1216. This may be implemented, without limitation, as described herein.

With continued reference to FIG. 17, at step 1720, method 1700 includes generating vapor 1232, by crystal compressor 1228, as a function of the transformed electrical energy and the fluid. In embodiments, generating vapor 1232 may further include using a controller 1212. In some embodiments, amount of fluid and/or modified electrical energy to be used may be set by controller 1212. In some embodiments, this may be implemented, without limitation, as described herein.

With continued reference to FIG. 17, method 1700, at step 1725, includes outputting vapor 1232 using vapor outlet 1236. In some embodiments, method 1700 may further include outputting vapor 1232, using vapor outlet 1236, to a plasma reactor. This may be implemented, without limitation, as described herein.

At a high level, aspects of the present disclosure are directed to a low-pressure injection system for a plurality of fluids and method of use thereof. In an embodiment, the system includes at least one injector configured to disperse a first fluid and second fluid mixture. Aspects of the present disclosure can be used to generate microfine fluid droplets, which may allow a second fluid to become ionized and be transferred into the generated microfine fluid droplets. Exemplary embodiments illustrating aspects of the present disclosure are described below in the context of several specific examples.

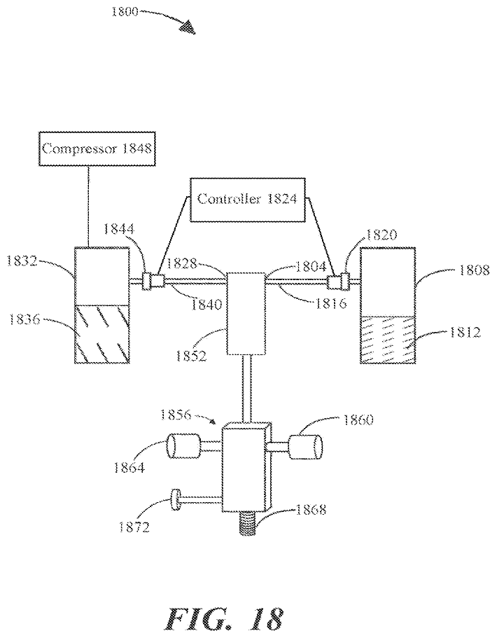

Referring now to FIG. 18, an exemplary embodiment of a pressure injection system 1800 for a plurality of fluids is illustrated. In an embodiment, a low-pressure injection system 1800 for a plurality of fluids includes at least one first fluid inlet 1804. At least one first fluid inlet 1804 may be communicatively connected to a first fluid reservoir 1808. As used in this disclosure, a “first fluid inlet” is an entry point through which at least first fluid 1812 may be introduced into pressure injection system before for use in such manners described herein. In an embodiment, at least one first fluid inlet 1804 may be configured to receive a first fluid 1812 from first fluid reservoir 1808. As used in this disclosure, a “reservoir” is a storage system, for example, for a fluid. In some cases, first fluid reservoir 1808 may include a plurality of reservoirs. In some cases, first fluid reservoir 1808 may be sealed to substantially prevent leaking of the fluid stored in the first fluid reservoir. In some cases, first fluid reservoir 1808 may be vented to allow for free passage of some fluids, such as without limitation air, into and out of the first fluid reservoir 1808. Alternatively, first fluid reservoir 1808 may be completely sealed. In some cases, first fluid reservoir 1808 may include a storage reservoir. In some cases, first fluid reservoir 1808 may include a pressure reservoir, providing for a pressure difference between inside and outside of the reservoir. In some cases, a first fluid reservoir 1808 may be insulated, for example to prevent electrical and/or thermal communication between inside and outside the reservoir. As used in this disclosure, and still referring to FIG. 18, a “fluid” is a gaseous or liquid material that can flow, including without limitation water, nitrogen, oxygen, and/or other gases and/or liquids.

With continued reference to FIG. 18, first fluid reservoir 1808 may provide a consistent and controlled supply of a first fluid 1812 for use in pressure injection system 1800 as described in further detail below. In an embodiment, first fluid 1812 may include a liquid; for instance, and without limitation, at least a fluid may include water, organic solvents, electrolyte solutions, and the like. With continued reference to FIG. 18, first fluid reservoir 1808 may be constructed from materials that are compatible with first fluid 1812 being stored. For example, and without limitation, first fluid reservoir 1808 may be made from any material such as corrosion-resistant metals, plastics, and/or glass. In some cases, first fluid reservoir 1808 may be appropriately sized to provide an adequate supply of first fluid 1812 without frequent refilling or interruptions. First fluid reservoir 1808 may include at least an inlet, at least an outlet, or both. In a non-limiting example, at least an inlet may be used for filling first fluid reservoir 1808 with first fluid 1812 and at least an outlet may be connected to a first fluid line 1816 or any other fluid delivery component of 1800 described herein. First fluid 1812 may be input through the at least an inlet into first fluid reservoir 1808 and/or output through the at least an outlet to pressure injection system 1800. In the case of 1800 having a plurality of first fluid reservoirs 1808, each reservoir of plurality of reservoirs may include at least an inlet and at least an outlet. In a non-limiting example, first reservoir configured to contain first fluid may include a first inlet and a first outlet, second reservoir configured to contain first fluid may include a second inlet and a second outlet, wherein the first inlet/first outlet may never intersect with second inlet/second outlet. In such an embodiment, first fluid 1812 may not output from second first fluid reservoir 1808 through second outlet until first fluid reservoir 1808 is empty.

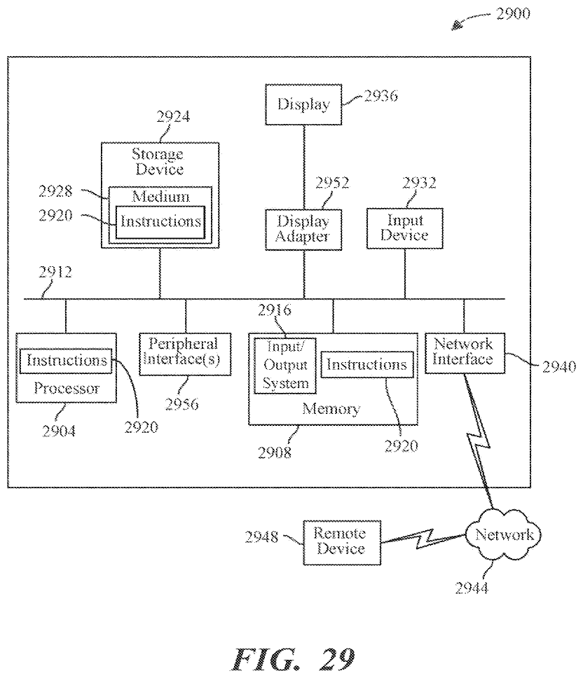

With further reference to FIG. 18, first fluid line 1816 may be configured to provide fluidic communication between first fluid reservoir 1808 and at least one first fluid inlet 1804. “Fluidic communication,” for the purpose of this disclosure, refers to a pathway or link that enables the transfer of at least a fluid. In a non-limiting example, fluidic connection between first fluid reservoir 1808 and at least one first fluid inlet 1804 may be established using first fluid line 1816. In an exemplary embodiment, first fluid line 1816 may be various components such as, without limitation, tubes, pipes, hoses, channels, or the like to create a continuous pathway for the flow of at least a fluid. In an embodiment, at least one first fluid inlet 1804 may be hydraulically connected to first fluid reservoir 1808. In some cases, first fluid line may include a first pump 1820. In an embodiment, first pump 1820 may be configured to unidirectionally pump first fluid 1812 to pressure injection system. In some cases, first pump 1820 may include more than one pump and/or a number of valves. In an embodiment, the number of valves may comprise at least one check valve. As used in this disclosure, “check valve” is a one-way/nonreturn valve that opens with fluid movement and pressure and closes to prevent backflow of the fluid and/or pressure. In exemplary embodiment, check valve may be any of a ball check valve, swing check, tilting disc check valve, and the like. In some cases, first pump 1820 and/or first fluid line 1816 may include a fluidic circuit configured to direct first fluid into pressure injection system 1800. In an embodiment, fluidic circuit may be connected to a controller 1824, such as any computing device described in FIG. 29, configured to control flow of the first fluid 1812 to at least one first fluid inlet 1804 and/or low-pressure injection system 1800.

Still referring to FIG. 18, controller 1824 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Controller 1824 may include a single computing device operating independently, or may include two or more computing device operating in concert, in parallel, sequentially or the like; two or more computing devices may be included together in a single computing device or in two or more computing devices. Controller 1824 may interface or communicate with one or more additional devices as described below in further detail via a network interface device. Network interface device may be utilized for connecting controller 1824 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Controller 1824 may include but is not limited to, for example, a computing device or cluster of computing devices in a first location and a second computing device or cluster of computing devices in a second location. Controller 1824 may include one or more computing devices dedicated to data storage, security, distribution of traffic for load balancing, and the like. Controller 1824 may distribute one or more computing tasks as described below across a plurality of computing devices of computing device, which may operate in parallel, in series, redundantly, or in any other manner used for distribution of tasks or memory between computing devices. Controller 1824 may be implemented using a “shared nothing” architecture in which data is cached at the worker, in an embodiment, this may enable scalability of system 1800 and/or computing device.

With continued reference to FIG. 18, controller 1824 may be designed and/or configured to perform any method, method step, or sequence of method steps in any embodiment described in this disclosure, in any order and with any degree of repetition. For instance, controller 1824 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Controller 1824 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 18, controller 1824 may be in communication with first pump 1820. For example, in some cases, controller 1824 may send pump commands to at least a first pump 1820, for example by way of pump command signals. “Pump command signal,” as used in this disclosure, is a signal representing a pump command. “Pump command,” as used in this disclosure, is a communication intended for any pump described herein. In some cases, pump command may be used to affect performance of first pump 1820. In some cases, controller 1824 may receive pump data from first pump 1820, for example by way of pump data signals. As used in this disclosure, a “pump data signal” is a signal representing pump data. As used in this disclosure, “pump data” is information associated with any pump described herein. In some cases, pump data may represent performance and/or operation of first pump 1820.

With further reference to FIG. 18, pressure injection system 1800 for a plurality of fluids includes at least one second fluid inlet 1828. The at least one second fluid inlet 1828 may be communicatively connected to a second fluid reservoir 1832. As used in this disclosure, a “second fluid inlet” is an entry point through which at least second fluid 1836 may be introduced into pressure injection system before for use in such manners described herein. In an embodiment, at least one second fluid inlet 1828 may be configured to receive a second fluid 1836 from second fluid reservoir 1832. Second fluid reservoir 1832 may be any reservoir described herein. In some cases, second fluid reservoir 1832 may include a plurality of reservoirs. For example, second fluid reservoir 1832 may be sealed to substantially prevent leaking of the fluid stored in the second fluid reservoir. In some cases, second fluid reservoir 1832 may be vented to allow for free passage of some fluids, such as without limitation air, into and out of the second fluid reservoir 1832. Alternatively, second fluid reservoir 1832 may be completely sealed. In some cases, second fluid reservoir 1832 may include a storage reservoir. In some cases, second fluid reservoir 1832 may include a pressure reservoir, providing for a pressure difference between inside and outside of the reservoir. In some cases, second fluid reservoir 1832 may be insulated, for example to prevent electrical and/or thermal communication between inside and outside the reservoir.

With continued reference to FIG. 18, second fluid reservoir 1832 may provide a consistent and controlled supply of a second fluid 1836 for use in pressure injection system 1800 as described in further detail below. In an embodiment, a second fluid 1836 may include a gas; for instance, and without limitation, second fluid 1836 may include oxygen gas, nitrogen gas, and the like. With continued reference to FIG. 18, second fluid reservoir 1832 may be constructed from materials that are compatible with second fluid 1836 being stored. For example, and without limitation, second fluid reservoir 1832 may be made from any material such as corrosion-resistant metals, plastics, and/or glass. In some cases, second fluid reservoir 1832 may be appropriately sized to provide an adequate supply of second fluid 1836 without frequent refilling or interruptions. Second fluid reservoir 1832 may include at least an inlet, at least an outlet, or both. In a non-limiting example, at least an inlet may be used for filling second fluid reservoir 1832 with second fluid 1836 and at least an outlet may be connected to a second fluid line 1840 or any other fluid delivery component of 1800 described herein. Second fluid 1836 may be input through the at least an inlet into second fluid reservoir 1832 and/or output through the at least an outlet to pressure injection system 1800. In the case of 1800 having a plurality of second fluid reservoirs 1832, each reservoir of plurality of reservoirs may include at least an inlet and at least an outlet. In a non-limiting example, first reservoir configured to contain second fluid may include a first inlet and a first outlet, second reservoir configured to contain second fluid may include a second inlet and a second outlet, wherein the first inlet/first outlet may never intersect with second inlet/second outlet. In such embodiment, second fluid 1836 may not output from second fluid reservoir 1832 through second outlet until first second fluid reservoir 1832 is empty. Further, in an exemplary embodiment, pressure injection system 1800 includes a first fluid reservoir 1808 configured to contain first fluid may include a first inlet and a first outlet, a second fluid reservoir 1832 configured to contain second fluid may include a second inlet and a second outlet, wherein the first inlet/first outlet may never intersect with second inlet/second outlet. In such embodiment, first fluid and second fluid may not contact each other before output into pressure injection system 1800.

With further reference to FIG. 18, second fluid line 1840 may be configured to provide fluidic communication between second fluid reservoir 1832 and at least one second fluid inlet 1828. “Fluidic communication,” for the purpose of this disclosure, refers to a pathway or link that enables the transfer of at least a fluid. In a non-limiting example, fluidic connection between second fluid reservoir 1832 and at least one second fluid inlet 1828 may be established using second fluid line 1840. In an exemplary embodiment, second fluid line 1840 may be various components such as, without limitation, tubes, pipes, hoses, channels, or the like to create a continuous pathway for the flow of at least a fluid. In an embodiment, the at least one second fluid inlet 1828 may be pneumatically connected to second fluid reservoir 1832. In some cases, second fluid line 1840 may include a second pump 1844. In an embodiment, second pump 1844 may be configured to unidirectionally pump second fluid 1836 to pressure injection system 1800. In some cases, second pump 1844 may include more than one pump and/or a number of second valves. In an embodiment, the number of second valves may comprise at least one second check valve. Second check valve may be any check valve described herein. In some cases, second pump 1844 and/or second fluid line 1840 may include a fluidic circuit configured to direct first fluid into pressure injection system 1800. In an embodiment, fluidic circuit may be connected to controller 1824, such as any computing device described in FIG. 6 and herein, configured to control flow of the second fluid 1836 to at least one second fluid inlet 1828 and pressure injection system 1800.

With continued reference to FIG. 18, controller 1824 may be in communication with second pump 1844. For example, in some cases, controller 1824 may send pump commands to second pump 1844, for example by way of pump command signals. Pump command signals may be any pump command signal described herein. Pump command may be any pump command described herein. In some cases, pump command may be used to affect performance of second pump 1844. In some cases, controller 1824 may receive pump data from second pump 1844, for example by way of pump data signals. Pump data signal and pump data may be any pump data described herein. In some cases, pump data may represent performance and/or operation of second pump 1844.

Still referring to FIG. 18, system 1800 includes a low-pressure compressor 1848 configured to provide pressure to the second fluid received from the second fluid reservoir. pressure compressor 1848 may include a pneumatic compression device. In some embodiments, pressure compressor 1848 may include a hydraulic, air, or other compressor. Further, pressure compressor 1848 may be a piston compressor, diaphragm compressor, helical screw compressor, sliding vane compressor, scroll compressor, rotary lobe compressor, centrifugal compressor, and like. pressure compressor 1848 may be configured to apply a pressure to system 1800, second fluid 1836, and/or at least one injector 1856. In some embodiments, pressure compressor 1848 may be configured to apply a pressure between about 2 Bar to about 7 Bar. In some embodiments, pressure compressor 1848 may be automated. pressure compressor 1848 may be automated to apply pressure to 18 for a set period of time. In some embodiments, pressure compressor 1848 may be configured to slowly apply an increasing pressure to system 1800. In other embodiments, pressure compressor 1848 may be automated to apply a constant pressure to system 1800. As a non-limiting example, pressure compressor 1848 may be driven by direct current (DC) electric power. As used in this disclosure, “direct current” is a unidirectional flow of current. In some embodiments, pressure compressor 1848 may be driven by electric power having varying or reversing voltage levels, such as alternating current (AC) power as produced by an alternating current generator and/or inverter, or otherwise varying power, such as produced by a switching power source. In some embodiments, system 1800 may include a high-pressure compressor configured to provide pressure to the second fluid received from the second fluid reservoir. High-pressure compressor may include a rotary screw compressor, reciprocating air compressor, dynamic compressor such as a centrifugal compressor and the like. For example, a dynamic air compressor may generate horsepower by bringing in air with rapidly rotating blades and restricting it to create pressure, the kinetic energy is then stored as static within the compressor. High-pressure may include compression to more than 150 pound PSI and can also range from 1000 to 6000 PSI. In some embodiments, high-pressure compressor may be automated. As a non-limiting example, high-pressure compressor may be driven by direct current (DC) electric power. As used in this disclosure, “direct current” is a unidirectional flow of current. In some embodiments, high pressure compressor may be driven by electric power having varying or reversing voltage levels, such as alternating current (AC) power as produced by an alternating current generator and/or inverter, or otherwise varying power, such as produced by a switching power source.

Continuing to reference FIG. 18, controller 1824 may be in communication with pressure compressor 1848. For example, in some cases, controller 1824 may send compressor commands to pressure compressor 1848, for example by way of compressor command signals. “Compressor command signal,” as used in this disclosure, is a signal representing a compressor command. “Compressor command,” as used in this disclosure, is a communication intended for any compressor described herein. In some cases, compressor command may be used to affect performance of pressure compressor 1848. In some cases, controller 1824 may receive compressor data from pressure compressor 1848, for example by way of compressor data signals. As used in this disclosure, a “compressor data signal” is a signal representing compressor data. As used in this disclosure, “compressor data” is information associated with any compressor described herein. In some cases, pump data may represent performance and/or operation of pressure compressor 1848.

With further reference to FIG. 18, system 1800 may include a combination reservoir 1852. Combination reservoir 1852 may be configured to receive first fluid 1812 from at least one first fluid inlet 1804 and second fluid 1836 from at least one second fluid inlet 1828. At least one first fluid inlet 1804 and at least one second fluid inlet 1828 may be used for filling combination reservoir 1852 with first fluid 1812 and second fluid 1836, respectively. Further, combination reservoir 1852 may be configured to combine the first fluid 1812 and the second fluid 1836 into a combination of the first fluid 1812 and the second fluid 1836. In an embodiment, combining first fluid 1812 and second fluid 1836 may include producing droplets of first fluid 1812. As used in this disclosure, “droplets” refer to small, spherical-shaped liquid particles. In a non-limiting example, combination reservoir 1852 may produce droplets through different mechanisms, such as, without limitation, pressure-driven atomization, ultrasonic atomization, electrostatic atomization, and the like. Combination reservoir 1852 may be constructed from materials that are compatible with first fluid 1812 and second fluid 1836 being combined. For example, and without limitation, first fluid reservoir 1808 may be made from any material such as corrosion-resistant metals, plastics, and/or glass.

With continued reference to FIG. 18, system 1800 includes at least one injector 1856 configured to disperse a combination of the first fluid and the second fluid. As used in this disclosure, an “injector” is a component designed to dispense at least one fluid for at least one of a plurality of applications. In a non-limiting example, system 1800 and at least one injector 1856 may be configured for use in industrial applications, agricultural applications, and the like. For example, system 1800 and at least one injector 1856 may be configured for use associated with painting or surface coating of various items, feed waste oil into a furnace for heating or into a plasma reactor, greenhouse humidity control, odor control and chemical engineering, and the like. One skilled in the art will recognize the various applications system 1800 and at least one injector 1856 may be configured for.

With further reference to FIG. 18, at least one injector 1856 may include at least one first fluid injector inlet 1860. As used in this disclosure, a “first fluid injector inlet” is an entry point through which at least first fluid may additionally be introduced into at least one injector 1856 before being output by at least one injector 1856 in such manners described herein. In a non-limiting example, at least one first fluid injector inlet 1860 may be connected with outlet of at least one first reservoir 1808 as described above. In some cases, at least one first fluid injector inlet 1860 may be designed to provide a secure, leak-free connection with the at least one first reservoir 1808; for instance, and without limitation, at least one first fluid injector inlet 1860 may be sealed using one or more sealing elements such as O-rings, gaskets, thread sealants, and the like to ensure a tight seal and/or prevent leaks or contamination.

Still referring to FIG. 18, at least one injector 1856 may include at least one second fluid injector inlet 1864. As used in this disclosure, a “second fluid injector inlet” is an entry point through which at least second fluid may additionally be introduced into at least one injector 1856 before being output by at least one injector 1856 in such manners described herein. In a non-limiting example, at least one second fluid injector inlet 1864 may be connected with outlet of at least one second reservoir 1832 as described above. In some cases, at least one second fluid injector inlet 1864 may be designed to provide a secure, leak-free connection with the at least one first reservoir 1808; for instance, and without limitation, at least one second fluid injector inlet 1864 may be sealed using one or more sealing elements such as O-rings, gaskets, thread sealants, and the like to ensure a tight seal and/or prevent leaks or contamination.

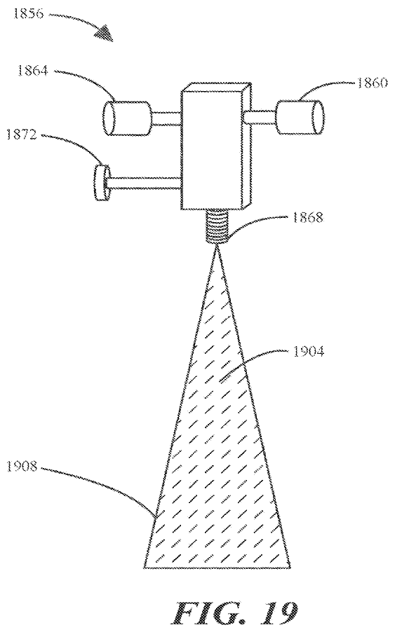

Continuing to reference FIG. 18, at least one injector 1856 may include at least a fluid outlet 1868. As used in this disclosure, a “fluid outlet” is an exit point through which at least a fluid is discharged from at least one injector 1856. In some cases, at least a fluid outlet 1868 may be configured to allow at least a fluid to be released into an intended location external to the low-pressure injection system 1800. For example, and without limitation, at least a fluid outlet 188 may be placed adjacent to a surface for painting and/or surface coating. In some cases, at least a fluid outlet 1868 may be configured to disperse the fluid in an optimal flow pattern and dispersion of the at least a fluid. Additionally, or alternatively, at least one injector 1856 and/or at least a fluid outlet 188 may be configured to disperse the first fluid of the combination in one of a plurality of first fluid spray volumes. In such an embodiment, the plurality of first fluid spray volumes may include from 4 to 25 liters per minute. Additionally, or alternatively, at least one injector 1856 and/or at least a fluid outlet 188 may be configured to disperse the second fluid of the combination in one of a plurality of second fluid spray volumes. In such an embodiment, the plurality of second fluid spray volumes may comprise flow volumes from 4 to 25 liters per minute. Further, additionally or alternatively, at least one injector 1856 and/or at least a fluid outlet 1868 may configured to disperse the combination in one of a plurality of spray patterns, described in more detail in FIG. 19. In such an embodiment, the plurality of spray patterns comprises a wide cone shape, a narrow cone shape, and the like. In a non-limiting example, at least a fluid outlet 188 may include a nozzle (i.e., a specially-shaped opening) designed to create a directed, high-velocity stream of at least a fluid, which may improve mixing and dispersion in reaction region. Such nozzle may include, without limitation, swirl nozzle, fan spray nozzle, impinging jet nozzle, multi-hole nozzle, atomizing nozzle, and the like. For example, a nozzle may include an orifice that is opened into a chamber where the liquid to be sprayed is fed under pressure. A spray may then be produced through the orifice with spray pattern, flow rate and spray angle depending upon the orifice edge profile and the design of the inside pressure chamber Furthermore, there are various spray patterns which may be produced by the nozzle such as a flat fan pattern, hollow cone pattern, full cone pattern, solid stream pattern, misting/fog pattern and the like. For example, in the flat fan spray pattern the liquid is shaped into a fan shaped sheet of fluid. This can be comprised of droplets or a sheet of water like a waterfall. Flat fans can have a spray angle of between 15 and 145 degrees depending on the nozzle design. Fans can be formed by a simple shaped orifice or by deflecting a spray on a shaped deflection surface. By way of a further example, in the full cone pattern the liquid is broken into droplets that are more or less evenly concentrated in the cone of spray produced. Again, this cone may vary from 30 to 170 degrees depending on nozzle design. Full cones can be formed by axial and tangential whirl nozzles as well as by spiral nozzles. For example, a solid stream pattern may include simple jet of focused fluid that has no true droplets. A solid stream may be formed by forcing the fluid through a shaped orifice that focuses the spray into a jet. By way of another example, the misting/fog pattern produces a homogeneous fog or mist with little or no impact. The pattern may start out as a full or hollow cone but at a very short distance from the nozzle orifice the pattern will lose coherence and form a fog or mist. Many hollow and full cone nozzles may eventually form a mist if sprayed at sufficient pressures.

Additionally, or alternatively, and still referring to FIG. 18, at least one injector 1856 may include one or more valves configured to monitor, control, or otherwise regulate the flow of at least a fluid. As used in this disclosure, a “valve” is a component that controls fluidic communication between two or more components (e.g., between combination reservoir 1852 and at least one injector 1856). Exemplary non-limiting valves include directional valves, control valves, selector valves, multi-port valves, check valves, pilot-operated flow control valves, proportional flow control valves, restrictor flow control valve, spool flow control valve and the like. For example, a pilot valve controls the position of the orifice or spool enabling the valve to maintain a consistent flow rate despite any change in system pressure. This valve may be controlled by a system pressure signal, which ensures that the valve responds quickly to any alterations in the operating conditions. By way of a further example, a proportional flow control value may include a variable orifice regulates the hydraulic fluid flow rate. An electrical signal controls the orifice's size, enabling the valve to maintain a precise flow rate. Valves may also include any suitable valve construction including ball valves, butterfly valves, needle valves, globe valves, gate valves, wafer valves, regulator valves, and the like. Valves may be included in a manifold of hydraulic or pneumatic circuit, for example allowing for multiple ports and flow paths. For example, flow control valves may control the volumetric rate of the fluid that flows through them. Generally, changing the size of the orifice is how the flow rate may be set and adjusted. For example, a tapered needle moving in and out of an orifice or opening and closing the gap inside a ball valve may change this rate. Depending on a valve's parameter, the flow rate may increase when the valve is opened to one hundred percent travel and a nearly fully opened valve allows increasing flow, hence higher production, and eliminating a bottleneck or pinch. Valves may be actuated by any known method, such as without limitation by way of hydraulic, pneumatic, mechanical, or electrical energy. For instance, in some cases, a valve may be actuated by an energized solenoid or electric motor. For example, pressure-compensated flow control valves are hydraulic components that regulate a constant fluid volume flow rate in a hydraulic system despite variations in system pressure. These valves are helpful when it may be necessary to maintain consistent speed on a hydraulic cylinder, regardless of the stress that cylinder is under Since speed is directly proportional to hydraulic flow rate, the speed of a hydraulic cylinder depends on the amount of fluid flowing through it Valve actuators and thereby valves themselves, may be controlled by computing device as described in further detail below. 1824 may be in communication with valve, for example by way of one or more of electrical communication, hydraulic communication, pneumatic communication, mechanical communication, and the like. Further, injector 18 and elements thereof will be explained in greater detail below in this disclosure.

With further reference to FIG. 18, additionally, or alternatively, at least one injector 1856 may break first fluid down into small droplets which may then be dispersed and mixed with second fluid. Further, at least one injector 1856 may be configured to adjust a droplet size of the first fluid 1812 from the combination reservoir 1852. For example, the smaller the droplet size the greater the surface area of the spray for any given volume of fluid with various factors affecting droplet size such as pressure, spray pattern type, spray angle, nozzle type specific gravity of fluid, viscosity and surface tension and the like. For example, in relation to a nozzle, the higher the fluid pressure the smaller the droplet size. For any given hydraulic nozzle the relationship between pressure and mean droplet size can be expressed as:

$$\frac{D 1}{D 2} = {( \frac{P 1}{P 2} )}^{- 0.3}$$

Wherein D is the mean droplet size at pressure 1 (P1) and pressure 2 (P2); in other embodiments, a different exponent may describe the relationship. This gives an approximate relationship for comparing droplet sizes for any given nozzle. By way of a further example, a solid stream spray may not have droplets at all, flat fan patterns may form sheets of liquid without much atomization or may produce coarsely atomized sprays and full cone nozzles will produce the next level of atomization with hollow cone nozzles producing the smallest droplets, all of which are described in further detail above. By way of further example for any given flow rate, the wider the spray angle is the smaller the droplet size will be as larger angles sprays may have more space to distribute the droplets and so there may be less chance of recombination and a greater opportunity to atomize. Additionally, the design of the spray nozzle may affect spray pattern type (e.g., flat fan, hollow cone) and this may affect droplet size, as discussed above, but even staying within a pattern type there may be a variation on levels of atomization. For example, a spiral design nozzle may produce a full cone pattern that, for a given pressure, flow rate and spray angle, may produce smaller droplets than an axial whirl nozzle. In an exemplary embodiment, at least one injector 1856 may be configured to reduce a size of droplets of first fluid 1812 formed in combination reservoir to a range of about 5 microns to about 50 microns. In such an embodiment, second fluid may be ionized as a result of the small droplet sizes of first fluid. Further, ionized second fluid may be easily transferred into the droplets of the first fluid. In some cases, droplets may carry reactants into a reaction region of a plasma reactor, described in more detail below. In some cases, droplets may enhance the mixing and interaction between different fluids within a plasma reactor, thereby improving the efficiency and/or uniformity of a treatment process.

With continued reference to FIG. 18, at least one injector 1856 may comprise a flow adjustment knob 1872. As used in this disclosure, a “flow adjustment knob” is a component that allows for the precise control and regulation of the fluid flow rate through at least one injector 1856. In some cases, flow adjustment knob 1872 may include a manual flow control valve which can be adjusted by hand to regulate the fluid flow rate through at least one injector 1856; flow control valve may include any suitable type of flow control valve, including without limitation a ball valve, a needle valve, a butterfly valve, or the like. In a non-limiting example, flow adjustment knob 1872 configured such that by turning a knob, valve opening or the opening of at least a fluid outlet 1868 may be opened and/or closed, allowing for more or less fluid to pass through at least one injector 1856. Additionally, or alternatively, flow adjustment knob 1872 may include a 10X turn-down ratio. As used in this disclosure, a “turn-down ratio” is a measure of the versatility and flexibility of flow through at least one injector 1856 controlled by flow adjustment knob 1872. For example, turn-down ratio may further refer to the width of the operational range of a device, and is defined as the ratio of the maximum capacity to minimum capacity. For example, a device with a maximum output of 10 units and a minimum output of 2 units may have a turn-down ratio of 5. In flow measurement, the turn-down ratio indicates the range of flow that a flow meter is able to measure with acceptable accuracy. The flow adjustment knob 1872 may be connected to a flow adjustment valve. For example, a typical control valve with an equal-percentage flow characteristic may have a 30:1 turn-down ratio, however, when the valve is oversized and throttling at the low end, its turn-down ratio may fall to 3:1 or less. In an embodiment, a flow adjustment knob 1872 may control fluid flow rate over a range of ten times the minimum flow rate. For example, if the minimum flow rate of flow adjustment knob 1872 is 1.75 liter per minute (GPM), a 10X turn-down ratio may indicate that flow adjustment knob 1872 may be able to effectively regulate flow rates through at least one injector 1856 from 1.75 liters per minute up to 17.5 liters per minute. In an exemplary embodiment, flow adjustment knob 1872 is configured to modify the fluid flow rate up to 10 liters per minute.

Now referencing FIG. 19, an exemplary embodiment of injector 1856 is shown. As described above, an “injector” is a component designed to dispense at least one fluid for at least one of a plurality of applications. In a non-limiting example, injector 1856 may be configured for use in industrial applications, agricultural applications, and the like. For example, injector 1856 may be configured for use associated with painting or surface coating of various items, feed waste oil into a furnace for heating or into a plasma reactor, greenhouse humidity control, odor control and chemical engineering, and the like. In a non-limiting embodiment, the plurality of spray patterns comprises a wide cone shape, a narrow cone shape, and the like. In such an embodiment, at least a fluid outlet 1868 of at least one injector 1856 may output a combination 1904 of a first fluid and a second fluid in a spray cone 1908 with any angle from about 12 degrees to about 15 degrees. First fluid may be consistent with any first fluid as discussed herein. Second fluid may be consistent with any second fluid as discussed herein.

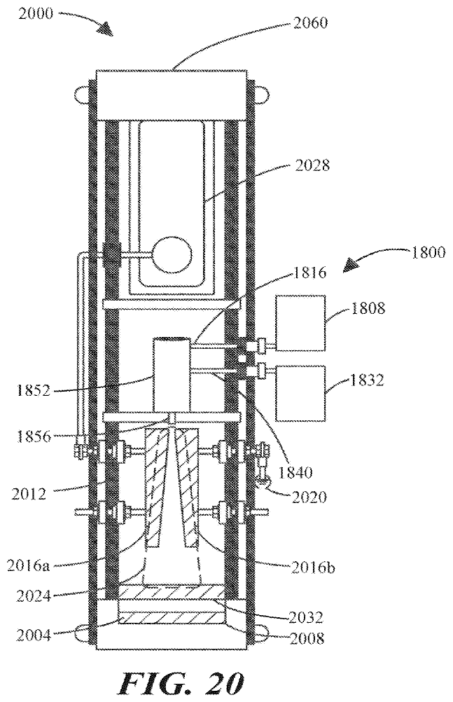

Referring now to FIG. 20, an exemplary embodiment of an apparatus 2000 for treating a growth media 2004 via an electrical discharge is illustrated. Apparatus 2000 may include a housing 2060 configured to house various internal components as discussed herein. Apparatus 2000 may include an internal injection system, such as low-pressure injection system 1800, disposed within the apparatus 2000. As used in this disclosure, an “internal injection system” is an injection system that is installed on an interior of apparatus 2000. Injection system may be any injection system described in this disclosure. In some embodiments, external injection system may be designed to deliver at least a fluid from first fluid reservoir 1808 and second reservoir 1832 into plasma reactor 2012.

With continued reference to FIG. 20, apparatus 2000 for treating a growth media 2004 via an electrical discharge. Apparatus 2000 may include a growth media 2004 within treatment chamber 2008. Apparatus 2000 may include a plasma reactor 2012. Plasma reactor 2012 may include at least a pair of electrodes 2016a-b. First electrode 2016a may include anode electrically connected to an ignition unit and second electrode 2016b may include cathode electrically connected to a ground 2020. Plasma reactor 2012 may include a reaction region 2024 disposed between first electrode 2016a and second electrode 2016b. Apparatus 2000 may include an ignition unit 2028 electrically connected to at least an electrode of at least a pair of electrodes 2016a-b. Apparatus 2000 may further include a condenser 2032 disposed within reaction region 2024 above treatment chamber 2008.

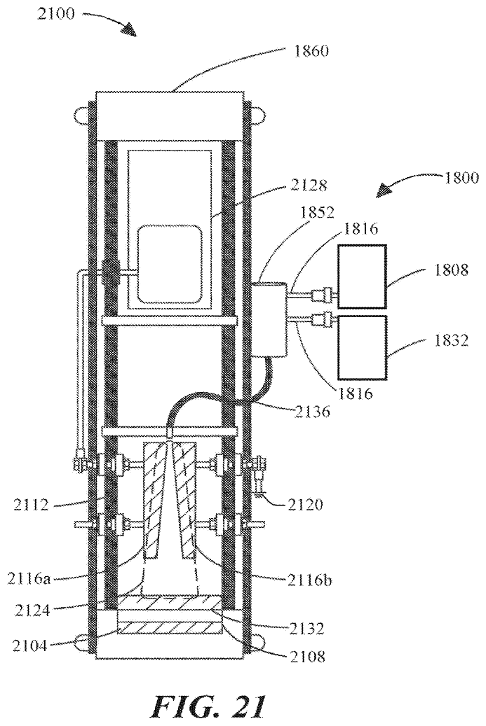

Referring now to FIG. 21, an exemplary embodiment of an apparatus 2100 for treating a growth media 2004 via an electrical discharge is illustrated. Apparatus 2100 may include an externally mounted injection system, such as low-pressure injection system 1800, disposed externally to the apparatus 2100. As used in this disclosure, an “externally mounted injection system” is an injection system that is installed on an exterior of apparatus 22100, rather than being integrated within apparatus 2100 as described above with reference to FIG. 20. Injection system may be any injection system described in this disclosure. Apparatus 2100 may include a growth media 2104 within treatment chamber 2108. Apparatus 2100 may include a plasma reactor 2112. Plasma reactor 2112 may include at least a pair of electrodes 2116a-b. First electrode 2116a may include anode electrically connected to an ignition unit and second electrode 2116b may include cathode electrically connected to a ground 2120. Plasma reactor 2112 may include a reaction region 2124 disposed between first electrode 21166a and second electrode 2116b. Apparatus 2100 may include an ignition unit 2128 electrically connected to at least an electrode of at least a pair of electrodes 2116a-b. Apparatus 2100 may further include a condenser 2132 disposed within reaction region 2124 above treatment chamber 2008.

Now referring to FIG. 21, an exemplary embodiment of apparatus 2100 for treating a growth media via an electrical discharge is illustrated. In some embodiments, external injection system may be designed to deliver at least a fluid from first fluid reservoir 1808 and second reservoir 1832 into plasma reactor 2112 from an external location via a tube 2136. In a non-limiting example, external injection system may be mechanically fixed to the exterior of a housing. In some cases, external injection system may be attached to exterior of housing via screw or bolt fastening, clamp or clip fastening, sliding or snap-fit connections, and/or the like.

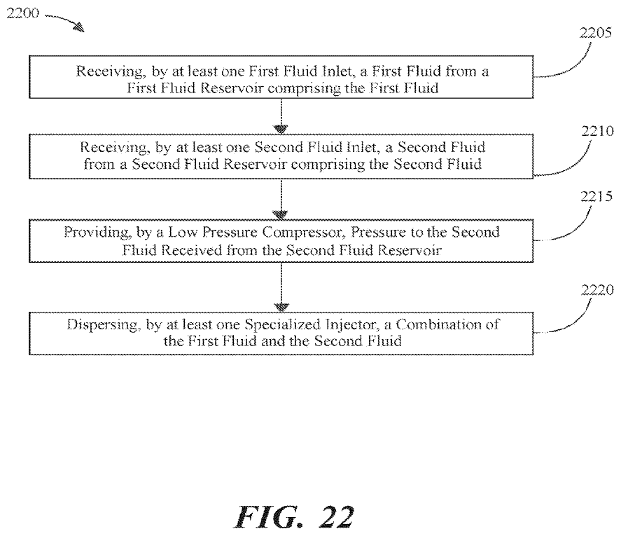

Now referring to FIG. 22, a flow diagram of an exemplary embodiment of a method 2200 for using a low-pressure injection system for a plurality of fluids is illustrated. The method 600 includes a step 2205 of receiving, by at least one first fluid inlet, a first fluid from a first fluid reservoir comprising the first fluid. In some embodiments, at least one first fluid inlet may be hydraulically connected to the first fluid reservoir. Additionally, or alternatively, the first fluid may be a liquid. This may be implemented, without limitation, as described herein.

With continued reference to FIG. 22, method 2200 includes step 2210 of receiving, at least one second fluid inlet, a second fluid from a second fluid reservoir comprising the second fluid. In some embodiments, the at least one second fluid inlet may be pneumatically connected to a second fluid reservoir. Additionally, or alternatively, the second fluid may be a gas. This may be implemented, without limitation, as described herein.

With continued reference to FIG. 22, method 2200 includes step 2215 of providing, by a low-pressure compressor, pressure to the second fluid received from the second fluid reservoir. In some embodiments, the low-pressure compressor may be configured to output a pressure from 2 bar to 7 bar. This may be implemented, without limitation, as described herein.

With continued reference to FIG. 22, method 2200 includes step 2220 of dispersing, by at least one injector, a combination of the first fluid and the second fluid. In some embodiments, at least one injector may be configured to disperse the first fluid of the combination in one of a plurality of first fluid spray volumes. Additionally, or alternatively, the plurality of fluid spray volumes may comprise from 4 to 25 liters per minute. Further, in an embodiment, at least one injector may be configured to disperse the combination in one of a plurality of spray patterns. In one embodiment, the plurality of spray patterns may comprise a cone shape. In yet another embodiment, at least one injector may be configured to disperse the second fluid of the combination at one of a plurality of second fluid flow volumes. Additionally, or alternatively, the plurality of second fluid flow volumes may comprise second fluid flow volumes from 4 to 25 liters per minute. Further, at least one injector may comprise at least one first fluid injector inlet connected to the first fluid reservoir, the at least one first fluid injector inlet configured to receive additional first fluid from the first fluid reservoir. Additionally, or alternatively, the at least one injector further may comprise at least one second fluid injector inlet connected to the second fluid reservoir, wherein the at least one second fluid injector inlet is configured to receive additional second fluid from the second fluid reservoir. Still further, wherein at least one injector may be configured to adjust a droplet size of the first fluid. In an embodiment, the droplet size of the first fluid comprises from 5 microns to 50 microns. This may be implemented, without limitation, as described herein.

With continued reference to FIG. 22, method 2200 may include modifying, by a flow adjustment knob, a fluid flow rate of the combination of the first fluid and the second fluid during operation of at least one injector. In some embodiments, the flow adjustment knob may be configured to modify the fluid flow rate up to 10 liters per minute. Additionally, or alternatively, the flow adjustment knob may be configured to modify the injector flow rate for a turn-down ratio of 10. This may be implemented, without limitation, as described herein.

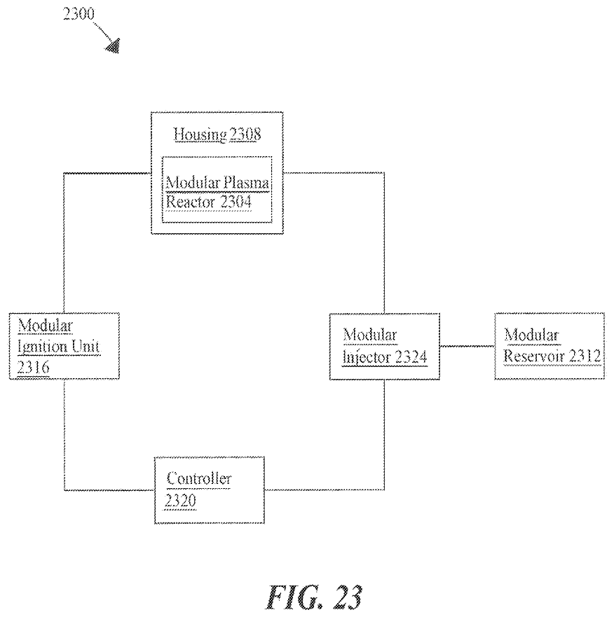

Now referring to FIG. 23, a block diagram of an exemplary embodiment of an apparatus 2300 for a modular plasma reactor 2304 is shown. The apparatus 2300 includes a modular plasma reactor 2304. For the purposes of this disclosure, a “modular plasma reactor” is a plasma reactor that can be removably connected to other modules. As used in this disclosure, a “plasma reactor” is a device configured to generate, sustain, and/or control plasma. “Plasma,” for the purpose of this disclosure, refers to the fourth state of matter, in addition to solid, liquid, and gas. Plasma may include a partially ionized gas consisting of a mixture of ions, electrons, and/or neutral particles (i.e., atoms and molecules). In an embodiment, plasma may be formed when at least a fluid subject to high-energy source, such as, without limitation, heat, radiation, electric filed, and the like, causing the atoms or molecules in at least a fluid to become ionized by losing or gaining electrons. At least a fluid may be inputted into modular plasma reactor 2304 using injector as described below in this disclosure. In some cases, plasma may include non-thermal plasma (NTP), wherein the non-thermal plasma is a type of plasma in which the electron temperature is significantly higher than the temperature of the heavier ions and neutral particles. In this case, while the electrons in plasma have high kinetic energy, the overall temperature of at least a fluid may remain relatively low (e.g., often near room temperature of 20-22° C./68-72° F.). Additionally, or alternatively, the energy distribution among particles within non-thermal plasma may not be in thermal equilibrium due to the electrons, being much lighter than ions and neutral particles, may gain energy more rapidly when subjected to an electric or magnetic field, leading to a higher electron temperature. On the other hand, heavier ions and neutral particles may move more slowly and remain cooler, resulting in low temperature of at least a fluid.

With continued reference to FIG. 23, a modular plasma reactor 2304 includes a housing 2308. As used in this disclosure, a “housing” refers to an outer structure configured to contain a plurality of components, such as, without limitation, components of apparatus 2300 as described in this disclosure. In some cases, the housing 2308 may include a durable, lightweight material such as without limitation, plastic, metal, and/or the like. In some embodiments, the housing 2308 may be scalable in size. In some embodiments, the housing 2308 may be designed and configured to protect sensitive components of apparatus 2300 from damage or contamination. In some embodiments, the housing 2308 may be portable. For the purposes of this disclosure, a “portable” refers to an object being designed to be transported from place to place. In a non-limiting example, the portable housing 2308 may include an outer casing of components of the apparatus 2300. For example and without limitation, the housing 2308 may be configured to protect components of a modular plasma reactor 2304, at least a modular reservoir 2312, a modular ignition unit 2316, a modular pressure regulator, a controller 2320, and the like separately or together. In some embodiments, the housing 2308 may include one or more flat surface on the housing 2308. For the purposes of this disclosure, “flat surface” refers to a surface of an object that is smooth and even, without any significant curvature or bumps. In a non-limiting example, the housing 2308 may include the flat surface so that the housing 2308 can be placed on the ground securely. In another non-limiting example, the housing 2308 may include the flat surface so that the housing 2308 can be mounted on another flat surface. In another non-limiting example, the housing 2308 may include the flat surface so that another object with the flat surface can be mounted on the housing 2308. In some embodiments, the housing 2308 may include one or more surface coatings and/or modifications that reduce the likelihood of unwanted adhesion or interference with external components such as debris, foreign object, liquid, and the like. Additionally, or alternatively, the housing 2308 may further include features such as latches, clips, or other fasteners that help to secure the housing 2308 in place during use.

With continued reference to FIG. 23, in some embodiments, a housing 2308 may include at least an aperture that provides a path for a connection between modules for communication. In a non-limiting example, the at least an aperture of the housing 2308 of the modular injector 2324 may provide the path for at least a fluid inlet of the modular injector 2324 to be connected with an outlet of the at least a modular reservoir 2312. The at least a fluid inlet of the modular injector 2324 and the outlet of the at least a modular reservoir 2312 are disclosed further in detail below. In another non-limiting example, the at least an aperture of the housing 2308 of the modular plasma reactor 2304 may provide the path for one or more continuous conductors of the modular ignition unit 2316 to be connected with at least an electrode of the modular plasma reactor 2304. The at least an electrode disclosed herein is further described below. In another non-limiting example, the at least an aperture of the housing 2308 of the modular plasma reactor 2304 may provide the path for at least a fluid outlet of the modular injector 2324 to be fluidically connected with the modular plasma reactor 2304. The at least a fluid outlet of the modular injector 2324 is further described below.

With continued reference to FIG. 23, as used in this disclosure, “communication” is an attribute wherein two or more relata interact with one another, for example within a specific domain or in a certain manner. In some cases, communication between two or more relata may be of a specific domain, such as without limitation electric communication, fluidic communication, informatic communication, mechanical communication, and the like. As used in this disclosure, “informatic communication” is an attribute wherein two or more relata interact with one another by way of an information flow or information in general. For example, and without limitation, a communication between a modular injector 2324 and a controller 2320 may include the informatic communication. For example, and without limitation, a communication between a modular ignition unit 2316 and the controller 2320 may include the informatic communication. As used in this disclosure, “mechanic communication” is an attribute wherein two or more relata interact with one another by way of mechanical means, for instance mechanical effort (e.g., force) and flow (e.g., velocity). “Electric communication,” as used in this disclosure, is an attribute wherein two or more relata interact with one another by way of an electric current or electricity in general. For example, and without limitation, a communication between the modular injector 2324 and the modular ignition unit 2316 may include the electric communication through one or more continuous conductors. “Fluidic communication,” as used in this disclosure, is an attribute wherein two or more relata interact with one another by way of a fluidic flow or fluid in general. For example, and without limitation, a communication between the modular injector 2324 and at least a modular reservoir 2312 may include the fluidic communication, where at least a fluid flows between the modular injector 2324 and the at least a modular reservoir 2312. The at least a fluid is disclosed further in detail below. As used in this disclosure, a “fluid” is a gaseous or liquid material that can flow, including without limitation water, nitrogen, oxygen, and/or other gases and/or liquids.

With continued reference to FIG. 23, a housing 2308 may further include a treatment chamber configured to contain a growth medium. As used in this disclosure, a “treatment chamber” is a controlled space designed to hold a specific material, substance, object and subject it to a particular treatment. In an embodiment, treatment chamber may be constructed as an open system; for instance, and without limitation, treatment chamber may include an open-top container. In another embodiments, treatment chamber may be constructed as a closed system; for instance, and without limitation, treatment chamber may be an enclosed container with an airtight seal. In some embodiments, treatment chamber may be designed to provide easy access to the growth medium being treated. In a non-limiting example, treatment chamber may include removable or hinged doors or ports for loading and/or unloading growth medium. In another non-limiting example, treatment chamber may include one or more window with/without cover for visual inspection or sampling during the treatment process.

With continued reference to FIG. 23, an apparatus 2300 includes a modular ignition unit 2316. In some embodiments, the modular ignition unit 2316 is removably connected to a modular plasma reactor 2304. For the purposes of this disclosure, “removably connected” refers to an ability for an object that is connected to another object to be disconnected from the other object without damaging or breaking said objects. In some embodiments, the modular ignition unit 2316 may include a housing 2308 as disclosed above. In some embodiments, the removable connection may include threaded connection. For the purposes of this disclosure, “threaded connection” is a type of connection that involves mating male and female halves together to create a connection to hold the threads together. As a non-limiting example, the threaded connection may be done by way of gendered mating components. As a non-limiting example, the gendered mating components may include a male component or plug which is inserted within a female component or socket. In some cases, the threaded connection may be removable. In some cases, the threaded connection may be removable, but requires a specialized tool or key for removal. In some embodiments, the threaded connection may be achieved by way of one or more of plug and socket mates, pogo pin contact, crown spring mates, and the like. In some cases, the threaded connection may be keyed to ensure proper alignment of a mating component. In some cases, the threaded connection may be lockable. As used in this disclosure, a “mating component” is a component that mates with at least another component. As a non-limiting example, the mating component may include a connector. In another embodiment, the removable connection may include bayonet connections. The bayonet connections may use a locking mechanism that allows the two components to be connected by inserting and twisting them into place. In another embodiment, the removable connection may include snap-fit connections. In some embodiments, the snap-fit connections may include a series of tabs or hooks that snap into place when the two components are pushed together. As a non-limiting example, the snap-fit connections may include snap-fit clips, snap-fit tabs, snap-fit hinges, snap-fit latches, snap-fit hooks, snap-fit pins, and the like. In another embodiment, the removable connection may include latch connections. The latch connections uses a latch or locking mechanism that secures the two components together. As a non-limiting example, the latch connections may include cabinet latches, door latches, aircraft fasteners, and the like. In another embodiment, the removable connection may include clamp connections. In some embodiments, the clamp connections uses a clamp or compression mechanism to hold the two components together. As a non-limiting example, the clamp connections may include hose clamps, c-clamps, pipe clamps, wire rope clamps, shaft collars, spring clamps, and the like. In another embodiment, the removable connection may include magnetic connections. In some embodiments, the magnetic connections uses magnets to hold the two components together. In some embodiments, the removable connection may include connectors, screws, adapters, feedthrough, and the like. For the purposes of this disclosure, a “connector” is a component configured to create an electrical or mechanical connection between two or more objects. Examples of connectors include plug and socket connectors, terminal blocks, crimp connectors, and the like. For the purposes of this disclosure, a “feedthrough” is a type of electrical component that allows electrical signals or power to pass through a barrier or enclosure while maintaining isolation between the inside and outside of the enclosure.

With continued reference to FIG. 23, in an embodiment, a modular ignition unit 2316 may be removably connected to a modular plasma reactor 2304 using one or more continuous conductors. A “continuous conductor,” as described herein, is an electrical conductor, without any interruption, made from electrically conducting material that is capable of carrying electrical current over a distance. As a non-limiting example, the electrically conductive material may include any material that is conductive to electrical current and may include, as a nonlimiting example, various metals such as copper, steel, or aluminum, carbon conducting materials, or any other suitable conductive material. In another embodiment, the modular ignition unit 2316 may be removably connected to the modular plasma reactor 2304 using a connector or an adapter. In some embodiments, the connector may be used to join wires or cables together. As a non-limiting example, the connector may connect the one or more continuous conductors. In another embodiment, the modular ignition unit 2316 may be removably connected to the modular plasma reactor 2304 using a high-voltage feedthrough. For the purposes of this disclosure, a “high-voltage feedthrough” is a sealed electrical connector that is designed to pass high-voltage current through a vacuum or pressurized chamber such as a housing of a plasma reactor. With continued reference to FIG. 23, for the purposes of this disclosure, a “modular ignition unit” is an ignition unit that can be removably connected to other modules. As used in this disclosure, an “ignition unit” is an electrical component responsible for supplying an initial electrical voltage necessary to initiate electrical discharge between electrodes. In a non-limiting example, the modular ignition unit 2316 may be configured to supply an electrical voltage to at least an electrode. The at least an electrode is disclosed further in detail below. In some embodiments, the modular ignition unit 2316 may include a power source. As used in this disclosure, a “power source” is any system, device, or means that provides power such as, without limitation, electric power to a device. Power source may provide electrical power to modular ignition unit 2316 and/or other devices/components within apparatus 2300 described in this disclosure, such as, without limitation, modular plasma reactor 2304, modular injector 2324, any computing device and/or the like. In a non-limiting example, a controller 2320 may be electrically connected to a power source. As a non-limiting example, the controller 2320 may control power to any components of the apparatus 2300 as described below. In some embodiments, the power source may be externally electrically connected to the controller 2320. In such embodiment, the power source may include an external power source such as, without limitation, a wall outlet. In some cases, transmitting electric power may include using one or more continuous conductor. In some embodiments, the power source may include a battery. In an embodiment, the power source may include direct current (DC) power. In another embodiment, the power source may include alternating current (AC) power. In some embodiments, additionally or alternatively, the power source may include AC or DC renewable power. As a non-limiting example, the AC or DC renewable power may include electrical power that is generated from renewable sources of energy such as solar, wind, hydro, geothermal, and biomass.

With continued reference to FIG. 23, in some embodiments, a modular ignition unit 2316 may be configured to convert a lower input voltage (e.g., 110V/220V for AC voltages or 12V/24V for DC voltages) from power source into a higher output voltage, thereby providing necessary electrical energy to drive a modular plasma reactor 2304. In a non-limiting example, the modular ignition unit 2316 may include an ignition transformer. As used in this disclosure, an “ignition transformer” is an electrical transformer designed to generate a high voltage output which is used to initiate electrical discharge, wherein the electrical transformer is a passive electrical device that transfers electrical energy from one circuit to another through the process of electromagnetic induction. In some cases, the electrical transformer may be used to increase or decrease the voltage levels of alternating current (AC) electrical signal while maintaining the same frequency. In a non-limiting example, ignition transformer may be configured to step up the input voltage from a lower level (from power source) to a higher voltage level required by the modular plasma reactor 2304 to create an electrical arc (i.e., point of arc). In some embodiments, the ignition transformer may include two sets of windings, wherein the two sets of windings may include a primary winding and a secondary winding. Two sets of windings may be wound around a magnetic core. In some cases, primary winding may be connected to lower voltage input, while secondary winding may generate high voltage output. In a non-limiting example, the modular ignition unit 2316 may include ignition transformer configured to converts electrical power received from power source into a high-voltage discharge of 6 kV to 30k. In another embodiment, the voltage range may be 3 kV to 18k. With continued reference to FIG. 23, in some embodiments, a modular ignition unit 2316 may be capable of converting AC voltage, which oscillates periodically between positive and negative values, into direct current, which has a constant polarity (positive or negative) and does not change over time, for connected electrodes to produce a controlled and/or stable electrical discharge to generate and/or maintain the plasma. In some cases, an apparatus 2300 may need to convert AC to DC power supply to perform a pulsed operation. During the pulse plasma operation, a modular plasma reactor 2304 may operate in a pulsed mode, where the plasma may be generated and sustained for short periods followed by a period of no electrical discharge. DC power supply may be easily controlled and switched on and off as required, thereby making it suitable for pulsed plasma operation. In some cases, the apparatus 2300 may convert AC to DC power supply to reduce electrode wear and contamination; for instance, and without limitation, in AC-powered modular plasma reactor 2304, the constantly changing polarity of electrodes may lead to accelerated electrode wear and the release of electrode material into the generated plasma. By using a DC power supply, the electrodes may maintain a constant polarity, reducing wear and contamination and increasing lifetime of the electrodes. In an embodiment, apparatus 2300 may also convert AC to AC. For example, AC to AC converters may be used for converting the AC waveforms with one particular frequency and magnitude to AC waveform with another frequency at another magnitude. For example, an AC voltage controller may be a thyristor-based device which converts fixed alternating voltage directly to variable alternating voltage without a change in frequency. AC voltage controller may be a phase-controlled device and hence no force commutation circuitry may be required and natural or line commutation may be used. In a non-limiting example, the modular ignition unit 2316 may include a rectifier. As used in this disclosure, a “rectifier” is an electrical device or circuit that converts AC to DC. The rectifier may be built using one or more diodes, wherein the diodes are semiconductor devices that allow electrical current to flow in only one direction and have a low resistance to electrical current flow in the forward direction (when the voltage is positive) and a high resistance to electrical current flow in the reverse direction (when the voltage is negative). In some cases, the rectifier may include, without limitation, half-wave rectifier, full-wave rectifier, and the like.

With continued reference to FIG. 23, in some embodiments, a modular ignition unit 2316 may include a power regulator (i.e., filter). As described in this disclosure, a “power regulator” is an electric device in power source that performs electrical power regulation or redistribution, wherein “power regulation” or “power redistribution,” as described herein, refers to a process that keeps voltage of power source below its maximum value during operation, non-operation, or charging. In a non-limiting example, the power regulator may be used to remove or attenuate unwanted frequencies, noise, or voltage fluctuations from the output voltage or current. The power regulator may include, without limitation, passive filter, active filter, EMI/RFI filter, voltage regulator, and the like. Additionally, or alternatively, modular ignition unit 2316 may include a balancer. As described herein, a “balancer” is an electric that performs power balancing, wherein “power balancing,” for the purpose of this disclosure, refers to a process that balances electric energy from one or more first power sources (e.g., strong batteries) to one or more second power sources (e.g., weaker batteries). Persons skilled in the art, upon reviewing the entirety of this disclosure, will be aware of various devices/components that may be used within modular ignition unit 2316 of apparatus 2300.

With continued reference to FIG. 23, additionally or alternatively, in some embodiment, a plasma reactor 2304 may include an on-board ignition unit. For the purposes of this disclosure, an “on-board ignition unit” is an ignition unit that is included in a housing that includes a plasma reactor. In some embodiments, the on-board ignition unit may be directly connected to the modular plasma reactor 2304 using a continuous conductor, a feedthrough, a connector or an adapter as described above. In some embodiments, the on-board ignition unit may be directly connected to the modular plasma reactor 2304. As a non-limiting example, in a direct connection, the on-board ignition unit may be physically attached to at least an electrode of the modular plasma reactor 2304 or other components inside the housing 2308. As another non-limiting example, the on-board ignition unit may be directly connected to the modular plasma reactor 2304 using a variety of techniques, such as but not limited to welding, soldering, brazing, adhesive bonding, or mechanical fasteners. As a non-limiting example, the mechanical fasteners may include bolts, screws, nuts, washers, rivets, pins, and the like. In some embodiments, a controller 2320 may be removably connected to the on-board ignition unit. In some embodiments, the controller 2320 may be configured to control a power to the on-board ignition unit to supply an initial electrical voltage necessary to initiate electrical discharge between electrodes.

With continued reference to FIG. 23, additionally or alternatively, a modular ignition unit 2316 may include a coil. As used in this disclosure, a “coil” is a wound spiral or helix of conductive wire that creates an electromagnetic field when an electric current flows through it. In a non-limiting example, the coil may be electrically connected to at least an electrode of at least a pair of electrodes of a modular plasma reactor 2304, configured to initiate electrical discharge in the modular plasma reactor 2304. As a non-limiting example, the coil may include an inductive coil or a high-voltage transformer coil. For the purposes of this disclosure, an “inductive coil” is an electronic component that stores energy in a magnetic field when an electrical current flows through it. As a non-limiting example, the inductive coil may include a wire coil that is wound around a core material, such as iron, ferrite or the like, that amplifies the magnetic field. In some embodiments, the inductive coil or the high-voltage transformer coil may generate high-voltage electrical pulses necessary to create electrical discharge between a first electrode and a second electrode of the at least a pair of electrodes of the modular plasma reactor 2304. By passing the high-frequency electrical current through the inductive coil, an oscillating magnetic field can be created. This magnetic field can then induce an electrical current in the gas or plasma, ionizing it and creating a plasma discharge (e.g. inductively coupled plasma (ICP)). In some embodiments, the magnetic field created around the inductive coil can be used to confine the plasma within the modular plasma reactor 2304.

With continued reference to FIG. 23, an apparatus 2300 includes a modular injector 2324. For the purposes of this disclosure, a “modular injector” is an injector that can be removably connected to other modules. As used in this disclosure, an “injector” is a component designed to introduce at least a fluid into a plasma reactor, specifically, reaction region of plasma reactor. In a non-limiting example, the modular injector 2324 may be configured to feed at least a fluid through reaction region. The reaction region and the at least a fluid disclosed herein are described below. The at least a fluid may then be used by the modular plasma reactor 2304 to generate plasma. In some embodiments, the modular injector 2324 is removably connected to the modular plasma reactor 2304. In some embodiments, the modular injector 2324 may be connected to modular plasma reactor 2304 using an injector mount flange. As used in this disclosure, an “injector mount flange” is a rim that projects from an object, that is used to attach injector to a housing of a plasma reactor. In a non-limiting example, the injector mount flange may include an interface between the modular injector 2324 and the modular plasma reactor 2304. In some cases, at least a fluid outlet of the modular injector 2324 may include a threaded adaptor. Both the at least a fluid outlet and the interface may include a threaded section; for instance, and without limitation, the at least a fluid outlet/interface may include a male/female threaded section, wherein the male and the female threaded section are compatible (i.e., matched). The modular injector 2324 may be threaded, using the at least a fluid outlet with threaded adaptor onto the injector mount flange at the interface. An exemplary configuration of the modular injector 2324, the at least a fluid outlet of the modular injector 2324, the injector mount flange and the interface is shown in FIG. 2.

With continued reference to FIG. 23, a modular injector 2324 may include at least a fluid inlet. As used in this disclosure, a “fluid inlet” is an entry point through which at least a fluid is introduced into the modular injector 2324 before being fed into reaction region of a modular plasma reactor 2304 or any other process described in this disclosure. In a non-limiting example, the at least a fluid inlet may be connected with outlet of at least a modular reservoir 2312 as described above. In some cases, the at least a fluid inlet may be designed to provide a secure, leak-free connection with the at least reservoir; for instance, and without limitation, the at least a fluid inlet may be sealed using one or more sealing elements such as O-rings, gaskets, thread sealants, and the like to ensure a tight seal and/or prevent leaks or contamination. The modular injector 2324 may include at least a fluid outlet. As used in this disclosure, a “fluid outlet” is an exit point through which at least a fluid is discharged from the modular injector 2324 into reaction region of the modular plasma reactor 2304. In some cases, the at least a fluid outlet may be configured to allow at least a fluid to be released into the intended location within reaction region. For example, and without limitation, the at least a fluid outlet may be placed at the center and right above at least a pair of electrodes. The at least a fluid outlet may be at a distance with at least a pair of electrodes or reaction region. Such distance may impact the time and space available for at least a fluid to mix and interact with the plasma or other process components. In some cases, the at least a fluid outlet may be configured to provide an optimal flow pattern and dispersion of the at least a fluid into reaction region. In a non-limiting example, the at least a fluid outlet may include a nozzle (i.e., a specially-shaped opening) designed to create a directed, high-velocity stream of at least a fluid, which may improve mixing and dispersion in reaction region. Such nozzle may include, without limitation, swirl nozzle, fan spray nozzle, impinging jet nozzle, multi-hole nozzle, atomizing nozzle, and the like.

With continued reference to FIG. 23, additionally, or alternatively, a modular injector 2324 may include one or more valves configured to monitor, control, or otherwise regulate the flow of at least a fluid fed through reaction region of a modular plasma reactor 2304. As used in this disclosure, a “valve” is a component that controls fluidic communication between two or more components (e.g., between at least a modular reservoir 2312 and the modular injector 2324). Exemplary non-limiting valves include directional valves, control valves, selector valves, multi-port valves, check valves, and the like. Valves may include any suitable valve construction including ball valves, butterfly valves, needle valves, globe valves, gate valves, wafer valves, regulator valves, and the like. Valves may be included in a manifold of hydraulic or pneumatic circuit, for example allowing for multiple ports and flow paths. Valves may be actuated by any known method, such as without limitation by way of hydraulic, pneumatic, mechanical, or electrical energy. For instance, in some cases, a valve may be actuated by an energized solenoid or electric motor. Valve actuators and thereby valves themselves, may be controlled by a controller 2320 as described in detail below. The controller 2320 may be in communication with valve, for example by way of one or more of electrical communication, hydraulic communication, pneumatic communication, mechanical communication, and the like.

With continued reference to FIG. 23, in some embodiments, a modular injector 2324 may include a flow adjust component. As used in this disclosure, a “flow adjustment component” is a device that allows for the precise control and regulation of the fluid flow rate through an injector. In some cases, the flow adjustment component may include a manual flow control valve which can be adjusted by hand to regulate the fluid flow rate through the modular injector 2324. In a non-limiting example, by turning a knob, valve opening or the opening of at least a fluid outlet may be changed, allowing for more or less fluid to pass through the modular injector 2324 or introduce into a modular plasma reactor 2304. In some cases, the flow adjustment component may include an actuator which can be controlled by a controller 2320 to the fluid flow rate through the modular injector 2324. The controller 2320 may be in communication with the flow adjustment component, for example by way of one or more of electrical communication, hydraulic communication, pneumatic communication, mechanical communication, and the like. In some embodiments, the flow adjustment component may include an 8X tum-down ratio. As used in this disclosure, a “tum-down ratio” is a measure of the versatility and flexibility of flow adjustment component which indicates how well the flow adjustment component accommodates different flow rate requirements within a system. Such flow adjustment component may control fluid flow rate over a range of eight times the minimum flow rate. For example, if the minimum flow rate of the flow adjustment component is 23 gallon per minute (GPM), an 8X tum-down ratio may indicate that the flow adjustment component may be able to effectively regulate flow rates from 1 GPM up to 8 GPM.

With continued reference to FIG. 23, an apparatus 2300 includes at least a modular reservoir 2312. For the purposes of this disclosure, a “modular reservoir” is a reservoir that can be removably connected to other modules. As used in this disclosure, a “reservoir” is a container or storage chamber designed to hold at least a fluid. In a non-limiting example, the at least a reservoir may be configured to contain at least a fluid. The at least a reservoir may provide a consistent and controlled supply of the at least a fluid for the treatment of growth medium as described in further detail below. In an embodiment, the at least a fluid may include a substance that enables the production of electrical discharge. In some cases, the at least a fluid may include liquid; for instance, and without limitation, the at least a fluid may include water, organic solvents, electrolyte solutions, and the like. In other cases, the at least a fluid may include one or more gases; for instance, and without limitation, the at least a fluid may include inert gases (e.g., nitrogen, argon, helium, neon, and the like), oxygen, carbon dioxide, air, reactive gases (e.g., hydrogen, ammonia, sulfur hexafluoride, and the like), and the like. Additionally, or alternatively, the apparatus 2300 may include a plurality of reservoirs 2312. In an embodiment, the at least a modular reservoir 2312 may include a first modular reservoir 2312 configured to contain a first fluid and a second modular reservoir 2312 configured to contain a second fluid, wherein the first fluid may include at least a gas and the second fluid may include at least a liquid.

With continued reference to FIG. 23, at least a modular reservoir 2312 may be constructed from materials that are compatible with at least a fluid being stored. For example, and without limitation, the at least a modular reservoir 2312 may be made from material such as corrosion-resistant metals, plastics, and/or glass. In some cases, the at least a modular reservoir 2312 may be appropriately sized to provide an adequate supply of fluid throughout the treatment process without frequent refilling or interruptions. The at least a modular reservoir 2312 may include at least an inlet, at least an outlet, or both. In a non-limiting example, the at least an inlet may be used for filling the at least a modular reservoir 2312 with the at least a fluid and the at least an outlet may be connected to a modular injector 2324 or other fluid delivery component of apparatus 2300 such as a modular pressure regulator as described in further detail below. in some embodiments, at least a modular reservoir 2312 is removably connected to the modular injector 2324. The at least a fluid may be input through the at least an inlet into the at least a modular reservoir 2312 and/or output through the at least an outlet to the modular injector 2324. In the case of apparatus 2300 having a plurality of reservoirs 2312, each modular reservoir 2312 of plurality of reservoirs 2312 may include the at least an inlet and the at least an outlet. In a non-limiting example, a first modular reservoir 2312 configured to contain a first fluid may include a first inlet and a first outlet, a second modular reservoir 2312 configured to contain a second fluid may include a second inlet and a second outlet, wherein the first inlet/first outlet may never intersect with the second inlet/second outlet. In such embodiment, the first fluid and the second fluid may not contact each other before output through the first outlet/second outlet.

With continued reference to FIG. 23, in some embodiments, an apparatus 2300 may include a modular pressure regulator. For the purposes of this disclosure, a “modular pressure regulator” is a pressure regulator that can be removably connected to other modules. As used in this disclosure, a “pressure regulator” is a component designed to control and maintain the pressure of at least a fluid, wherein such pressure drives the flow of the at least a fluid into a plasma reactor. In an embodiment, the modular pressure regulator may include an atmospheric pressure system. As used in this disclosure, an “atmospheric pressure system” is a mechanism that controls the pressure of the fluid being introduced into a plasma reactor around atmospheric pressure. “Atmospheric pressure,” for the purpose of this disclosure, is the pressure exerted by the weight of air in the Earth's atmosphere at sea level, which is approximately 101.3 kilopascals (kPa) or 14.7 pounds per square inch (psi). In some embodiments, the modular pressure regulator may ensure that at least a fluid being injected into reaction region of a modular plasma reactor 2304 is maintained at or near atmospheric pressure. In some embodiments, the modular pressure regulator may be responsible for transferring the at least a fluid from at least a modular reservoir 2312 to a modular injector 2324, providing a consistent and controlled flow of the at least a fluid into reaction region of the modular plasma reactor 2304.

With continued reference to FIG. 23, in some embodiments, a modular pressure regulator may be removably connected to at least a modular reservoir 2312. In some cases, the modular pressure regulator may include a flow component removably connected with the at least a reservoir configured to flow at least a fluid from at least a fluid inlet of a modular injector 2324 or outlet of at least a modular reservoir 2312 to at least a fluid outlet of the modular injector 2324. In some embodiments, the flow component may include a passive flow component configured to initiate a passive flow process. As used in this disclosure, a “passive flow component” is a component that imparts a passive flow on at least a fluid, wherein the “passive flow,” for the purpose of this disclosure, is flow of fluid, which is induced absent any external actuators, fields, or power sources. A “passive flow process,” as described herein, is a plurality of actions or steps taken on passive flow component in order to impart a passive flow on at least a fluid. In a non-limiting example, with the modular pressure regulator including the passive flow component, the modular injector 2324 may be able to feed the at least a fluid through a reaction region as a function of the passive flow process. The passive flow component may employ one or more passive flow techniques in order to initiate passive flow process; for instance, and without limitation, the passive flow techniques may include osmosis, capillary action, surface tension, pressure, gravity-driven flow, hydrostatic flow, vacuums, and the like. The passive flow component may be in fluidic communication with the at least a modular reservoir 2312.

With continued reference to FIG. 23, in other embodiments, a flow component may include an active flow component configured to initiate an active flow process. As used in this disclosure, an “active flow component” is a component that imparts an active flow on a fluid, wherein the “active flow,” for the purpose of this disclosure, is flow of fluid which is induced by external actuators, fields, or power sources. An “active flow process,” as described in this disclosure, is a plurality of actions or steps taken on active flow component in order to impart active flow on at least a fluid. In some embodiments, the active flow component may be electrically connected to a power source. In some embodiments, the power source may be controlled by a controller 2320, where the controller 2320 may control a power to the active flow component of the modular pressure regulator. In a non-limiting example, with a modular pressure regulator including the active flow component, a modular injector 2324 may be able to feed at least a fluid through the reaction region as a function of the active flow process. Atmospheric pressure system may be configured to pressurize the at least a fluid entering the reaction region of a modular plasma reactor 2304; for instance, and without limitation, active flow component of the modular pressure regulator may include one or more pumps. The pump may include a substantially constant pressure pump (e.g., centrifugal pump) or a substantially constant flow pump (e.g., positive displacement pump, gear pump, and the like). The pump can be hydrostatic or hydrodynamic. As used in this disclosure, a “pump” is a mechanical source of power that converts mechanical power into fluidic energy. The pump may generate flow with enough power to overcome pressure induced by a load at a pump outlet. The pump may generate a vacuum at a pump inlet, thereby forcing fluid from a reservoir into the pump inlet to the pump and by mechanical action delivering this fluid to a pump outlet. Hydrostatic pumps are positive displacement pumps. The hydrodynamic pumps can be fixed displacement pumps, in which displacement may not be adjusted, or variable displacement pumps, in which the displacement may be adjusted. Exemplary non-limiting pumps include gear pumps, rotary vane pumps, screw pumps, bent axis pumps, inline axial piston pumps, radial piston pumps, and the like. The pump may be powered by any rotational mechanical work source, for example without limitation, an electric motor or a power take off from the power source. The pump may be in fluidic communication with at least a modular reservoir 2312.

With continued reference to FIG. 23, in some embodiments, a modular pressure regulator may include a low-pressure compressor. For the purposes of this disclosure, a “low-pressure compressor” is a device or a component configured to provide pressure to at least a fluid of at least a reservoir. The low-pressure compressor may include a pneumatic compression device. In some embodiments, the low-pressure compressor may include a hydraulic, air, or other compressor. Further, the low-pressure compressor may be a piston compressor, diaphragm compressor, helical screw compressor, sliding vane compressor, scroll compressor, rotary lobe compressor, centrifugal compressor, and like. The low-pressure compressor may be configured to apply a pressure to the at least a fluid and/or a modular injector 2324. In some embodiments, the low-pressure compressor may be configured to apply a pressure between 2 bars and 7 bars. In some embodiments, a controller 2320 may be configured to control a power to the low-pressure compressor to output a pressure. In a non-limiting example, the controller 2320 may be configured to control a power to the low-pressure compressor to output the pressure between 2 bars and 7 bars. In some embodiments, the low-pressure compressor may be automated. The low-pressure compressor may be automated to apply the pressure for a set period of time. As a non-limiting example, the controller 2320 may include a timing component as described below, where the controller 2320 may control the low-pressure compressor to apply the pressure for the set period of time using the timing component. In some embodiments, the low-pressure compressor may be configured to slowly apply an increasing pressure to the modular injector 2324 and/or the at least a modular reservoir 2312. In other embodiments, the low-pressure compressor may be automated to apply a constant pressure to the modular injector 2324 and/or the at least a modular reservoir 2312. As a non-limiting example, the low-pressure compressor may be driven by direct current (DC) electric power. In some embodiments, the low-pressure compressor may be driven by electric power having varying or reversing voltage levels, such as AC power as produced by an alternating current generator and/or inverter, or otherwise varying power, such as produced by a switching power source.

With continued reference to FIG. 23, an apparatus 2300 includes a controller 2320. For the purposes of this disclosure, a “controller” is an electronic device or system that manages and regulates operations related to a plasma reactor. In some embodiments, controller 2320 may include a modular controller. For the purposes of this disclosure, a “modular controller” is a controller that can be removably connected to other modules. In some embodiments, the controller 2320 may include a computing device configured to control various internal components as described above, such as, without limitation, the modular plasma reactor 2304, a modular ignition unit 2316, a modular injector 2324, a modular pressure regulator, and the like. In some embodiments, the controller 2320 may be configured to allow for a direct human interface and/or remote operation. In some embodiments, the controller 2320 may include various communication protocols and interfaces to facilitate communication between the controller 2320 and other components of the apparatus 2300. In some embodiments, the controller 2320 may be configured to control various aspects of a plasma reactor system, such as the power supply, gas flow rate, pressure, temperature, fluid volume, and other parameters that affect plasma generation and maintenance.

With continued reference to FIG. 23, a controller 2320 may include any computing device as described in this disclosure, including without limitation a microcontroller, microprocessor, a programmable logic controller (PLC), digital signal processor (DSP) and/or system on a chip (SoC) as described in this disclosure. For the purpose of this disclosure, a “programmable logic controller” is a digital computer-based system used for automation and control of any system. In some embodiments, the PLC may be programmed using various programming languages to create a sequence of instructions that control components of an apparatus 2300's operations. As a non-limiting example, the PLC may be programmed using ladder logic, function block diagrams, or the like. For example, and without limitation, the PLC may be programmed to control the fluid flow into a modular plasma reactor 2304, adjust the power input to the components of the apparatus 2300, regulate the temperature of the modular plasma reactor 2304, and the like. Any computing device disclosed in the entirety of this disclosure may be consistent with the functions of the PIC. Computing device may include, be included in, and/or communicate with a mobile device such as a mobile telephone or smartphone. Controller 2320 may include a single computing device operating independently, or may include two or more computing device operating in concert, in parallel, sequentially or the like; two or more computing devices may be included together in a single computing device or in two or more computing devices. Controller 2320 may interface or communicate with one or more additional devices as described below in further detail via a network interface device. Network interface device may be utilized for connecting controller 2320 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Controller 2320 may include but is not limited to, for example, a computing device or cluster of computing devices in a first location and a second computing device or cluster of computing devices in a second location. Controller 2320 may include one or more computing devices dedicated to data storage, security, distribution of traffic for load balancing, and the like. Controller 2320 may distribute one or more computing tasks as described below across a plurality of computing devices of computing device, which may operate in parallel, in series, redundantly, or in any other manner used for distribution of tasks or memory between computing devices. Controller 2320 may be implemented using a “shared nothing” architecture in which data is cached at the worker, in an embodiment, this may enable scalability of apparatus 2300 and/or computing device.

With continued reference to FIG. 23, a controller 2320 may be designed and/or configured to perform any method, method step, or sequence of method steps in any embodiment described in this disclosure, in any order and with any degree of repetition. For instance, controller 2320 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Controller 2320 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 23, in some embodiments, a controller 2320 is communicatively connected to one or more of a modular ignition unit 2316 and a modular injector 2324. In some embodiments, the controller 2320 may be removably connected to a modular pressure regulator, or other components of an apparatus 2300. In some embodiments, the controller 2320 may be removably connected to the components of an apparatus 2300 using wired or wireless connection, or any network or connection protocols disclosed in the entirety of this disclosure. In some embodiments, the controller 2320 may be removably connected to the components of the apparatus 2300 using a communication port. For the purposes of this disclosure, a “communication port” is a physical interface on a device that allows it to send and receive data to and from other devices or systems. In some embodiments, the controller 2320 may be removably connected to the components of the apparatus 2300 using Ethernet, RS-232, RS-485, Controller Area Network (CAN) bus, or the like. In some embodiments, the controller 2320 may be in communication with the one or more of a modular ignition unit 2316 and a modular injector 2324. In some embodiments, the controller 2320 may in communication with a modular pressure regulator, or other components of an apparatus 2300. As a non-limiting example, the communication may include electric communication, fluidic communication, informatic communication, mechanic communication, and the like.

With continued reference to FIG. 23, in some embodiments, a controller 2320 may be configured to receive at least a connection signal. For the purposes of this disclosure, a “connection signal” is a signal that indicates a connection between components of an apparatus. As a non-limiting example, the controller 2320 may receive the at least a connection signal when a modular ignition unit 2316 is removably connected to the modular plasma reactor 2304. As another non-limiting example, the controller 2320 may receive the at least a connection signal when a modular injector 2324 is removably connected to the modular plasma reactor 2304. As another non-limiting example, the controller 2320 may receive the at least a connection signal when a modular reservoir 2312 is removably connected to the modular injector 2324.

With continued reference to FIG. 23, in an embodiment, a controller 2320 may be configured to receive at least a connection signal from at least a sensor. For the purposes of this disclosure, a “sensor” is a device that produces an output signal for the purpose of sensing a physical phenomenon. For example, and without limitation, the at least a sensor may transduce a detected phenomenon, such as without limitation, temperature, voltage, current, pressure, speed, motion, light, moisture, and the like, into a sensed signal. The at least a sensor may output the sensed signal. As a non-limiting example, the at least a sensor may output at least a connection signal. The at least a sensor may include any computing device as described in the entirety of this disclosure and configured to convert and/or translate a plurality of signals detected into electrical signals for further analysis and/or manipulation. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sine function, or pulse width modulated signal. Any datum captured by the at least a sensor may include circuitry, computing devices, electronic components or a combination thereof that translates into at least an electronic signal configured to be transmitted to another electronic component. In a non-limiting embodiment, the at least a sensor may include a plurality of sensors comprised in a sensor suite. In one or more embodiments, and without limitation, the at least a sensor may include a plurality of sensors.

With continued reference to FIG. 23, in some embodiments, at least a sensor may include a proximity sensor. In some embodiments, the proximity sensor may be configured to generate at least a connection signal as a function of a connection between components of an apparatus 2300. As used in this disclosure, a “proximity sensor” is a sensor that is configured to detect at least a phenomenon related to one of components of an apparatus being mated to another of components of an apparatus. “Mate,” as used in this disclosure, is an action of attaching two or more components together. In some embodiments, the proximity sensors may be used to detect the presence of the components of the apparatus 2300 and may send the at least a connection signal to a controller 2320 indicating that the connection has been made. As a non-limiting example, the components of the apparatus 2300 may include a connector, adapter, continuous conductor, fastener, port, or the like of a modular plasma reactor 2304, modular ignition unit 2316, modular injector 2324, modular reservoir 2312, controller 2320, modular pressure regulator, and the like. Exemplary proximity sensor may include any sensor described in this disclosure, including without limitation a switch, a capacitive sensor, a capacitive displacement sensor, a doppler effect sensor, an inductive sensor, a magnetic sensor, an optical sensor (such as without limitation a photoelectric sensor, a photocell, a laser rangefinder, a passive charge-coupled device, a passive thermal infrared sensor, and the like), a radar sensor, a reflection sensor, a sonar sensor, an ultrasonic sensor, fiber optics sensor, a Hall effect sensor, and the like.

With continued reference to FIG. 23, in some embodiments, at least a sensor may include a flow sensor. For the purposes of this disclosure, a “flow sensor” is a sensor that measures a flow of a fluid. In an embodiment, the flow sensor may measure a volumetric flow rate. For the purposes of this disclosure, a “volumetric flow rate” refers to the volume of fluid that passes a measurement point over a period of time. In another embodiment, the flow sensor may measure a mass flow rate. For the purposes of this disclosure, a “mass flow rate” refers to the amount of mass of fluid that passes a specific point over a period of time. In some embodiments, the flow sensor may be configured to measure a speed of a flow. For the purposes of this disclosure, a “speed” of a flow refers to an indication of how fast a substance moves through a conduit from one place to another. In some embodiments, the flow sensor may be configured to measure a distance of a flow. For the purposes of this disclosure, a “distance” of a flow refers to a distance a substance moves over a period of time. In some embodiments without limitation, the flow sensor may include ultrasonic meter, electromagnetic meter, Karman vortex meter, paddlewheel meter, floating element meter, thermal meter, differential pressure types meter, and the like. Persons skilled in the art, upon reviewing the entirety of this disclosure, will be aware of various ways in which steps, sequences of steps, and/or processing tasks to detect the flow of fluids for the disclosure.

With continued reference to FIG. 23, in some embodiments, at least a sensor may include a force sensor. For the purposes of this disclosure, a “force sensor” is a sensor that that converts an input mechanical load, weight, tension, compression or pressure into an electrical output signal. As a non-limiting example, the force sensor may include a tension force sensor, compression force sensor, tension and compression force sensor, and the like. As another non-limiting example, the force sensor may include a strain gauge, load cell, piezoelectric sensor, capacitive sensor, magnetic sensor, and the like. In some embodiments, the force sensor may be configured to transform a pressure into an analogue electrical signal. In some embodiments, the force sensor may be configured to transform a force into a digital signal.

With continued reference to FIG. 23, in some embodiments, at least a sensor may include an electrical sensor. As described in this disclosure, an “electrical sensor” is a device that is configured to detect an electrical parameter associated with an electrical phenomena. Exemplary non-limiting electrical sensors include volt-meters, amp-meters, ohm-meters, multi-meters, oscilloscopes, and the like. In some embodiments, the at least a sensor may include other types of sensors to detect changes in other parameters that can indicate whether a connection of components of an apparatus 2300 has been made.

With continued reference to FIG. 23, in another embodiment, a controller 2320 may be configured to receive at least a connection signal from a switch. For the purposes of this disclosure, a “switch” is a type of electronic or mechanical component that is configured to detect and manage connections between individual modules. In some embodiments, the switch may be configured to detect the presence or absence of a physical connection between components of an apparatus 2300. As a non-limiting example, the components of the apparatus 2300 may be designed with connectors that includes the switch that detects when one component of the apparatus 2300 is physically connected (or removably connected) to another component of the apparatus 2300. Then, in a non-limiting example, the switch may send at least a connection signal to a controller 2320 indicating the status of the connection.

With continued reference to FIG. 23, in another embodiment, a controller 2320 may be configured to receive at least a connection signal from an electronic communication protocol. For the purposes of this disclosure, an “electronic communication protocol” is a set of rules and standards that define how electronic devices communicate with each other over a network or bus system. In some embodiments, the electronic communication protocol may be used to detect and confirm connections between components of an apparatus 2300, control signals between components of an apparatus 2300 and the controller 2320, and the like. In some embodiments, the electronic communication protocol may include Modbus, Ethernet/IP, CAN, OLE for Process Control (OPC), Bluetooth, and the like.

With continued reference to FIG. 23, in some embodiments, a controller 2320 may be configured to analyze a number of modules connected to a modular plasma reactor 2304 using at least a connection signal. As a non-limiting example, the controller 2320 may analyze a number of modules, such as but not limited to a modular ignition unit 2316, modular injector 2324, modular reservoir 2312, controller 2320, modular pressure regulator, and the like, removably connected to the modular plasma reactor 2304 as a function of a number of the at least a connection signals from them. In some embodiments, the controller 2320 may be configured to analyze which of the components of the apparatus 2300 is connected to the modular plasma reactor 2304 using the at least a connection signal. In some embodiments, the controller 2320 may be configured to control power that is supplied to the components of the apparatus 2300 as a function of the at least a connection signal. As a non-limiting example, the controller 2320 may supply the power to the modular ignition unit 2316 once the controller 2320 receives the at least a connection signal that indicates the modular ignition unit 2316 is removably connected to the modular plasma reactor 2304. As another non-limiting example, the controller 2320 may supply the power to the modular injector 2324 once the controller 2320 receives the at least a connection signal that indicates the modular injector 2324 is removably connected to the modular plasma reactor 2304. As another non-limiting example, the controller 2320 may supply the power to the modular pressure regulator once the controller 2320 receives the at least a connection signal that indicates the modular pressure regulator is removably connected to the modular injector 2324.

With continued reference to FIG. 23, a controller 2320 may be in communication with a modular ignition unit 2316. In some embodiments, the controller 2320 may send ignition commands to the modular ignition unit 2316, for example by way of ignition command signals. “Ignition command signal,” as used in this disclosure, is a signal representing an ignition command. “Ignition command,” as used in this disclosure, is a communication intended for a modular ignition unit. In some cases, the ignition command may be used to affect performance of the modular ignition unit 2316. As a non-limiting example, the ignition command may be configured to control amount of power of the modular ignition unit 2316. In some cases, the controller 2320 may receive ignition data from the modular ignition unit 2316, for example by way of ignition data signals. As used in this disclosure, a “ignition data signal” is a signal representing ignition data. As used in this disclosure, “ignition data” is information associated with a modular ignition unit. In some cases, ignition data may represent performance and/or operation of the modular ignition unit 2316.

With continued reference to FIG. 23, a controller 2320 may be in communication with a modular injector 2324. In some embodiments, the controller 2320 may send ignition commands to the modular injector 2324, for example by way of injector command signals. “Injector command signal,” as used in this disclosure, is a signal representing an injector command. “Injector command,” as used in this disclosure, is a communication intended for a modular injector unit. In some cases, the injector command may be used to affect performance of the modular injector 2324. As a non-limiting example, the injector command may be configured to configured to control the modular injector 2324 to disperse at least a fluid in one of a plurality of fluid spray volumes. For example, and without limitation, the injector command may be configured to configured to control one or more valves of the modular injector 2324 to disperse at least a fluid in one of a plurality of fluid spray volumes. For example, and without limitation, the injector command may be configured to control a flow adjustment component of the modular injector 2324 to disperse at least a fluid in one of a plurality of fluid spray volumes. For the purposes of this disclosure, “fluid spray volume” is amount of fluid gets output from a modular injector. In some cases, the controller 2320 may receive injector data from the modular injector 2324, for example by way of injector data signals. As used in this disclosure, an “injector data signal” is a signal representing injector data. As used in this disclosure, “injector data” is information associated with a modular injector unit. In some cases, injector data may represent performance and/or operation of the modular injector 2324.

With continued reference to FIG. 23, a controller 2320 may be in communication with a modular pressure regulator. In some embodiments, the controller 2320 may send pressure regulator commands to the modular pressure regulator, for example by way of pressure regulator command signals. “Pressure regulator command signal,” as used in this disclosure, is a signal representing a pressure regulator command. “Pressure regulator command,” as used in this disclosure, is a communication intended for a modular pressure regulator. In some cases, the pressure regulator command may be used to affect performance of the modular pressure regulator. As a non-limiting example, the pressure regulator command may be configured to control actuators, such as but not limited to an active flow component, of the modular pressure regulator. For example, and without limitation, the pressure regulator command may be configured to control a pump of the pressure regulator command. In some cases, the controller 2320 may receive pressure regulator data from the modular pressure regulator, for example by way of pressure regulator data signals. As used in this disclosure, a “pressure regulator data signal” is a signal representing pressure regulator data. As used in this disclosure, “pressure regulator data” is information associated with a modular pressure regulator. In some cases, pressure regulator data may represent performance and/or operation of the modular pressure regulator. Additional disclosure related to the controller 2320 may be found below.

With continued reference to FIG. 23, in some embodiments, a controller 2320 may include a timing component. For the purposes of this disclosure, a “timing component” is a device or system used to control or synchronize the timing of various processes or operations of components of an apparatus. In some embodiments, the timing component is configured to regulate the timing of operations of the one or more of a modular ignition unit 2316 and a modular injector 2324. As a non-limiting example, the timing component may control the modular ignition unit 2316 to supply electrical voltages between electrodes of a modular plasma reactor 2304 for a set period of time. As another non-limiting example, the timing component may control the modular injector 2324 to provide at least a fluid to reaction region of the modular plasma reactor 2304 for the set period of time. In some embodiments, the set period of time may be predetermined. In some embodiments, the set period of time may be determined and input into the controller 2320 by a user, where the user is any person that uses an apparatus 2300. In some embodiments, the timing component may be configured to regulate the timing of operations of a modular pressure regulator. As another non-limiting example, the timing component may control the modular pressure regulator to control the pressure of at least a fluid for the set period of time.

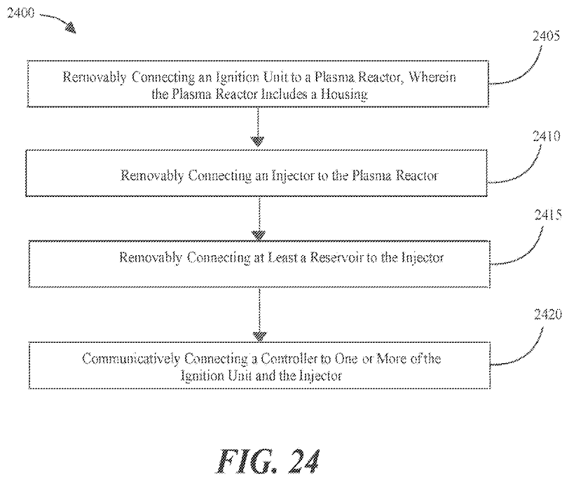

Now referring to FIG. 24, a flow diagram of an exemplary embodiment of a method 2400 for treating a growth medium via an electrical discharge is illustrated. The method 2400 includes a step 2405 of removably connecting a modular ignition unit to a modular plasma reactor, wherein the modular plasma reactor comprises a housing. In some embodiments, the modular ignition unit may include an inductive coil. This may be implemented, without limitation, as described herein.

With continued reference to FIG. 24, a method 2400 includes a step 2410 of removably connecting a modular injector to a modular plasma reactor. This may be implemented, without limitation, as described herein.

With continued reference to FIG. 24, a method 2400 includes a step 2415 of removably connecting at least a modular reservoir to a modular injector. In some embodiments, the method 2400 may further include removably connecting a modular pressure regulator to the at least a modular reservoir. This may be implemented, without limitation, as described herein.

With continued reference to FIG. 24, a method 2400 includes a step 2420 of communicatively connecting a controller to one or more of a modular ignition unit and a modular injector. In some embodiments, the controller may include a programmable logic controller (PLC). In some embodiments, the method 2400 may further include receiving, using the controller, a connection signal, wherein the connection signal indicates a connection between a modular plasma reactor and the one or more of the modular ignition unit, the modular injector and the modular pressure regulator. In some embodiments, the method 2400 may further include controlling, using the controller, a low-pressure compressor of the modular pressure regulator to output a pressure between 2 bars and 7 bars. In some embodiments, the method 2400 may further include regulating, using a timing component of the controller, timing of operations of the one or more of the modular ignition unit and a modular injector. In some embodiments, the method 2400 may further include controlling, using the controller, the power to an on-board modular ignition unit of the modular ignition unit. In some embodiments, the method 2400 may further include controlling, using the controller, the modular injector to disperse at least a fluid in one of a plurality of fluid spray volumes. This may be implemented, without limitation, as described herein.

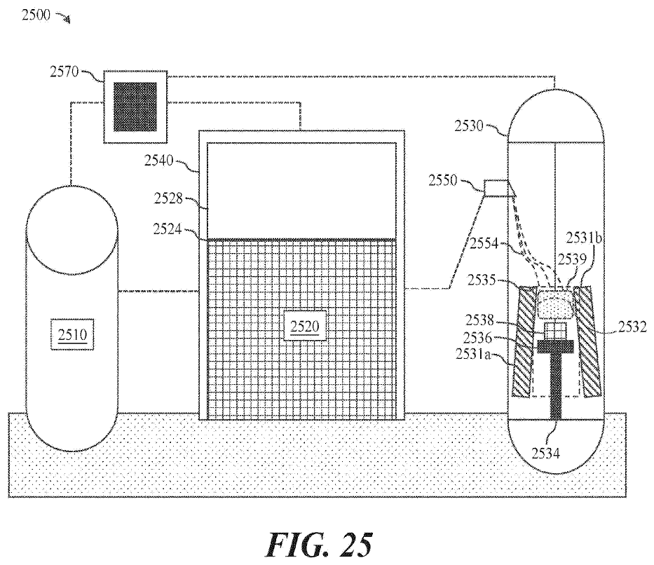

Now referring to FIG. 25, an exemplary embodiment of an apparatus 2500 for treating substrate 2538 via an electrical discharge is illustrated. In some embodiments, apparatus 2500 may be relatively small-sized (e.g., suitable for countertop placement) modular plasma reactor apparatus for producing gaseous and liquid substances or mixtures for various end use application areas, such as fertilizers, disinfectants, aerosols for odor removal, etc. Apparatus 2500 includes various pieces of equipment communicatively connected to one another, where each piece of equipment is centrally controlled by a control module, which may generate and send at least a control signal to activate or deactivate material (such as water) movement within apparatus 2500. More particularly, in some embodiments, apparatus 2500 includes water supply tank 2540 connected to both reaction chamber 2530 and control module 2570, which may generate a control signal. Reaction chamber 2530 may be used to expose a substrate, such as food substance, seed, or other form of growth medium, placed within reaction chamber 2530 to plasma. More particularly, in some aspects, system and/or apparatus may generate plasma and/or plasma discharges without additionally generating any undesirable harmful emission.

Water supply tank 2540 has level line 2524 and reservoir 2528 filled with water 2520 to level line 2524. Water supply tank 2540 may replenish (e.g., auto-replenish) water upon detection of depletion of water 2520 beneath level line 2524. That is, more specifically, water supply tank 2540 may automatically replenish water by extracting additional water from water source 2510, such as a sink, reservoir, or other water container, which is fluidically connected to water supply tank 2540 when the amount of water declines beneath the level line. Accordingly, unlike some conventional NTP plasma devices or systems that rely on a static water supply, water supply tank 2540 may be sized to accommodate portable placement within, for example, a conventional residential home countertop or similar substantially flat and rigid surface. Upon detection of depletion of water content within water supply tank 2540 by sensors, lasers, or other detection devices (not shown in FIG. 25), water supply tank 2540 may, in some embodiments, electronically communicate with one or more valves, pumps, flow controllers or the like to initiate water extraction and transfer from water source 2510 to automatically replenish water levels within water supply tank 2540 back to level line 2524. As further described below, NTP plasma treatment processes of substrate 2538 using reaction chamber 2530 consumes water dispersed as a spray from injector 2550 such that water 2520 contained within reservoir 2528 eventually will deplete beneath a pre-set demarcation point, such as level line 2524. Instead of requiring manual water 2520 replenishment, such as by pouring water 2520 into water supply tank 2540, water supply tank 2540 includes an auto-fill feature that is configured to automatically replenish water in the water supply tank upon detection of depletion of water 2520 beneath a pre-defined threshold, such as level line 2524. That is, in some embodiments, a sensor (not shown in FIG. 25) may be incorporated within water supply tank 2540 to detect depletion of water 2520 beneath level line 2524 and thereby communicate with control module 2570, which may, in response to detection of depletion of water 2520 beneath level line 2524, generate a control signal responsible for initiation of water transfer from water source 2510 to water supply tank 2540. In one or more embodiments, water source 2510 may be, for example, a municipal water supply source or large-scale reservoir, such as a well, capable of supplying apparatus 2500 with sufficient water for treatment of substrate 2538 indefinitely or on an as-needed basis. Accordingly, injector 2550 may be configured to spray various quantities of water to generate various forms of water-inclusive mists, suspensions, dispersions, and/or the like, any one or more of which may be suspended into any medley of gases flowed into reaction chamber 2530. After generation of a mist in reaction chamber 2530, a voltage may be provided by one or more electrodes, or applied across both electrodes, to generate one or more electric arcs capable of igniting a plasma within reaction region 2539.

Reaction chamber 2530 is connected to water supply tank 2540 and includes a pair of electrodes with first electrode 2531a and second electrode 2531b positioned opposite to the first electrode, and reaction region 2535 defined between first electrode 2531a and the second electrode 2531b. In some embodiments, each electrode has a proximal end and a distal end positioned opposite to the proximal end, where an electrical voltage is configured to be provided from the distal end. In addition, in some embodiments, first electrode 2531a may diverge from second electrode 2531b at an angle, which may be 12 degrees. Further, reaction region 2535 may, in some embodiments, include electric arcs between first electrode 2531a and second electrode 2531b and may at least temporarily surround substrate 2538 in a desired position during treatment. That is, pedestal 2534 and baseplate 2536 may support substrate 2538 to expose substrate 2538 to reaction region 2535. Control module 2570 is connected to at least reaction chamber 2530 and may generate at least a control signal. Apparatus 2500 may also include injector 2550 connecting water supply tank 2540 to reaction chamber 2530. Injector 2550 may generate a dispersion 2554 of microfine water droplets from water extracted from the reservoir in response to receipt of the control signal. In addition, apparatus 2500 may include a platform configured to support at least the reaction chamber and lay on a flat surface.

Operationally, the pair of electrodes may generate plasma by energetically exciting fluid within the reaction region through electrical discharge 2532 from first electrode 2531a to second electrode 2531b upon receipt of the control signal. At least one electrode of the pair of electrodes comprises a dielectric insulation and/or is configured to provide an electrical voltage. More particularly, when a voltage difference between two electrodes exceeds the breakdown voltage, a spark, defined here as an abrupt electrical discharge that occurs when a sufficiently high electric field creates an ionized, electrically conductive channel through a normally insulating medium, forms. In this case, the spark forms between the electrodes to generate plasma. Accordingly, exposing substrate 2538 to plasma within the reaction region 2539 treats (such as by “plasma treatment”) substrate 2538. “Plasma treatment,” as used herein, is a process that can be used to alter the characteristics of a material with the goal of improving the ability of the material to accept a coating or to be bonded to another material.

In addition, in some embodiments, a converter (not shown in FIG. 25) may convert electrical voltage from a direct current (DC) voltage input to an alternating current (AC) voltage output. Accordingly, an electrical connection interface may electrically connect the converter to at least one electrode of the electrodes disposed in reaction chamber 2530. In some instances, the converter may transform the DC voltage input to a high-voltage discharge at 10,000 kHz (10 MHz). Further, in one or more embodiments, a sensor (not shown in FIG. 25) may be disposed within reaction chamber 2530 proximate to substrate 2538 to detect reaction data describing substrate 2538 when exposed to a plasma generated within the reaction region. The sensor may be any type or sensor. Alternatively, the sensor be replaced by an array of sensors, at least one of which consists of a voltage sensor, a current sensor, a temperature sensor, a moisture sensor, and an optical sensor. Reaction data detected by the sensor may include a plurality of electrical discharge parameters, a plurality of fluid parameters, and a plurality of growth medium parameters.

In addition, in some aspects, control module 2570 may receive reaction data detected by the sensor and adjust at least a treatment parameter of apparatus as a function of the reaction data. More particularly, adjusting the at least a treatment parameter includes generating a trained treatment machine-learning model by training a treatment machine-learning model using treatment training data. Treatment training data may include reaction data classified treatment parameters and determining at least a treatment parameter as a function of the trained treatment machine-learning model.

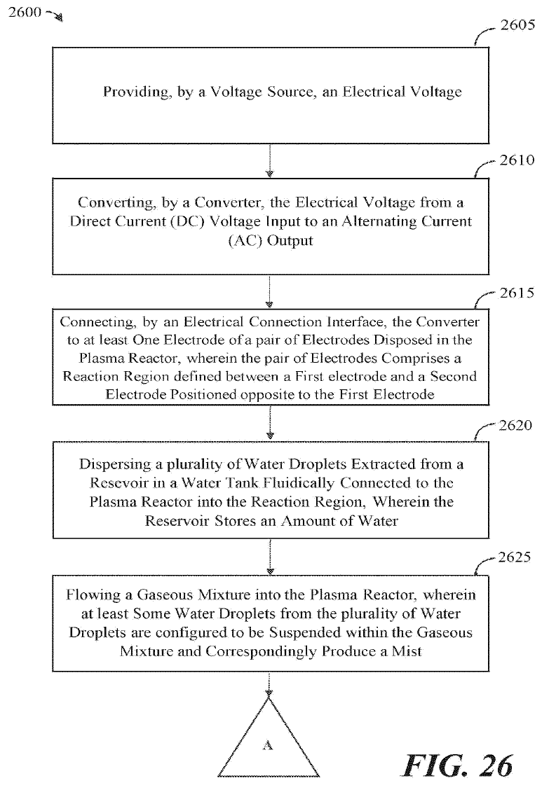

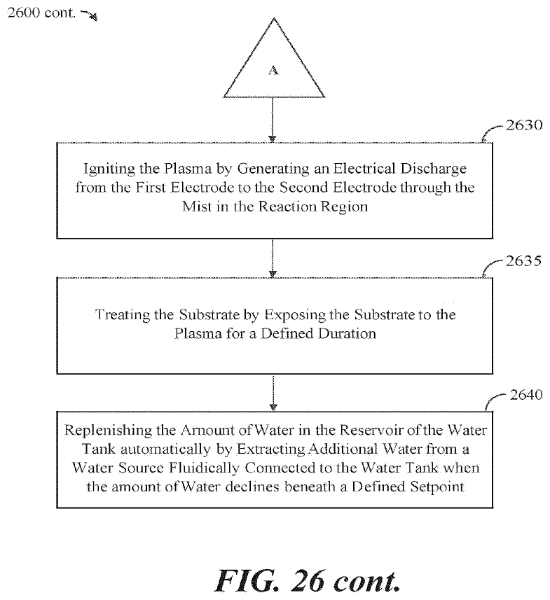

Now referring to FIG. 26, a flow diagram of an exemplary embodiment of a method 2600 for generating a plasma for treatment of a substrate within a plasma reactor is illustrated. Method 2600 includes step 2605 of providing, by a voltage source, an electrical voltage. This may be implemented, without limitation, as described herein.

With continued reference to FIG. 26, method 2600 includes step 2610 of converting, by a converter, the electrical voltage from a direct current (DC) voltage input to an alternating current (AC) output. In some embodiments, the converter may be configured to the DC voltage input to a high-voltage discharge at 10,000 kHz (10 MHz). This may be implemented, without limitation, as described herein.

With continued reference to FIG. 26, method 2600 includes a step 2615 of connecting, by an electrical connection interface, the converter to at least one electrode of a pair of electrodes disposed in the plasma reactor electrically, wherein the pair of electrodes comprises a first electrode and a second electrode. In some embodiments, the first electrode of the at least a pair of electrodes may be configured to diverge from the second electrode of the at least a pair of electrodes. In some embodiments, each electrode of at least a pair of electrodes may include a pitch angle of from 6 degrees to 8 degrees. In some embodiments, at least one electrode of the pair of electrodes may include a dielectric insulation. This may be implemented, without limitation, as described herein.

With continued reference to FIG. 26, method 2600 includes step 2620 of dispersing a plurality of water droplets extracted from a reservoir in a water tank communicatively connected to the plasma reactor into the reaction region, wherein the reservoir stores an amount of water. This may be implemented, without limitation, as described herein.

With continued reference to FIG. 26, method 2600 includes step 2625 of flowing a gaseous mixture into the plasma reactor, wherein at least some water droplets from the plurality of water droplets are configured to be suspended within the gaseous mixture and correspondingly produce a mist. This may be implemented, without limitation, as described herein.

With continued reference to FIG. 26, method 2600 includes step 2630 of igniting the plasma by generating an electrical discharge from the first electrode to the second electrode through the mist in the reaction region. This may be implemented, without limitation, as described herein.

With continued reference to FIG. 26, method 2600 includes step 2635 of treating the substrate by exposing the substrate to the plasma for a defined duration. This may be implemented, without limitation, as described herein.

With continued reference to FIG. 26, method 2600 includes step 2640 of replenishing the amount of water in the reservoir of the water tank automatically by extracting additional water from a water source communicatively connected to the water tank when the amount of water declines beneath a defined setpoint. This may be implemented, without limitation, as described herein.

With continued reference to FIG. 26, method 2600 may include steps of receiving, by the control module, the reaction data detected by the sensor from the feedback mechanism and adjusting, by the control module, at least a treatment parameter of the apparatus as a function of the reaction data. In some embodiment, adjusting the at least a treatment parameter may include training, by the control module, a treatment machine-learning model using treatment training data, wherein the treatment training data may include a plurality of reaction data as input correlated to a plurality of treatment parameters as output and determining, by the control module, at least a treatment parameter as a function of the trained treatment machine-learning model. This may be implemented, without limitation, as described herein.

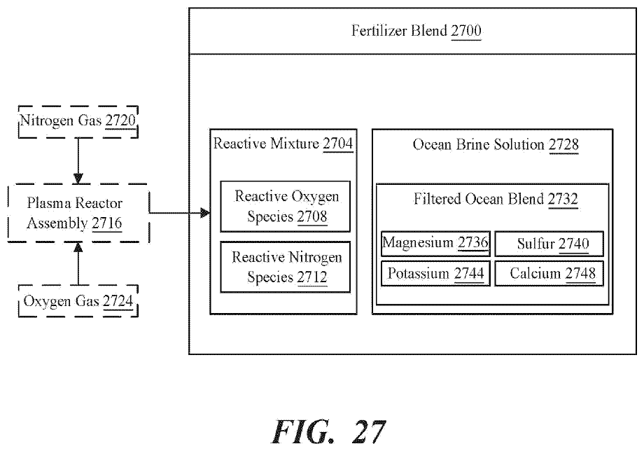

Now referring to FIG. 27, an exemplary embodiment of a fertilizer blend 2700 for use as a growth medium is described. “Fertilizer” for the purposes of this disclosure is one or more substances that may be used as a growth medium. As used in this disclosure, a “growth medium” is a substance or material that provides essential nutrients and environmental conditions for the growth and proliferation of microorganisms, cells, or tissues. In an embodiment, one or more seeds may be placed in growth medium. “Seeds,” fix the purpose of this disclosure, are a mature, fertilized ovule of a flowering plant (i.e., angiosperms) that contains an embryonic plant within a protective outer covering. Seeds may serve as the primary means of reproduction for many plant species, enabling them to disperse and establish new plants. In some embodiments, seeds may include, without limitation, cereal seeds (e.g., wheat, rice, com, barley, oats, millets, and the like), legume seeds (e.g., soybeans, peas, beans, lentils, chickpeas, peanuts, and the like), oilseeds (e.g., sunflower, rapeseed, flaxseed, sesame, safflower, and the like), vegetable seeds (e.g., tomatoes, peppers, cucumbers, eggplants, lettuce, spinach, and the like), and fruit seeds (e.g., watermelon, muskmelon, apple, citrus, and the like). In such an embodiment, growth medium may include a nutrient-rich environment that provides the essential conditions for germination and growth of the seeds. In some cases, growth medium may provide environmental factors such as, without limitation, temperature, pH level, oxygen, and the like required for the seed to germinate and develop into a healthy plant. In a non-limiting example, growth medium may include soil, wherein the soil may include a complex mixture of mineral particles, organic matter, water, air, living organisms, and the like. In another non-limiting example, growth medium may include soilless mix, or a specially formulated medium designed for seed germination and plant growth.

With continued reference to FIG. 27, fertilizer blend 2700 includes a reactive mixture 2704. A “reactive mixture” for the purposes of this disclosure is a solution containing atoms or molecules that have at least one unpaired electron. For example, a super oxide anion bearing the symbol O₂⁻, may be found in a reactive mixture 2704. Reactive mixture 2704 may include unstable molecules that are highly reactive and susceptible to forming chemical bonds. Reactive mixture 2704 includes at least a reactive oxygen species 2708 and a reactive nitrogen species 2712. “Reactive oxygen species” also known as “ROS” is an unstable molecule formed from molecular oxygen (O₂) and is susceptible to reacting with other molecules within a solution. ROS 2708 may include peroxides, superoxide, hydroxyl radicals, peroxynitrite, singlet oxygen and the like. The reaction of molecular oxygen may form a superoxide which is then used to create other reactive oxygen species 2708. “Reactive nitrogen species” or “RNS,” for the purposes of this disclosure, are reactive compounds that are susceptible to chemical bonds that are created by super oxides and nitric Oxide (NO). RNS 2712 may include nitric oxides, peroxynitrite, nitrogen dioxide, nitrous oxide nitrotyrosine, dinitrogen trioxide and the like.

In some cases, reactive mixture 2704 includes both reactive oxygen and reactive nitrogen species 2712 also known as “RONS”. RONS is the combination of reactive oxygen and reactive nitrogen within a solution. In some cases, reactive mixture 2704 may include water wherein the reactive species are contained within the water. In some cases, reactive mixture 2704 may include a liquid wherein the reactive species are contained within the liquid. In some cases, reactive mixture 2704 may contain a disproportionate amount of RNS 2712 and/or ROS 2708 where either one reactive species may be more concentrated than the other reactive species. In some cases, reactive mixture 2704 includes a solvate wherein the ROS 2708 and RNS 2712 are contained within the solvate. In some cases, ROS 2708 and RNS 2712 are gaseous compounds that are contained within the solvate. In some cases, reactive mixture 2704 contains ionized gases such as ionized oxygen and ionized nitrogen. In some cases, ROS 2708 and RNS 2712 contain ionized gases such as a superoxide and the like. In some cases, RNS 2712 may contain nitrogen or nitrous oxides, wherein “nitrous oxides” for the purposes of this disclosure are oxides of nitrogen such as NO, NO₂, NO₃ and any other oxide NOx wherein X may be any non-zero integer. In some cases, nitrous oxides may be beneficial for growth medium as the growth medium may absorb the nitrogen within the nitrous oxides. In some cases fertilizer blend 2700 may include a partially ionized gas consisting of a mixture of ions, electrons, and/or neutral particles (i.e., atoms and molecules).

With continued reference to FIG. 27, reactive mixture 2704 may be formed using a plasma reactor assembly 2716. Plasma reactor assembly 2716 may be consistent with a plasma reactor and/or plasma reactor as described herein. Plasma reactor assembly 2716 may include a treatment chamber configured to contain a growth medium. Plasma reactor assembly 2716 may further include a at least a reservoir configured to contain at least a fluid. Plasma reactor assembly 2716 may further include a plasma reactor. The plasma reactor may include at least a pair of electrodes having a first electrode and a second electrode, wherein the at least a pair of electrodes is configured to produce an electrical discharge as a function of the at least a fluid. Plasma reactor may further include a reaction region disposed between the first electrode and the second electrode, wherein the reaction region is configured to enable an interaction between the electrical discharge and a growth medium. Plasma reactor may further include an ignition unit electrically connected to at least an electrode of the at least a pair of electrodes, wherein the ignition unit is configured to supply an electrical voltage to the at least an electrode. In some cases, plasma reactor may include an injector in fluidic connection with the at least a reservoir, wherein the injector is configured to feed at least a fluid through the reaction region. In some cases, plasma reactor may further include a pressure regulator configured to transfer at least a fluid to the injector. In some cases, the at least a reservoir may include a first reservoir configured to contain a first fluid and a second reservoir configured to contain a second fluid, wherein the first fluid includes at least a gas, and the second fluid includes at least a liquid. Plasma reactor assembly 2716 is described in further detail below. In some cases, plasma reactor assembly 2716 is configured to receive nitrogen gas 2720 and oxygen gas 2724 and expose the nitrogen gas 2720 and the oxygen gas 2724 to a plasma discharge, wherein the plasma discharge is generated by the plasma reactor assembly 2716. In some cases, nitrogen gas 2720 and oxygen gas 2724 is received from a separate fuel container having nitrogen gas 2720 and/or oxygen gas 2724, wherein reactive mixture contains products of the nitrogen gas 2720 and oxygen gas 2724, such as the RNS 2712 and ROS 2708. Plasma reactor assembly 2716 may include a reaction region disposed between first an electrode and a second electrode, wherein the reaction region is configured to enable an interaction between electrical discharge (i.e., plasma) and a growth medium. As used in this disclosure, a “reaction region” is a designated area or space within plasma reactor assembly where specific chemical or physical reactions take place. In some embodiments, generating plasma in reaction region may include generating reactive oxygen species (ROS) and reactive nitrogen species (RNS), wherein both species are highly reactive molecules primarily formed through an interaction of molecular oxygen (O₂) and molecular nitrogen (N₂) with high-energy species, such as free radicals, ions, and/or electrons generated through electrical discharge as described above. In some cases, ROS may include, without limitation, superoxide (O₂⁻), hydroxyl radical (·OH), hydrogen peroxide (H₂O₂). Plasma may collide with O₂ molecules, causing dissociation, ionization, or excitation, which subsequently leads to the formation of ROS through further reactions. In some cases, RNS may include, without limitation, nitric oxide (·NO), nitrogen dioxide (·NO2), peroxynitiite (ONOO—), and the like. Plasma may collide with N2 molecules or other nitrogen-containing molecules, causing dissociation, ionization, or excitation, which subsequently leads to the formation of RNS through further reactions. In some cases, nitrogen gas 2720 and oxygen gas 2724 is produced from the surrounding atmosphere. In some cases, nitrogen gas 2720 and/or oxygen gas 2724 may be received in any way in which a fluid and/or a gaseous substance is received in this disclosure. In some cases nitrogen gas 2720 and oxygen gas 2724 is combined with a fluid to create a fluidic mixture having nitrogen and/or oxygen gas 2724. In some cases, the fluidic mixture may include water. Plasma reactor assembly 2716 and/or any reactive mixtures 2704 generated as a result are described in further detail below.

With continued reference to FIG. 27, fertilizer blend 2700 includes an ocean brine solution 2728 having a filtered ocean blend 2732. “Ocean brine solution,” for the purposes of this disclosure, is a product of ocean water that has been modified or filtered for use in fertilization of a growth medium. Ocean brine solution 2728 may include a product of ocean water in fluid form and/or in a solid form. In some cases, ocean brine solution 2728 may include ocean water with various larger deposits, such as rocks and seaweed removed. “Ocean blend” for the purposes of this disclosure is unmodified or unfiltered ocean water. Ocean blend 2732 may include a large portion of ocean water including deposits such as plastic, seaweed, rocks, garbage, and/or any deposits not naturally found in ocean water. In some cases, ocean blend includes ocean water including any deposits that have not been dissolved in the ocean water. This may include, for example, sand, larger undissolved minerals, salt crystals, fish, plants, and the like. “Filtered ocean blend” for the purposes of this disclosure is an ocean blend 2732 wherein deposits that may be detrimental and/or harmful to the growth of a medium are removed. In some cases, filtered ocean blend 2732 may further include an ocean blend 2732 wherein all elements of the blend may be readily absorbed into the ground, such as for example, a blend wherein all nutrients are completely dissolved within a fluid. In some cases, filtered ocean blend 2732 may include an ocean blend wherein plastics, microplastics and other unnatural/human made deposits are removed. In some cases, filtered ocean blend 2732 may include an ocean blend 2732 wherein undissolved deposits are moved such as undissolved minerals, rocks, seaweed and any other deposits that are not readily dissolved within a liquid. In some cases, ocean blend 2732 may be filtered through a filtration process wherein ocean blend 2732 is passed through a filtering medium, wherein the filtering medium is configured to separate a fluid and any solids within the ocean blend. For example, the filtering medium may be configured to separate ocean water and any deposits within the ocean water. In some cases, the filtering medium may remove contaminants such as viruses, bugs, and/or any other deposits that may cause harm to a growth medium. In some cases the size of the filtering medium may vary, wherein a larger size may allow for larger particles and/or sediment to pass through wherein a smaller filtering medium may only allow fluids and elements dissolved within the fluids to pass through. In some cases, filtering may include sedimentation wherein sediments within an ocean blend 2732 settle at the bottom of a container holding the ocean blend, wherein the sediments at the bottom are removed in order to create a filtered ocean blend 2732.

With continued reference to FIG. 27, ocean brine solution 2728 includes magnesium 2736, sulfur 2740, potassium 2744, and calcium 2748. In some cases, the minerals described above may already be contained within an ocean blend 2732 containing a wide variety of minerals. In some cases, the minerals described above may be added to ocean brine solution 2728. In some cases, additional similar and/or differing minerals may be added to ocean brine solution 2728. In some cases, ocean brine solution 2728 contains saltwater brine. Saltwater brine is a high-concentration solution of salt (typically sodium chloride or calcium chloride) in water. Saltwater brine may include trace elements of various minerals typically found within ocean water. Trace elements may include but are not limited to Oxygen, Hydrogen, Chlorine, Sodium, Magnesium, Sulfur, Calcium, Potassium, Bromine, Carbon, Strontium, Boron, Silicon, Fluorine, Nitrogen, Argon, Lithium, Rubidium, Phosphorus, Iodine, Indium, Barium, Molybdenum, Zinc, Arsenic, Uranium, Vanadium, Aluminum, Iron, Titanium, Nickel, Chromium, and the like. In some cases, saltwater brine may include a concentration factor of 2:1, wherein the saltwater brine contains twice the amount of minerals per given area in comparison to ocean blend 2732. In some cases, the concentration factor may be 4:1. In some cases, the concentration factor may be 10:1.

With continued reference to FIG. 27, ocean brine solution 2728 may include a concentrated ocean blend 2732. A “concentrated ocean blend” for the purposes of this disclosure is an ocean blend having that has been modified to have a larger amount of minerals per unit in comparison to a non-concentrated ocean blend 2732. In a nonlimiting example, ocean blend 2732 may contain a concentration of 400 parts per million (PPM) whereas concentrated ocean blend may contain a concentration of 800 PPM. In another non-limiting example, an ocean blend and/or seawater may contain a concentration of potassium of 380 PPM whereas concentrated ocean blend may contain a concentration of 400 PPM or larger In some cases, concentrating ocean blend 2732 to create a concentrated ocean blend, may include adding additional minerals to an existing ocean blend mixture. In some cases, concentrating ocean blend to create a concentrated ocean blend may include any process of removing water from the mixture, whereby the minerals within the blend contain a higher concentration within a smaller volume. In an embodiment, concentrated ocean blend 2732 may include an ocean blend that has undergone an evaporation process, wherein water within the ocean blend has been evaporated. In some cases, concentrated ocean blend 2732 may be differentiated from a non-concentrated ocean blend wherein the non-concentrated ocean blend has not gone through an evaporation process. In one or more embodiments, concentrated ocean blend 2732 may include a non-concentrated ocean blend that has undergone one or more processes to reduce the fluid within the non-concentrated ocean blend and thereby increase the concentration of minerals with respect to the amount of fluid present. In some cases, concentrated ocean blend 2732 may include a higher concentration of salt and/or any other minerals described in this disclosure. In some cases, concentrated ocean blend 2732 may include an ocean blend 2732 that has been boiled to remove a portion of water from the ocean blend 2732. In some cases, the resulting concentrated blend may include an ocean blend 2732 having a higher concentration of minerals per square unit. In some cases, concentrated ocean blend 2732 may include an ocean blend 2732 that has been filtered through a desalination process. A “desalination” process for the purposes of this disclosure is a process in which sea water is separated into purified unsalted water and minerals that were present within the sea water. Desalination may include a process in which sea water ocean brine is forced through a semipermeable membrane wherein only water may pass through while the minerals, such as sodium chloride, within the ocean blend 2732 are separated. In some cases, concentrated ocean blend 2732 may include a solution containing minerals separated from an ocean blend 2732 and readded to an unmodified ocean blend 2732, thereby creating a concentrated ocean blend 2732. In some cases, concentrated ocean blend 2732 may include minerals removed from ocean blend 2732 and remixed into an existing fluid. In some cases, concentrated ocean blend 2732 may include a concentration of minerals higher than the original ocean blend 2732. In some cases, concentrated ocean blend 2732 may include a higher concentration of minerals than that found within ordinary ocean water.

With continued reference to FIG. 27, in some cases ocean brine solution 2728 may include freshwater. “Freshwater” for the purposes of this disclosure is water retrieved from a lake, min, or any other source that may be suitable for human consumption. In some cases, freshwater may include water retrieved from a lake or a spring. In some cases, freshwater may include water suitable for human consumption, such as for example, water suitable for hydrating an individual. In some cases, freshwater may include distilled water In some cases, freshwater may include water having a higher or lower PH value. In some cases, freshwater may include purified water that has been produced as a product of distillation, desalination and/or any other purification processes. In some cases, ocean brine solution 2728 may include freshwater in order to reduce the concentration of the minerals within an ocean blend 2732. In some cases, ocean brine solution 2728 may include freshwater wherein the sodium chloride and/or any other salts may be reduced in concentration. In some cases, ocean brine solution 2728 contains freshwater such that ocean brine solution 2728 contains the appropriate concentration suitable for the growth of a medium.

With continued reference to FIG. 27, fertilizer blend 2700 may include at least two parts of reactive mixture 2704 and one part of ocean brine solution 2728. For example, a part may include 270 fluid ounces wherein reactive mixture 2704 may include 20 fluid ounces (two parts) and ocean brine solution 2728 may include 10 fluid ounces (one part). In some cases, fertilizer blend 2700 may include a higher concentration of reactive mixture 2704 than ocean brine solution 2728. In some cases fertilizer blend 2700 may include ten parts of a reactive mixture 2704 and one part of ocean brine solution 2728. In some cases, fertilizer blend 2700 may include equal parts of ocean brine solution 2728 and reactive mixture 2704. In some cases, fertilizer blend may include 100 parts of reactive mixture 2704 and one part of ocean brine solution 2728. In some cases, fertilizer blend 2700 contains two or more parts of reactive mixture 2704 and one part of ocean brine solution 2728.

With continued reference to FIG. 27, fertilizer blend 2700 may include a fluid. A “Fluid” for the purposes of this disclosure is a substance that has no fixed shape and yields easily to external pressure. In some cases, fertilizer blend 2700 may be in fluid form. In some cases, reactive mixture 2704 and/or ocean brine solution 2728 are both fluids wherein the resulting fertilizer blend 2700 is a fluid. In some cases, reactive mixture 2704 and/or ocean brine solution 2728 may include a solid material wherein the solid material is dissolved into a fluid. One solid component of fertilizer blend 2700 may be dissolved into a fluid component of fertilizer blend 2700 wherein a component may include a reactive mixture 2704 or an ocean brine solution 2728. In some cases, ocean brine solution 2728 may include a fluid wherein the fluid used within plasma reactor assembly 2716 described below may include ocean brine solution 2728.

With continued reference to FIG. 27, fertilizer blend 2700 may be used as fertilizer. In an aspect a method of using a fertilizer blend 2700 is described. The method includes pouring a fertilizer blend 2700 over a plant, wherein the fertilizer blend 2700 includes a reactive mixture 2704 having a reactive oxygen species 2708 and a reactive nitrogen species 2712, and an ocean brine solution 2728 having a filtered ocean blend 2732, wherein the ocean brine solution 2728 further includes magnesium, sulfur, potassium, and calcium. In some cases, the fertilizer blend 2700 may be used for the growth of a plant such as a tree, grass, bushes and the like. In some cases, the method includes diluting fertilizer blend 2700 with a fluid such that fertilizer blend 2700 is suitable for consumption by plants. In some cases, fertilizer blend 2700 may be poured into a container along with soil, wherein the soil may soak within the fertilizer blend 2700 in order to absorb the necessary nutrients. In some cases, soil is soaked within fertilizer blend 2700 for an hour or more. In some cases, fertilizer blend 2700 may be sprayed onto a plant. In some cases, after pouring fertilizer blend 2700 over a plant, fresh water may be poured in order to remove any excess nutrients that have not been absorbed by the plant. In some cases, fertilizer blend 2700 may be pre-mixed with soil prior to placing the soil on top of the plant and/or placing a plant within the soil.

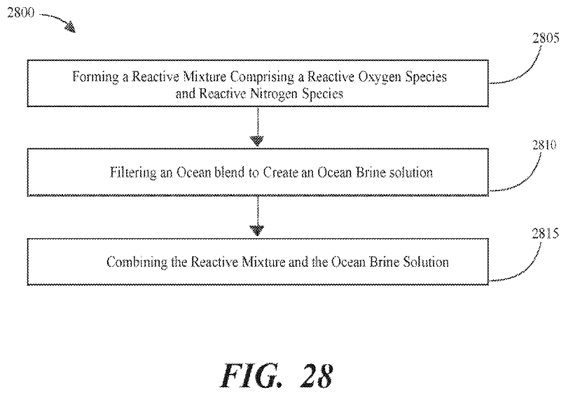

Now referring to FIG. 28, a method of manufacturing a fertilizer blend. For use as a growth medium is described. At step 2805, method 2800 includes forming a reactive mixture having a reactive nitrogen species and a reactive oxygen species. In some cases, forming the reactive mixture includes forming the reactive mixture using a plasma reactor assembly. In some cases, the reactive mixture includes ionized gases. In some cases, the reactive nitrogen species includes nitrogen oxides. In some cases, forming the reactive nitrogen species includes receiving nitrogen has and oxygen gas, and exposing, using the plasma reactor assembly, the nitrogen gas and the oxygen gas to a plasma discharge. This may be implemented, without limitation, as described herein.

With continued reference to FIG. 28, at step 2810, method 2800 includes filtering an ocean blend to create an ocean brine solution, wherein the ocean brine solution includes magnesium, sulfur, potassium and calcium. In some cases, filtering the ocean blend includes concentrating the ocean blend. Concentrating may include increasing the concentration of minerals within the ocean brine solution. Concentrating may include removing some fluid from ocean brine solution wherein the resulting ocean brine solution contains a higher concentration of minerals within a smaller amount of fluid. In some cases, concentrating may include removing a part of a fluid from ocean brine solution through distillation or desalination. In some cases, concentrating may include adding additional minerals into ocean brine solution. In some cases, the additional minerals may be received from mineralization process whereby minerals from ocean water are removed. In some cases filtering the ocean blend may include removing solid particles that are not dissolved within the ocean blend. In some cases, filtering may include removing harmful elements from the ocean blend that may inhibit the growth of a growth medium. In some cases, filtering may include pouring ocean blend through a filtering medium, wherein the filtering medium is configured to remove solid particles from the ocean blend. In some cases, filtering may include a sedimentation process wherein particles within ocean blend fall to the bottom of a fluid solution and eventually removed. In some cases, filtering the ocean blend may further include diluting the ocean blend with fresh water. Fresh water may include any freshwater as described in this disclosure. This may be implemented, without limitation, as described herein.

With continued reference to FIG. 28, at step 2815, method 2800 includes combing the reactive mixture and the ocean brine solution to create a fertilizer blend. In some cases, combining may include pouring a reactive mixture into the ocean brine solution. In some cases, combining may include mixing the ocean brine solution and the reactive mixture to create a uniform product. In some cases, combining may include combing, using the plasma reactor assembly, the reactive species and the ocean brine solution. In some cases, combining the reactive mixture and the ocean brine solution may include combining at least two parts of the reactive mixture and one part of the ocean brine solution. In some cases, the method further includes modifying the PH of the fertilizer blend. Modifying may include combining a fluid and/or component having a PH different from that of the fertilizer blend, wherein the resulting combination may cause the fertilizer blend to increase or decrease in PH level. For example, a solution having a lower PH than the fertilizer blend may be combined, with fertilizer blend to reduce the PH of fertilizer blend. In some cases, modifying the PH of the fertilizer blend may include modifying the PEI of fertilizer blend such that is suitable for the growth of a growth medium. In some cases, fertilizer blend may include a mixture of reactive mixture and ocean brine solution wherein the PH of the reactive mixture and the PH of the ocean brine solution are different. In some cases, combining the ocean brine solution and the reactive mixture may include combining reactive mixture and ocean brine solution to create a fertilizer blend with a predetermined PH value. In some cases, reactive mixture and ocean brine solution may contain differing amounts within fertilizer blend to create a fertilizer solution with a specific PH. This may be implemented, without limitation, as described herein.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 29 shows a diagrammatic representation of one embodiment of a computing device in the exemplary form of a computer system 2900 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 2900 includes a processor 2904 and a memory 2908 that communicate with each other, and with other components, via a bus 2912. Bus 2912 may include any of several types of bus structures including, but not limited to, a memory bus, a memory controller, a peripheral bus, a local bus, and any combinations thereof, using any of a variety of bus architectures.

Processor 2904 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 2904 may be organized according to Von Neumann and/or Harvard architecture as a non-limiting example. Processor 2904 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 2908 may include various components (e.g., machine-readable media) including, but not limited to, a random-access memory component, a read only component, and any combinations thereof. In one example, a basic input/output system 2916 (BIOS), including basic routines that help to transfer information between elements within computer system 2900, such as during start-up, may be stored in memory 2908. Memory 2908 may also include (e.g., stored on one or more machine-readable media) instructions (e.g., software) 2920 embodying any one or more of the aspects and/or methodologies of the present disclosure. In another example, memory 2908 may further include any number of program modules including, but not limited to, an operating system, one or more application programs, other program modules, program data, and any combinations thereof.

Computer system 2900 may also include a storage device 2924. Examples of a storage device (e.g., storage device 2924) include, but are not limited to, a hard disk drive, a magnetic disk drive, an optical disc drive in combination with an optical medium, a solid-state memory device, and any combinations thereof. Storage device 2924 may be connected to bus 2912 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 2924 (or one or more components thereof) may be removably interfaced with computer system 2900 (e.g., via an external port connector (not shown)). Particularly, storage device 2924 and an associated machine-readable medium 2928 may provide nonvolatile and/or volatile storage of machine-readable instructions, data structures, program modules, and/or other data for computer system 2900. In one example, software 2920 may reside, completely or partially, within machine-readable medium 2928. In another example, software 2920 may reside, completely or partially, within processor 2904.

Computer system 2900 may also include an input device 2932. In one example, a user of computer system 2900 may enter commands and/or other information into computer system 2900 via input device 2932. Examples of an input device 2932 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 2932 may be interfaced to bus 2912 via any of a variety of interfaces (not shown) including, but not limited to, a serial interface, a parallel interface, a game port, a USB interface, a FIREWIRE interface, a direct interface to bus 2912, and any combinations thereof. Input device 2932 may include a touch screen interface that may be a part of or separate from display device 2936, discussed further below. Input device 2932 may be utilized as a user selection device for selecting one or more graphical representations in a graphical interface as described above.

A user may also input commands and/or other information to computer system 2900 via storage device 2924 (e.g., a removable disk drive, a flash drive, etc.) and/or network interface device 2940. A network interface device, such as network interface device 2940, may be utilized for connecting computer system 2900 to one or more of a variety of networks, such as network 2944, and one or more remote devices 2948 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 2944, may employ a wired and/or a wireless mode of communication. In general, any network topology may be used. Information (e.g., data, software 2920, etc.) may be communicated to and/or from computer system 2900 via network interface device 2940.

Computer system 2900 may further include a video display adapter 2952 for communicating a displayable image to a display device, such as display device 2936. Examples of a display device include, but are not limited to, a liquid crystal display (LCD), a cathode ray tube (CRT), a plasma display, a light emitting diode (LED) display, and any combinations thereof. Display adapter 2952 and display device 2936 may be utilized in combination with processor 2904 to provide graphical representations of aspects of the present disclosure. In addition to a display device, computer system 2900 may include one or more other peripheral output devices including, but not limited to, an audio speaker, a printer, and any combinations thereof. Such peripheral output devices may be connected to bus 2912 via a peripheral interface 2956. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. An apparatus comprising:
a plasma generator defining a reaction region configured to enable an interaction between an electrical discharge and a liquid introduced into the reaction region;
at least one feedback mechanism configured to detect reaction data associated with the interaction between the electrical discharge and the liquid; and
a control module configured to adjust at least one treatment parameter of the apparatus as a function of the reaction data in a manner that produces a solution enriched with a reactive nitrogen species.

2. The apparatus of claim 1, further comprising a water reservoir fluidically connectable to an external water source through a refill valve, wherein:
the feedback mechanism comprises a level sensor; and
the control module is configured to, upon detection of depletion of water content, electronically communicate with one or more valves, pumps, and/or flow controllers to automatically replenish water in the reservoir.

3. The apparatus of claim 2, wherein the control module is further configured to prevent initiation of the electrical discharge when a water level is below a setpoint.

4. The apparatus of claim 1, further comprising an injector configured to introduce atomized water toward the reaction region, wherein the injector is selectively operable in a gas-only mode, a liquid-only mode, and a gas-liquid mixed mode, and wherein the control module is configured to ignite the electrical discharge while the injector is in the gas-only mode and subsequently transition the injector to the gas-liquid mixed mode to produce the solution enriched with the reactive nitrogen species.

5. The apparatus of claim 4, wherein the injector is aligned to produce a spray cone having an angle between about 12 degrees and about 15 degrees into the reaction region.

6. The apparatus of claim 4, wherein the control module is further configured to regulate respective gas and liquid feed rates to maintain a predetermined gas-to-liquid mass-flow ratio during operation.

7. The apparatus of claim 1, wherein:
the at least one feedback mechanism comprises one or more sensors configured to detect at least one electrical-discharge parameter and to provide corresponding reaction data to the control module; and
the control module is configured, in response to the reaction data, to adjust an applied voltage of the plasma generator.

8. The apparatus of claim 1, further comprising an injector configured to atomize liquid into droplets having a Sauter mean diameter in a range of about 5 microns to about 50 microns and to deliver the droplets into the reaction region.

9. The apparatus of claim 8, further comprising at least one pressure or flow sensor associated with a feed path to the injector, wherein the control module is configured to inhibit or terminate generation of the electrical discharge when a sensed pressure or flow is outside a permissible range in a manner that prevents dry ignition.

10. The apparatus of claim 8, wherein the injector comprises a piezoelectric water-vapor injector configured to generate a dispersion of microfine water droplets and water vapor in response to a control signal and to deliver the dispersion into the reaction region.

11. The apparatus of claim 1, further comprising a condenser positioned downstream of the reaction region and a collection reservoir fluidically coupled to the condenser, wherein the solution enriched with the reactive nitrogen species is collected in the collection reservoir.

12. The apparatus of claim 11, wherein the condenser comprises a cooled heat-exchange surface aligned with the reaction region.

13. The apparatus of claim 11, wherein the collection reservoir is sealed and configured to maintain a headspace pressure in a manner that limits off-gassing of the reactive nitrogen species.

14. The apparatus of claim 11, further comprising a recirculation line fluidically coupling the collection reservoir to an inlet of an injector, wherein the control module is configured to recirculate a portion of the collected solution.

15. The apparatus of claim 11, wherein the condenser is integrated within a conduit positioned downstream of the reaction region and comprises a thermally conductive porous packing material selected from steel wool, metal wool, or copper configured to promote condensation of vapor formed during interaction between the electrical discharge and the liquid.

16. An apparatus comprising:
a plasma generator having a pair of electrodes that define a reaction region;
an introduction subsystem comprising an injector fluidically coupled to a liquid source and a process gas source and configured to introduce atomized liquid and process gas into the reaction region;
a feedback mechanism comprising one or more sensors configured to detect reaction data associated with an electrical discharge in the reaction region;
a control module operatively coupled to the plasma generator, the introduction subsystem, and the feedback mechanism and configured to generate the electrical discharge and to adjust at least one treatment parameter of the apparatus as a function of the reaction data.

17. The apparatus of claim 16, further comprising:
a condenser positioned downstream of the reaction region; and
a collection reservoir fluidically coupled to the condenser,
wherein during operation, the injector introduces the atomized liquid and the process gas into the reaction region such that the electrical discharge reacts with the atomized liquid to form a solution enriched with a reactive nitrogen species.

18. The apparatus of claim 16, wherein the control module is configured to regulate respective gas and liquid feed rates to maintain a predetermined gas-to-liquid mass-flow ratio within the reaction region.

19. A method comprising:
providing a plasma generator having a pair of electrodes that define a reaction region;
supplying a process gas to the reaction region;
atomizing a liquid to form droplets and introducing the droplets with the process gas into the reaction region;
initiating an electrical discharge within the reaction region while supplying the process gas and the liquid to the reaction region;
maintaining a predetermined gas-to-liquid mass-flow ratio during concurrent introduction;
forming reactive nitrogen species within the electrical discharge;
detecting reaction data associated with the electrical discharge;
adjusting at least one treatment parameter of the plasma generator as a function of the reaction data;
condensing vapor downstream of the reaction region; and
collecting condensed liquid in a collection reservoir as a solution enriched with the reactive nitrogen species.

20. The method of claim 19, wherein initiating the electrical discharge comprises igniting the discharge while introducing only the process gas and thereafter commencing concurrent introduction of the liquid droplets and the process gas.
